(19) United States
(12) Patent Application Publication
(10) Pub. No.: US 2025/0130311 A1
(43) Pub. Date: Apr. 24, 2025

(54) RADAR APPARATUS, RADAR SIGNAL GENERATING APPARATUS, AND RADAR SIGNAL GENERATING METHOD

(71) Applicant: Panasonic Automotive Systems Co., Ltd., Kanagawa (JP)

(72) Inventor: Takaaki KISHIGAMI, Tokyo (JP)

(21) Appl. No.: 18/984,308

(22) Filed: Dec. 17, 2024

Related U.S. Application Data
(63) Continuation of application No. PCT/JP2023/008127, filed on Mar. 3, 2023.

(30) Foreign Application Priority Data
Jun. 30, 2022 (JP) 2022-105855

(51) Int. Cl. G01S 7/35; G01S 7/02; G01S 13/42

(52) U.S. Cl. CPC G01S 7/354; G01S 7/024; G01S 13/42

(57) ABSTRACT

A radar apparatus includes: a plurality of transmission antennas including a first transmission antenna that radiates a first polarized wave and a second transmission antenna that radiates a second polarized wave different from the first polarized wave; and transmission circuitry, which, in operation, performs multiplexing transmission of a transmission signal to which a phase rotation corresponding to a Doppler shift amount assigned to each of the plurality of transmission antennas is applied, from the plurality of transmission antennas, in which a Doppler multiplexing interval by the plurality of transmission antennas is an uneven interval on a Doppler frequency axis, and a first pattern of the Doppler shift amount assigned to the first transmission antenna and a second pattern of the Doppler shift amount assigned to the second transmission antenna are different from each other.

### TECHNICAL FIELD

The present disclosure relates to a radar apparatus, a radar signal generating apparatus, and a radar signal generating method.

### BACKGROUND ART

Recently, a study of radar apparatuses using a radar transmission signal of a short wavelength including a microwave or a millimeter wave that can achieve high resolution has been carried out. Further, it has been required to develop a radar apparatus which detects not only vehicles but also small objects such as pedestrians in a wide-angle range (e.g., referred to as “wide-angle radar apparatus”) in order to improve the outdoor safety.

As a configuration of a radar apparatus having a wide detection range, for example, there is a configuration that uses an array antenna composed of a plurality of antennas (or also called antenna elements) to receive reflected waves from a target, and estimates the direction (or called the Direction Of Arrival (DOA)) from which a reflected wave from the target arrive (Direction of Arrival (DOA) estimation), based on a reception phase difference for elements spacings (antenna spacings). Examples of the DOA estimation include a Fourier method, and, a Capon method, Multiple Signal Classification (MUSIC), and Estimation of Signal Parameters via Rotational Invariance Techniques (ESPRIT) that are methods achieving higher resolution.

Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

### PTL 1

US Patent Application Publication No. 2019/0064337

### PTL 2

US Patent Application Publication No. 2020/0363497

### PTL 3

Japanese Unexamined Patent Application Publication No. 2008-304417

### PTL 4

Japanese Unexamined Patent Application Publication (Translation of PCT Application) No. 2011-526371

### PTL 5

Japanese Unexamined Patent Application Publication No. 2011-119344

### PTL 6

Japanese Unexamined Patent Application Publication No. 2019-052952

### PTL 7

Japanese Unexamined Patent Application Publication No. 2020-148754

### Non-Patent Literature

### NPL 1

J. Li, and P. Stoica, “MIMO Radar with Colocated Antennas,” Signal Processing Magazine, IEEE Vol. 24, Issue: 5, pp. 106-114, 2007

### NPL 2

M. Kronauge, H. Rohling, “Fast two-dimensional CFAR procedure,” IEEE Trans. Aerosp. Electron. Syst., 2013, 49, (3), pp. 1817-1823

### NPL 3

Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### SUMMARY OF INVENTION

However, methods for a radar apparatus (e.g., MIMO radar) to sense a target object (or a target) have not been comprehensively studied.

One non-limiting and exemplary embodiment of the present disclosure facilitates providing a radar apparatus, a radar signal generating apparatus, and a radar signal generating method with an enhanced sensing accuracy for sensing a target object.

A radar apparatus according to one exemplary embodiment of the present disclosure includes: a plurality of transmission antennas including a first transmission antenna that radiates a first polarized wave and a second transmission antenna that radiates a second polarized wave different from the first polarized wave; and transmission circuitry, which, in operation, performs multiplexing transmission of a transmission signal to which a phase rotation corresponding to a Doppler shift amount assigned to each of the plurality of transmission antennas is applied, from the plurality of transmission antennas, in which a Doppler multiplexing interval by the plurality of transmission antennas is an uneven interval on a Doppler frequency axis, and a first pattern of the Doppler shift amount assigned to the first transmission antenna and a second pattern of the Doppler shift amount assigned to the second transmission antenna are different from each other.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to an exemplary embodiment of the present disclosure, the target object-object sensing accuracy of a radar apparatus can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of Time Division Multiplexing (TDM) transmission;

FIG. 2 illustrates an example of Doppler Division Multiplexing (DDM) transmission;

FIG. 3 illustrates an example of uneven-interval Doppler multiplexing transmission;

FIG. 4 illustrates an example of Doppler multiplexing transmission;

FIG. 5 is a block diagram showing a configuration example of a radar apparatus;

FIG. 6 illustrates an example of a transmission signal using a chirp signal;

FIG. 7 illustrates an example of a chirp signal;

FIG. 8 illustrates an example of a transmission signal and a reception signal in a case where a chirp signal is used;

FIG. 9 illustrates an exemplary configuration of the Doppler shift amount;

FIG. 10 illustrates an example of a reception signal in Doppler multiplexing transmission;

FIG. 11 illustrates an exemplary configuration of the Doppler shift amount;

FIG. 12 illustrates an example of a reception signal in Doppler multiplexing transmission;

FIG. 13 illustrates an exemplary configuration of the Doppler shift amount;

FIG. 14 illustrates an exemplary configuration of the Doppler shift amount;

FIG. 15 illustrates an exemplary configuration of the Doppler shift amount;

FIG. 16 illustrates an exemplary configuration of the Doppler shift amount;

FIG. 17 is a flowchart showing an exemplary operation for separating Doppler multiplexed signals;

FIG. 18 is a block diagram showing an exemplary configuration of a radar receiver;

FIG. 19 illustrates an exemplary configuration of the Doppler shift amount;

FIG. 20 illustrates an exemplary configuration of the Doppler shift amount;

FIG. 21 illustrates an exemplary configuration of the Doppler shift amount; and

FIG. 22 is a block diagram showing an exemplary configuration of a radar apparatus.

### DESCRIPTION OF EMBODIMENTS

A MIMO radar transmits, from a plurality of transmission antennas (also referred to as “transmission array antenna”), signals (radar transmission waves) that are time-division, frequency-division, or code-division multiplexed, for example. The MIMO radar then receives signals (radar reflected waves) reflected, for example, by an object around the radar using a plurality of reception antennas (also referred to as “reception array antenna”) to separate and receive multiplexed transmission signals from reception signals. With this processing, the MIMO radar can extract propagation path responses indicated by the product of the number of transmission antennas and the number of reception antennas, and perform array signal processing using these reception signals as a virtual reception array. Further, in the MIMO radar, it is possible to enlarge the antenna aperture of the virtual reception array so as to enhance the angular resolution by appropriately arranging element spacings in transmission and reception array antennas.

### [Regarding Polarimetric Radar]

Further, there are techniques for improving radar detection performance or identification performance by using, for example, an antenna that emits differently polarized radio waves or an antenna that receives differently polarized radio waves (see, for example, PTL 3 or 4). A radar apparatus using a plurality of polarized waves is also referred to as a “Polarimetric radar,” for example.

For example, PTL 1 or PTL 2 discloses a method for detecting and identifying an object by transmitting a transmission signal by an antenna using vertically polarized waves or horizontally polarized waves, and by using a signal received by an antenna using vertically polarized waves or horizontally polarized waves. PTL 2 discloses, for example, a method for detecting and identifying an object by transmitting a transmission signal by an antenna using left-handed circularly polarized waves or right-handed circularly polarized waves, and by using a signal received by an antenna using left-handed circularly polarized waves or right-handed circularly polarized waves. Note that an antenna using linearly polarized waves such as the vertically polarized waves or the horizontally polarized waves, or circularly polarized waves such as left-handed circularly polarized waves or right-handed circularly polarized waves are also referred to as a “polarized antenna.”

Such polarimetric radars use a plurality of different types of polarized antennas (for example, polarized transmission antennas or polarized reception antennas).

Below, attention is given to the multiplexing transmission method in a MIMO radar using a plurality of different types of polarized antennas (referred to as, for example, “polarimetric MIMO radar”).

### [Regarding Time Division Multiplexing Transmission]

For example, as a multiplexing transmission method of a MIMO radar using a plurality of transmission antennas, there is Time Division Multiplexing (TDM), which shifts the transmission time for each transmission antenna to transmit signals. Time-division multiplexing, compared to Frequency Division Multiplexing (FDM) and Code Division Multiplexing (CDM), can be realized with a simple configuration, and by sufficiently widening the transmission time intervals, it is possible to maintain good orthogonality between transmission signals.

For example, the MIMO radar using time-division multiplexing transmission disclosed in PTL 3 outputs a transmission pulse, which is an example of a transmission signal (for example, a transmission pulse or radar transmission wave), while sequentially switching transmission antennas that transmit transmission signals at a specified period. The MIMO radar which uses time-division multiplexing transmission receives, at a plurality of reception antennas, signals that are the transmission pulses reflected by an object, performs processing of correlating the reception signals with the transmission pulses, and then performs, for example, spatial Fast Fourier transform (FFT) processing (direction-of-arrival estimation processing on the reflected waves).

A MIMO radar using time-division multiplexing transmission has a specified transmission time (or transmission interval) pre-assigned for each of the plurality of transmission antennas. Therefore, a polarimetric MIMO radar using time-division multiplexing transmission receives reflections from the target object for each transmission time assigned to transmission antennas of a plurality of different polarizations, thereby separating and receiving the reflected waves from the target object corresponding to the transmission signals of the transmission antennas of a plurality of different polarizations.

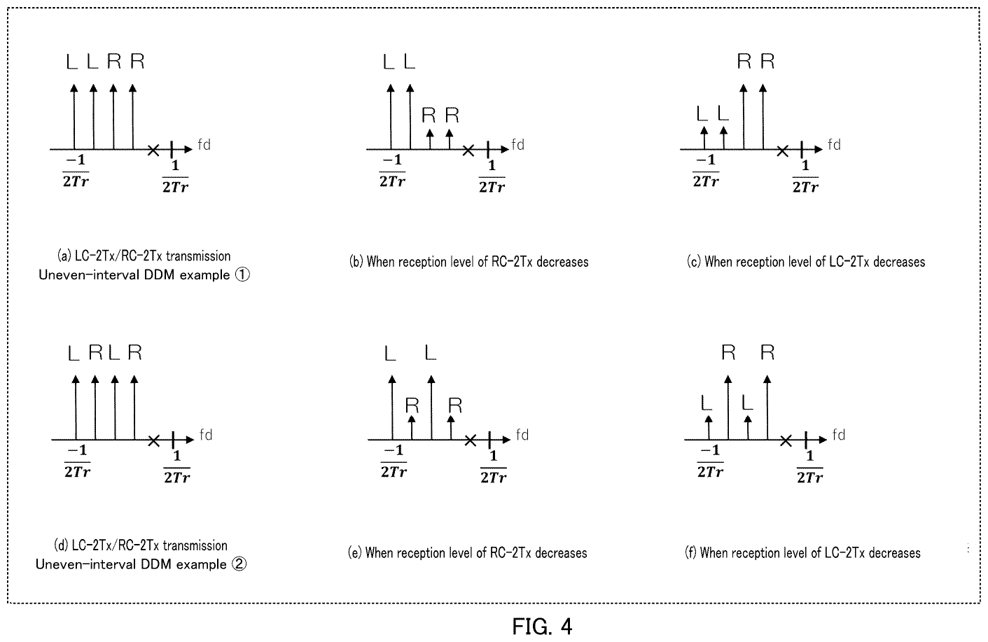

Since a MIMO radar using time-division multiplexing transmission sequentially switches the transmission antenna that transmits the radar transmission wave at specified intervals, the time until the transmission from all transmission antennas is completed is likely to be longer compared to when using frequency division multiplexing transmission or code division multiplexing transmission. Therefore, in a MIMO radar using time-division multiplexing transmission, when transmitting a plurality of radar transmission waves for each transmission antenna and detecting Doppler frequency (for example, relative speed detection) from their reception phase changes (for example, as shown in FIG. 4 of PTL 4), the time interval for observing the reception phase changes in application of Fourier frequency analysis for Doppler frequency detection (for example, relative speed detection) becomes longer. When the time interval for observing the reception phase changes during Fourier frequency analysis becomes longer, the maximum detectable Doppler frequency based on the sampling theorem decreases, and the detectable Doppler frequency range (for example, the range of relative speeds) is likely to narrow.

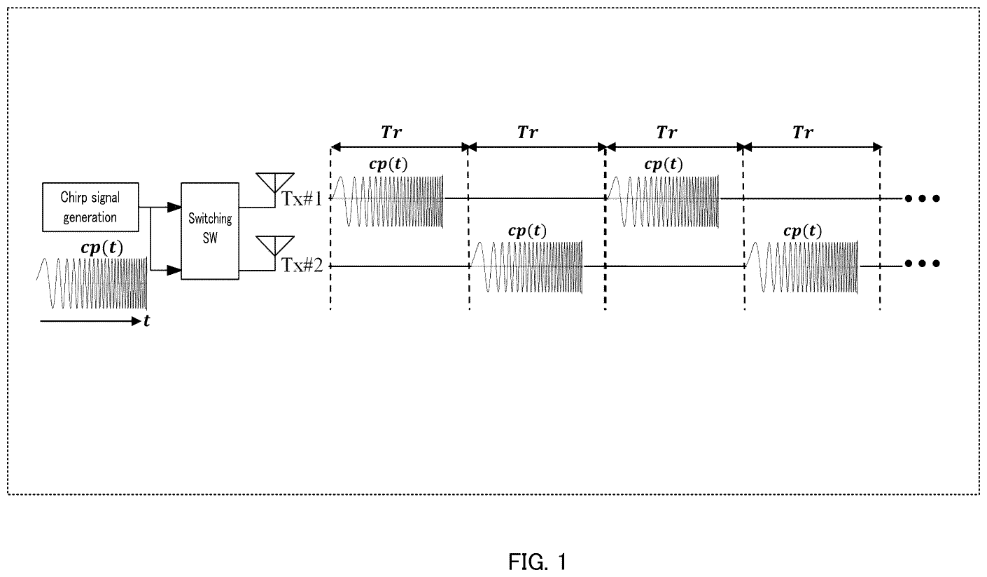

For example, as shown in FIG. 1, a MIMO radar using time-division multiplexing transmission that outputs transmission pulses while sequentially switching transmission antennas (for example, Tx #1 and Tx #2) that emit chirp signals as radar transmission waves at transmission period Tr is described.

For example, in the case of Nt transmission antennas (in the case of FIG. 1, Nt=2), the transmission time until the transmission of radar transmission waves from Nt transmission antennas is completed is Tr×Nt (in the case of FIG. 1, 2Tr). In a MIMO radar using time-division multiplexing transmission, when such time-division multiplexing transmission is repeated Nc times and Fourier frequency analysis is applied for Doppler frequency detection (for example, relative speed detection), the range of Doppler frequencies that can be detected without aliasing becomes ±1/(2Tr×Nt) according to the sampling theorem. Therefore, the range of Doppler frequencies that can be detected without aliasing narrows as number Nt of transmission antennas increases. Further, in a MIMO radar using time-division multiplexing transmission, when receiving Doppler frequencies beyond the range in which detection without aliasing is possible, it becomes difficult to uniquely determine the Doppler frequency (for example, relative speed), and ambiguity is likely to arise.

In a polarimetric radar using time-division multiplexing transmission, similar to the MIMO radar using the above time-division multiplexing transmission, as number Nt of transmission antennas increases, the Doppler frequency range in which a Doppler frequency is detectable without aliasing is likely to narrow.

The example of time-division multiplexing transmission has been described above.

Next, by way of example, attention will be paid to a method of multiplexing and transmitting transmission signals simultaneously from a plurality of transmission antennas.

### [Regarding Doppler Multiplexing Transmission]

Examples of the method for simultaneously multiplexing and transmitting transmission signals from a plurality of transmission antennas include a method (hereinafter referred to as Doppler Division Multiplexing (DDM) transmission) for transmitting signals such that a plurality of transmission signals can be separated in the Doppler frequency domain on the receiver (see, for example, PTL 5).

In Doppler multiplexing transmission, for example, at the transmitter, a phase rotation that gives a different Doppler shift amount to the transmission signal is applied for each transmission antenna, and transmission signals are simultaneously transmitted from a plurality of transmission antennas. In the Doppler multiplexing transmission, the signals (e.g., reflected waves from the target object) received using a plurality of reception antennas are each filtered in the Doppler frequency domain, so that the transmission signals transmitted from the transmission antennas are separated and received.

In a MIMO radar using Doppler multiplexing transmission, for example, a specified Doppler frequency domain (or Doppler shift amount) is pre-assigned for each of the plurality of transmission antennas. For example, a polarimetric MIMO radar using Doppler multiplexing transmission receives reflections from the target object for each Doppler frequency domain assigned to transmission antennas of a plurality of different polarizations, thereby separating and receiving the reflected waves from the target object corresponding to the transmission signals of the plurality of differently polarized transmission antennas.

In the MIMO radar which uses Doppler multiplexing transmission as compared with time-division multiplexing transmission, simultaneous transmission of transmission signals from a plurality of transmission antennas can reduce the time interval for observing the reception phase changes for application of Fourier frequency analysis for Doppler frequency detection (e.g., relative velocity detection). Meanwhile, since filtering is performed on the Doppler frequency axis to separate the transmission signals of the respective transmission antennas in the MIMO radar which uses Doppler multiplexing transmission, the effective Doppler frequency bandwidth per transmission signal is restricted.

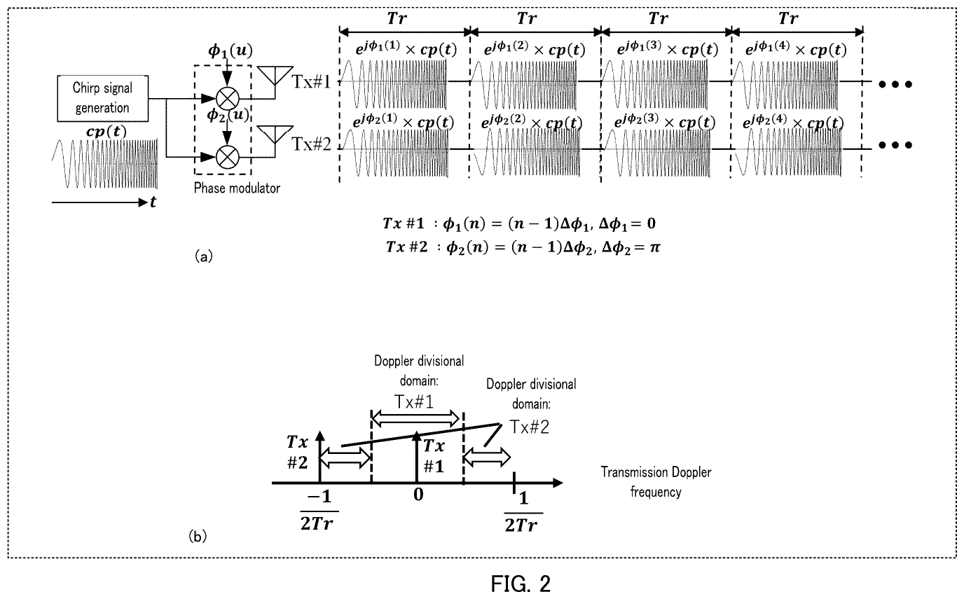

For example, as shown at part (a) in FIG. 2, a MIMO radar using Doppler multiplexing transmission, which repeats, Nc times, the transmission of a chirp signal as the transmission radar wave outputted at transmission periods Tr and applies Fourier frequency analysis for Doppler frequency detection (for example, relative speed detection), is described.

For example, at part (b) in FIG. 2, on the Doppler frequency axis, the Doppler frequency range in which a Doppler frequency is detectable without aliasing becomes ±1/(2Tr) according to the sampling theorem, and compared to when performing time-division multiplexing transmission, it is expanded by Nt times (in the case of FIG. 2, Nt=2). On the other hand, in the MIMO radar using Doppler multiplexing transmission, because the transmission signals are separated by filtering on the Doppler frequency axis, the effective Doppler frequency range per transmission signal becomes narrower than the Doppler frequency range of ±1/(2Tr). For example, when the Doppler frequency range±1/(2Tr) is divided equally into Nt parts (in the case of FIG. 2, Nt=2), and the Doppler shifts, which are also referred to as “Doppler shift amount” or “transmission Doppler shift amount,” of 0 [Hz] and −1/(2Tr)[Hz] are respectively applied to Tx #1 and Tx #2, a MIMO radar using Doppler multiplexing transmission multiplies the chirp signal, which is the transmission signal, (cp(t)) by phase rotations Φ₁(n)=(n−1)ΔΦ₁, Φ₂(n)−(n−1)ΔΦ₂ (where, ΔΦ₁=0, ΔΦ₂=π) every transmission period Tr. Here, n=1, 2, 3, 4, . . . , which is an index representing the number of chirp signal transmissions.

In this case, as shown at part (b) in FIG. 2, a Doppler frequency domain is pre-assigned to each of the plurality of transmission antennas Tx #1 and Tx #2. For example, the domain of Doppler frequency fd1 for Tx #1 (also referred to as “Doppler divisional domain”), is assigned −1/(4Tr)≤fd1<1/(4Tr), and the domain of Doppler frequency fd2 for Tx #2 is assigned −1/(2Tr)≤fd2<−1/(4Tr) and 1/(4Tr)≤fd2<−1/(2Tr).

A MIMO radar using Doppler multiplexing transmission, for example, receives signals reflected by a target object respectively from transmission antennas and separates and receives the transmission signals by filtering processing on the Doppler frequency axis. For example, at part (b) in FIG. 2, the MIMO radar using Doppler multiplexing transmission separates and receives the signal being the transmission signal reflected by the target object from transmission antenna Tx #1 by filtering and extracting within the range of −1/(4Tr)≤fd1<1/(4Tr) on the Doppler frequency axis. Similarly, the MIMO radar using Doppler multiplexing transmission separates and receives the signal being the transmission signal reflected by the target object from transmission antenna Tx #2 by filtering and extracting within the range of −1/(2Tr)≤fd2<−1/(4Tr) and 1/(4Tr)≤fd2<−1/(2Tr) on the Doppler frequency axis.

Thus, in the MIMO radar using Doppler multiplexing transmission, reception processing is performed on the reflected wave signals corresponding to the transmission signals from respective transmission antennas based on an assumption that the signals are included within the Doppler frequency range of ±1/(2Tr×Nt), resulting in a Doppler frequency range similar to that of time-division multiplexing transmission. For example, in the MIMO radar using Doppler multiplexing transmission, the larger number Nt of transmission antennas, the narrower the Doppler frequency range in which detection is possible without aliasing becomes.

Similarly, in a polarimetric MIMO radar using Doppler multiplexing transmission, as with the aforementioned MIMO radar using Doppler multiplexing transmission, the larger number Nt of transmission antennas, the narrower the Doppler frequency range in which detection is possible without aliasing becomes.

### [Regarding Uneven-Interval Doppler Multiplexing Transmission]

The aforementioned time-division multiplexing transmission or Doppler multiplexing transmission can separate the reflected waves corresponding to the transmission signals from a plurality of transmission antennas using the assigned transmission time or Doppler frequency domain. On the other hand, with time-division multiplexing transmission and Doppler multiplexing transmission, as the number of transmission antennas increases, the detection range of Doppler frequencies is likely to narrow. For example, in time-division multiplexing and Doppler multiplexing, the detectable Doppler frequency range is −1/(2Nt×Tr)≤fd<1/(2Nt×Tr), and the detection range of Doppler frequencies narrows inversely proportional to the number of transmission antennas. Here, Nt is the number of transmission antennas.

For example, PTL 6 and PTL 7 disclose methods for expanding the detection range of Doppler frequencies in Doppler multiplexing transmission. PTL 7 (for example, FIG. 4) discloses the following method. For example, the detectable Doppler frequency range in which a Doppler frequency is detectable without aliasing, ±1/(2Tr), is divided equally into (Nt+1) Doppler shift amounts (or Doppler frequency domains), of which Nt Doppler shift amounts are assigned to Nt transmission signals, and transmission signals from Nt transmission antennas are transmitted simultaneously.

In such Doppler multiplexing transmission, some of the (Nt+1) equally divided Doppler shift amounts are not assigned to transmission signals. Therefore, in the Doppler frequency domain, the intervals of Doppler shift amounts given to the Doppler-multiplexed transmission signals (hereinafter, also referred to as “Doppler multiplexing intervals”) become uneven. Hereinafter, such Doppler multiplexing transmission is referred to as “uneven-interval Doppler Multiplex Transmission (uneven-interval DDM).”

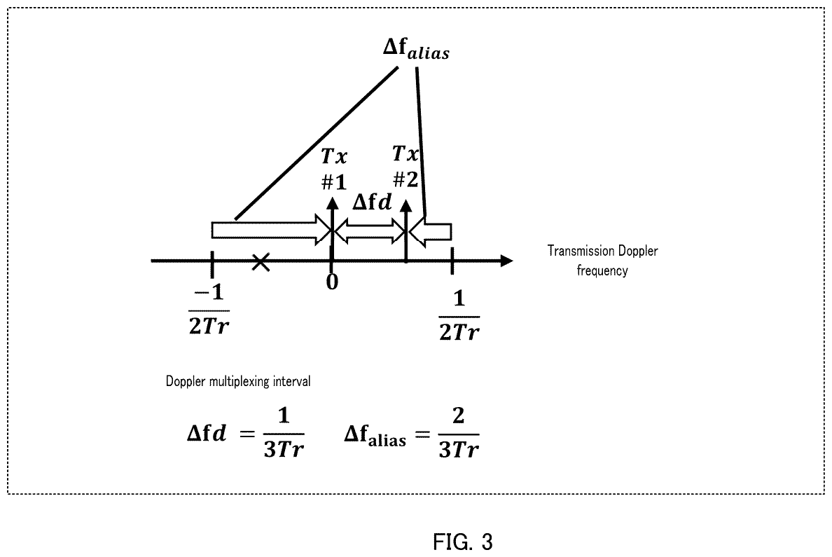

FIG. 3 shows an example of assigning Doppler multiplexed signals using uneven interval Doppler multiplexing transmission when transmitting radar transmission waves (for example, chirp signals) every transmission period Tr, using transmission antennas with Nt=2, and setting the unit of Doppler multiplexing interval to Δfd=1/(3Tr).

In FIG. 3, the transmission Doppler shift amounts assigned to transmission antennas Tx #1 and Tx #2 are Δfd1=0 and Δfd2=1/(3Tr)[Hz], respectively. For example, to give transmission Doppler shift amount Δfd1 to transmission antenna Tx #1 in every nth transmission period, phase rotation Φ₁(n)=ΔΦ₁×(n−1) is applied to the radar transmission wave (chirp signal). Similarly, for example, to give transmission Doppler shift amount Δfd2 to transmission antenna Tx #2 in every nth transmission period, phase rotation Φ₂(n)−ΔΦ₂×(n−1) is applied to the radar transmission wave (chirp signal). Note that there is no transmission antenna assignment for Doppler shift amount Δfd3 corresponding to phase rotation Φ₃(n)=ΔΦ₃×(n−1).

Here, FIG. 3 shows the transmission Doppler frequencies assigned to transmission antennas Tx #1 and Tx #2 when Δfd1=0, Δfd2=1/(3Tr), ΔΦ₁=0, and ΔΦ₂=2π×Δfd×Tr=2π/3. In FIG. 3, the transmission Doppler frequency when Δfd3=2/(3Tr) and ΔΦ₃=2π×2Δfd×Tr=4π/3 (or, −2π/3) is represented by an “×” mark. As shown in FIG. 3, there is no transmission antenna assignment for Doppler shift amount Δfd3.

Note that phase rotation (n may be expressed as −π≤ΔΦₙ<π. For example, ΔΦ₃=−2π/3 may be expressed. The same applies hereinafter.

For example, a case is considered in which, as shown in FIG. 3, the Doppler multiplexing interval for Tx #1 and Tx #2 is Δfd=1/(3Tr), the observable range (region) of Doppler frequencies is −1/(2Tr)≤fd<1/Tr, and Doppler frequencies outside this range are included. For example, when the reception Doppler frequency of the Doppler multiplexed signal from Tx #1 or Tx #2 exceeds 1/(2Tr) or is less than −1/(2Tr), as shown in FIG. 3, the Doppler multiplexing interval for Tx #1 and Tx #2 becomes Δfₐₗᵢₐₛ=1/Tr−Δfd=⅔Tr. In the following, when the “Doppler multiplexing interval” or “Doppler shift interval” is referred to, Δfₐₗᵢₐₛ is included in addition to Δfd.

Next, examples of demultiplexing reception processing of Doppler multiplexed signals using uneven interval Doppler multiplexing transmission will be described.

In the demultiplexing reception processing of Doppler multiplexed signals using uneven interval Doppler multiplexing transmission, for example, the following character is utilized for Doppler frequency detection (e.g., relative speed detection) of reception signals of the radar reflection signals.

For example, in an output resulting from application of Fourier frequency analysis, among the equally divided Nt+1 Doppler shift amounts, the reception power level of the Doppler frequency corresponding to the Doppler shift amount not assigned to the transmission signal is sufficiently lower (e.g., about the noise level) than the reception power level of the Doppler frequency corresponding to the Doppler shift amount assigned to the transmission signal.

The MIMO radar using uneven interval Doppler multiplexing transmission utilizes this character to estimate the reception Doppler frequency of the reflection from the target object and to perform separation processing of the transmission antennas.

For example, the reception Doppler frequency of the reflection from the target object is denoted as “fd_{target}.” In this case, in the output resulting from application of Fourier frequency analysis to Doppler frequency detection (e.g., relative speed detection) of the radar reflected wave reception signal, the reception levels of Doppler frequencies fd_{target}+Δfd1 and fd_{target}+Δfd2 are observed to be high (e.g., above a threshold). On the other hand, in the output resulting from application of Fourier frequency analysis to Doppler frequency detection (e.g., relative speed detection), the reception level of Doppler frequency fd_{target}+Δfd3 is observed to be sufficiently low, as about the noise level, compared to the reception levels of Doppler frequencies fd_{target}+Δfd1 and fd_{target}+Δfd2.

Note that the output resulting from application of Fourier frequency analysis to Doppler frequency detection (e.g., relative speed detection) is observed in the range of −1/(2Tr)≤fd<1/(2Tr), and thus, when this range is exceeded, the output resulting from application of Fourier frequency analysis is observed as an aliasing signal within −1/(2Tr)≤fd<1/(2Tr).

When the reception Doppler frequency fd_{target} of the reflection from the target object is within the range of −1/(2Tr)≤fd_{target}<1/(2Tr), the reception Doppler frequencies that satisfy the aforementioned relationship become unique within the range of −1/(2Tr)≤fd_{target}<1/(2Tr), thus, the MIMO radar using uneven interval Doppler multiplexing transmission can unambiguously determine the target-object Doppler frequency fd_{target} within this range. For example, when determining Doppler frequency fd_{target} corresponding to a target object, the MIMO radar using uneven-interval Doppler multiplexing transmission can determine the reception Doppler frequency for each transmission antenna, enabling the demultiplexing reception of Doppler multiplexed signals.

Such demultiplexing reception processing of Doppler multiplexed signals enables the MIMO radar using uneven-interval Doppler multiplexing transmission, for example, to estimate the Doppler frequencies of radar reflections within the Doppler frequency range of ±1/(2Tr). Uneven-interval Doppler multiplexing transmission expands the detectable Doppler frequency range to ±1/(2Tr). For example, compared to the method in PTL 3, uneven-interval Doppler multiplexing transmission expands the detectable Doppler frequency range by Nt times.

### [Regarding Application of Uneven-Interval Doppler Multiplexing Transmission to Polarimetric MIMO Radar]

As mentioned above, in uneven-interval Doppler multiplexing, unlike even-interval Doppler multiplexing, some Doppler frequency domains are not assigned to the transmission signal, and the MIMO radar performs demultiplexing processing on Doppler multiplexed signals to estimate the target-object Doppler frequency based on the reception power of the reception Doppler frequency of reflections from the target object.

Therefore, when applying uneven-interval Doppler multiplexing to the polarimetric MIMO radar, the following can be anticipated.

In the polarimetric MIMO radar, for example, the reception level of reflected waves can vary significantly depending on the polarization of the transmission and reception antennas. In the polarimetric MIMO radar, when using transmission antennas of different polarizations, the reception level of reflected waves from a transmission antenna of one polarization may significantly attenuate compared to that from a transmission antenna of another polarization. Therefore, in the polarimetric MIMO radar, when multiplexing transmission using uneven-interval Doppler multiplexing, when there is a large difference in the reception level of reflections between transmission antennas of different polarizations, Doppler demultiplexing using uneven-interval Doppler multiplexing may become difficult. When Doppler demultiplexing becomes difficult, it may lead to degradation in the detection performance of target objects in the MIMO radar, or errors in Doppler demultiplexing, resulting in incorrect Doppler estimation or degradation of angle measurement performance.

Below, examples where Doppler demultiplexing becomes difficult in the polarimetric MIMO radar applying uneven-interval Doppler multiplexing are described.

Here, as an example, the case of configuring a MIMO radar with two transmission antennas for each of both left-handed circular polarization (hereafter, also referred to as “LC”) and right-handed circular polarization (hereafter, also referred to as “RC”) (denoted as LC-2Tx and RC-2Tx, respectively) (for example, with a total of Nt=4 transmission antennas) is described. For example, the polarization antenna corresponding to left-handed circular polarization is called “LC polarization antenna” (for example, LC polarized transmission antenna, or LC polarization reception antenna), and the polarization antenna corresponding to right-handed circular polarization is called “RC polarization antenna” (for example, RC polarized transmission antenna, or RC polarization reception antenna).

For example, the case where the MIMO radar receives a once-reflected wave (a reflected wave, which is reflected once on a target object) using an LC polarization reception antenna is described. In this case, the reflected wave signal corresponding to the transmission signal from the RC polarized transmission antenna (for example, also called “reception signal corresponding to the RC polarized transmission antenna”) is a reception signal as an RC polarized wave, and when the reception signal corresponding to the RC polarized transmission antenna is received by the LC polarization reception antenna, the reception is a cross-polarized reception. Therefore, the reception level of the reception signal corresponding to the RC polarized transmission antenna at the LC polarization reception antenna is lower (for example, by 10 dB or more depending on the cross-polarization discrimination degree of the antenna) compared to the reception level of the reflected wave signal corresponding to the transmission signal from the LC polarized transmission antenna (for example, also called “reception signal corresponding to the LC polarized transmission antenna”). For example, the reception level of the reception signal corresponding to the RC polarized transmission antenna may become at or below the noise level depending on the reception quality (for example, Signal to Noise Ratio (SNR)), making it difficult to detect Doppler frequency peaks in the MIMO radar.

FIG. 4 is a diagram showing an example of signals that are transmitted by Doppler multiplexing in the polarimetric MIMO radar. In FIG. 4, the signal assigned to the LC polarized transmission antenna is represented by “L,” and the signal assigned to the RC polarized transmission antenna is represented by “R.”

For example, as shown at part (a) in FIG. 4, when Doppler multiplexed signals are assigned and the LC polarization reception antenna receives a once-reflected wave, the reception level of the reception signal (R) corresponding to the RC polarized transmission antenna may be lower compared to the reception signal (L) corresponding to the LC polarized transmission antenna as shown at part (b) in FIG. 4.

Further, for example, an explanation is given for the case where the MIMO radar receives a twice-reflected wave (a reflected wave that is reflected twice by an object) using an LC polarization reception antenna. In this case, because the reception signal corresponding to the LC polarized transmission antenna received by the LC polarization reception antenna is reflected twice, it becomes a reception signal as an RC polarized wave, and when received by the LC polarization reception antenna, the reception becomes cross-polarized reception. Thus, the level of the reception signal corresponding to the LC polarized transmission antenna is lower (for example, by 10 dB or more depending on the cross-polarization discrimination degree of the antenna) compared to the reception signal corresponding to the RC polarized transmission antenna. For example, the reception level of the reception signal corresponding to the LC polarized transmission antenna may become below the noise level depending on the reception quality (SNR), making it difficult to detect Doppler frequency peaks in the MIMO radar.

For example, as shown at part (a) in FIG. 4, when Doppler multiplexed signals are assigned and the LC polarization reception antenna receives a twice-reflected wave, the reception level of the reception signal (L) corresponding to the LC polarized transmission antenna may be lower compared to the reception signal (R) corresponding to the RC polarized transmission antenna as shown at part (c) in FIG. 4.

Here, in the MIMO radar, when the number of reflections is unknown in advance, it is difficult to determine based on the reception levels shown at part (b) or (c) in FIG. 4 whether the reception level of the reception signal corresponding to the RC polarized transmission antenna has decreased or the reception level of the reception signal corresponding to the LC polarized transmission antenna has decreased. Further, for example, it is difficult for the MIMO radar to determine which transmission antenna the detected Doppler frequency peak in the signal corresponds to, based on the reception levels shown at part (b) or (c) in FIG. 4, when using uneven-interval Doppler multiplexing transmission. Therefore, it becomes difficult for the MIMO radar to separate Doppler multiplexed signals and to determine Doppler frequency fd of the reflected waves from the target object (for example, referred to as “target-object reflected waves”) within the range of

$$- 1 / ( 2 Tr ) \leq fd < 1 / ( 2 Tr ) .$$

Similarly, when Doppler multiplexed signals are assigned as shown at part (d) in FIG. 4, and MIMO radar receives a once-reflected wave using an LC polarization reception antenna, the reception signal (R) corresponding to the RC polarized transmission antenna is an RC polarized wave as shown at part (e) in FIG. 4, resulting in a lower reception level compared to the reception signal (L) corresponding to the LC polarized transmission antenna, which is an LC polarized wave (for example, lower by 10 dB or more depending on the cross-polarization discrimination degree of the antenna).

Further, when the MIMO radar receives a twice-reflected wave using an LC polarization reception antenna, as shown at part (f) in FIG. 4, since the reception signal (L) corresponding to the LC polarized transmission antenna is an RC polarized wave, the reception level becomes lower compared to the reception signal (R) corresponding to the RC polarized transmission antenna, which is an LC polarized wave (for example, lower by 10 dB or more depending on the cross-polarization discrimination degree of the antenna).

In parts (e) and (f) in FIG. 4, the reception signals with reduced reception levels may fall below the noise level depending on the reception quality (SNR), making it difficult to detect Doppler frequency peaks in the MIMO radar. Moreover, it is difficult for the MIMO radar to determine, based on the reception levels shown at part (e) or (f) in FIG. 4, whether the reception level of the transmission signal from the RC polarized transmission antenna has decreased or that from the LC polarized transmission antenna has decreased. Therefore, it becomes difficult for the MIMO radar to separate Doppler multiplexed signals and to determine Doppler frequency fd of the target-object reflected waves within the range of −1/(2Tr)≤fd<1/(2Tr).

Thus, in uneven-interval Doppler multiplexing, Doppler demultiplexing processing is performed on the assumption that the reception levels of each transmission antenna are approximately the same as shown at part (a) in FIG. 4, and the reception levels of the Doppler multiplexing intervals (marked with ×) that are not Doppler multiplexed are sufficiently low, about the noise level. In the polarimetric MIMO radar using uneven-interval Doppler multiplexing, the assumptions for the separation processing of uneven-interval Doppler multiplexing may collapse as shown at part (b), (c), (e), or (f) in FIG. 4, potentially leading to errors in Doppler demultiplexing processing.

In a non-limiting example of the present disclosure, a method for improving the detection performance of the polarimetric MIMO radar using uneven-interval Doppler multiplexing transmission is described.

It should be noted that, although the example described here involves configuring the MIMO radar using two transmission antennas for each of both left-handed circular polarization (LC) and right-handed circular polarization (RC) (for example, number Nt of transmission antennas=4), the polarizations used in the polarimetric MIMO radar are not limited to these.

For example, in the polarimetric MIMO radar, different linear polarizations that are orthogonal to each other may be applied. For example, linear polarizations that are orthogonal to each other, such as applying vertical polarization instead of left-handed circular polarization (LC) and horizontal polarization instead of right-handed circular polarization (RC), may be applied. When radar transmission waves are transmitted using such vertically and horizontally polarized transmission antennas, the closer the angle of incidence when the radar transmission waves are reflected by the target object is to the Brewster angle, the reflected wave of one of the vertical polarization and the horizontal polarization may have a weaker reflected-wave reception level compared to the other polarization. In the MIMO radar, for example, when such reflected waves are received using a polarization reception antenna corresponding to either the vertical polarization or the horizontal polarization, the reception signal corresponding to the transmission antenna of one of the vertical polarization and the horizontal polarization becomes a cross-polarized reception, and may have a lower reception level (for example, lower by 10 dB or more depending on the cross-polarization discrimination degree of the antenna) compared to the reception signal corresponding to the other polarized transmission antenna. The reception signal with reduced reception level may fall below the noise level depending on the reception quality (SNR), making it difficult to detect Doppler frequency peaks in the MIMO radar.

For instance, when vertical polarization is applied instead of left-handed circular polarization (LC) and horizontal polarization is applied instead of right-handed circular polarization (RC), and Doppler multiplexed signals are assigned as at part (a) in FIG. 4, the reception signals could be as shown at part (b) in FIG. 4 or part (c) in FIG. 4. Further, for example, when vertical polarization is applied instead of left-handed circular polarization (LC) and horizontal polarization is applied instead of right-handed circular polarization (RC), and Doppler multiplexed signals are assigned as at part (d) in FIG. 4, the reception signals could be as shown at part (e) in FIG. 4 or FIG. 4(f).

Even when using vertical and horizontal polarized transmission antennas, it is difficult for the MIMO radar to determine whether the reception level of the transmission signal from the horizontal polarized transmission antenna has decreased or the reception level of the transmission signal from the vertical polarized transmission antenna has decreased, based on the reception levels shown at part (b), (c), (e), or (f) in FIG. 4, for example. Therefore, for example, it becomes difficult for the MIMO radar to separate Doppler multiplexed signals and to determine Doppler frequency fd of the target-object reflected wave within the range of −1/(2Tr)≤fd<1/(2Tr).

Embodiments according to exemplary embodiments of the present disclosure will be described below in detail with reference to the accompanying drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

Further, the radar apparatus may perform Doppler multiplexing transmission (for example, uneven interval Doppler multiplexing transmission). Additionally, the radar apparatus may be equipped with a polarization antenna.

### [Configuration of Radar Apparatus]

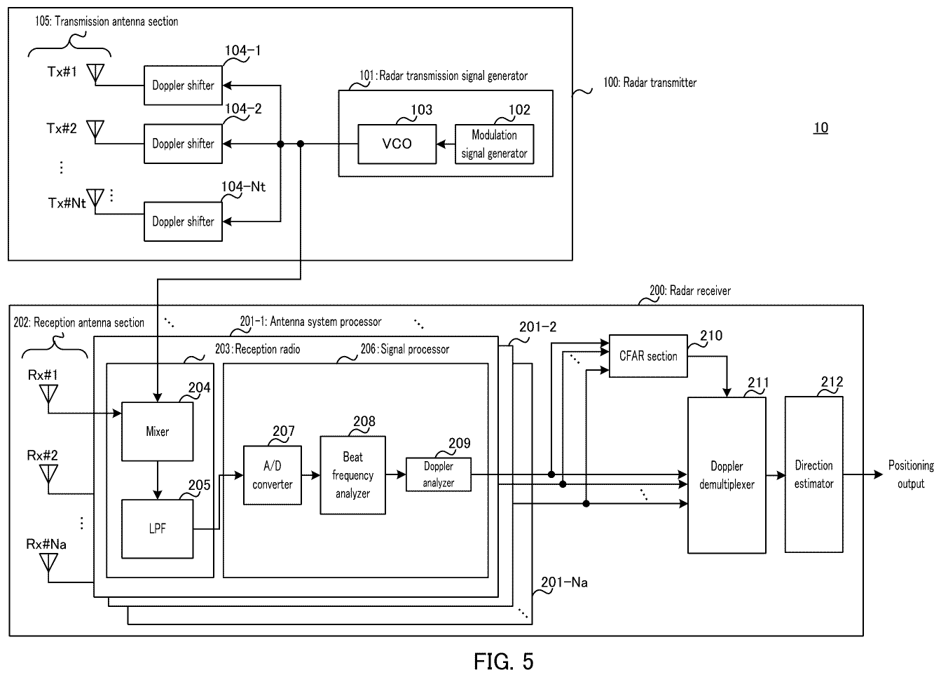

Radar apparatus 10 shown in FIG. 5 includes radar transmitter (transmission branch) 100 and radar receiver (reception branch) 200.

Radar transmitter 100 generates radar signals (radar transmission signals) and transmits the radar transmission signals in a defined transmission period (e.g., referred to as “radar transmission period”) using transmission antenna section 105 composed of a plurality of transmission antennas 109 (for example, Nt transmission antennas).

Radar receiver 200 receives the reflected wave signal, which is the radar transmission signal reflected by the target object (target; not illustrated), using reception antenna section 202 that includes a plurality of reception antennas. Radar receiver 200 performs signal processing on the reflected wave signals received each reception antenna of reception antenna section 202 to, for example, detect the presence or absence of the target object, or estimate the distances through which the reflected wave signals arrive, the Doppler frequencies (for example, the relative velocities), and the directions of arrival, and outputs information on an estimation result (for example, positioning information).

Note that, radar apparatus 10 may be mounted, for example, on a mobile body such as a vehicle, and a positioning output of positioning output section 300 (e.g., information on the estimation result) may, for example, be connected to an Electronic Control Unit (ECU) (not illustrated) of a control apparatus such as an Advanced Driver Assistance System (ADAS) or an autonomous driving system for enhancing the collision safety and utilized for a vehicle drive control or alarm call control.

Radar apparatus 10 may also be mounted on a relatively high-altitude structure (not illustrated), such as, for example, a roadside utility pole or traffic lights. Radar apparatus 10 may also be utilized, for example, as a sensor of a support system for enhancing the safety of passing vehicles or pedestrians, or as a sensor of a suspicious intrusion prevention system (not illustrated). The positioning output of radar receiver 200 may also be connected, for example, to a control device (not illustrated) in the support system or the suspicious intrusion prevention system for enhancing safety and may be utilized for an alarm call control or an abnormality detection control. The use of radar apparatus 10 is not limited to the above, and may also be used for other uses.

In addition, the target object is an object to be detected by radar apparatus 10. Examples of the target object include vehicles (including four-wheel and two-wheel vehicles), a person, and a block or a curb.

### [Configuration of Radar Transmitter 100]

Radar transmitter 100 includes radar transmission signal generator 101, Doppler shifters 104, and transmission antenna section 105.

Radar transmission signal generator 101 generates a radar transmission signal. Radar transmission signal generator 101 includes, for example, modulation signal generator 102 and Voltage Controlled Oscillator (VCO) 103. Hereinafter, the components of radar transmission signal generator 101 will be described.

Modulation signal generator 102 periodically generates, for example, saw-toothed modulation signals.

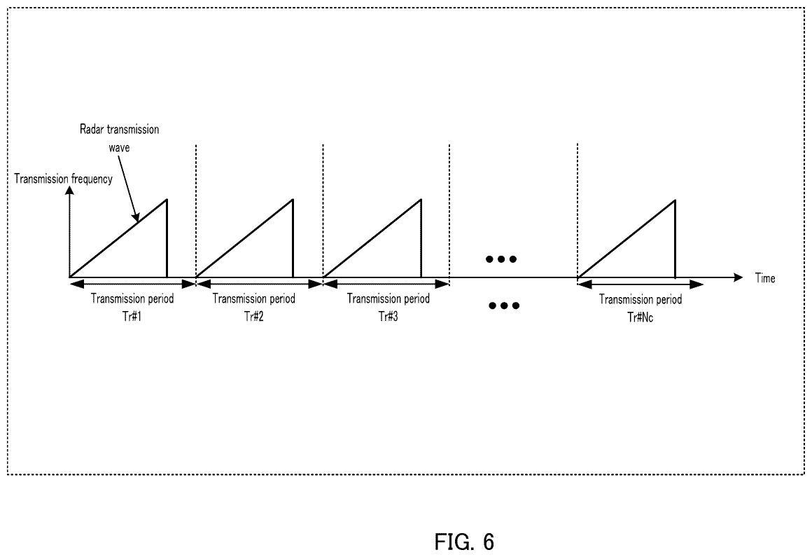

VCO 103 outputs, based on the modulation signals inputted from modulation signal generator 102, frequency-modulated signals (hereinafter referred to as, for example, frequency chirp signals or chirp signals) to Doppler shifters 104 and radar receiver 200 (mixer 204 described below) as the radar transmission signals (radar transmission waves) illustrated in FIG. 6.

In the following, modulation signal generator 102 generates a modulation signal to transmit the chirp signal Nc times for each transmission period Tr per radar positioning. VCO 103 outputs the chirp signal Nc times for each transmission period Tr based on the operation of modulation signal generator 102.

Radar apparatus 10 may detect temporal variations in the position of a target object by performing multiple radar positionings, for example.

Further, in the following description, each transmission period among Nc transmission periods Tr is represented by index “m.” Here, m is an integer of 1 to Nc.

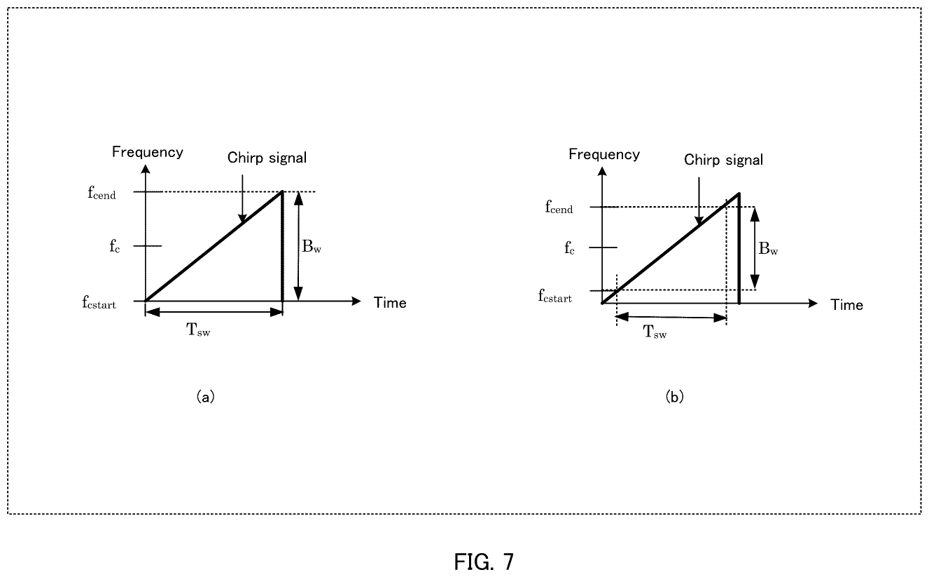

FIG. 7 illustrates an example of the chirp signal output from radar transmission signal generator 101.

As illustrated in FIG. 7, the modulation parameters for the chirp signal may include, for example, center frequency f_{c}, frequency sweep bandwidth B_{w}, sweep start frequency fₑₛₜₐᵣₜ, sweep end frequency f_{cend}, frequency sweep duration T_{sw}, and frequency sweep change rate Dₘ. Note that Dₘ=B_{w}/T_{sw}. Note also that B_{w}=f_{cend}−fₑₛₜₐᵣₜ, and f_{c}=(fₑₛₜₐᵣₜ+f_{cend})/2.

Frequency sweep time T_{sw} corresponds to, for example, a time range (also called a range gate) in which A/D sampled data is taken by A/D converter 207 of radar receiver 200, which will be described later. Frequency sweep time T_{sw} may be set to an entire time section of the chirp signal as illustrated at (a) in FIG. 7, or may be set to a partial time section of the chirp signal as illustrated at (b) in FIG. 7, for example.

Note that FIGS. 6 and 7 illustrate examples of up-chirp waveforms in which the modulation frequency gradually increases with time, but the present disclosure is not limited thereto, and down-chirp in which the modulation frequency gradually decreases with time may be applied. Similar effects can be obtained regardless of whether the modulation frequency is of up-chirps or down-chirps.

The chirp signal output from radar transmission signal generator 101 is input to each of Nt Doppler shifters 104. Also, the chirp signal is input to each mixer 204 of radar receiver 200.

The nth Doppler shifter 104, for example, applies phase rotation Φₙ(m) for each transmission period Tr of the chirp signal to apply specified Doppler shift amount DOPₙ to the chirp signal input from radar transmission signal generator 101. The nth Doppler shifter 104 outputs the chirp signal, to which phase rotation Φₙ(m) has been applied, to the nth transmission antenna (for example, Tx #n) of transmission antenna section 105. Here, n=1 to Nt.

Transmission antenna section 105 may include Nt transmission antennas Tx #1 to Tx #Nt. Transmission antennas Tx #1 to Tx #Nt may include at least two types of transmission antennas (polarized transmission antennas) with different polarizations, and may constitute a polarimetric radar. For example, Doppler shifters 104 may apply phase rotation Φₙ(m) that provides a different Doppler shift amount for each transmission antenna of transmission antenna section 105, based on the configuration of transmission antennas with different polarizations, to the chirp signal and output it to transmission antenna section 105. Thus, even when there is a significant difference in reception levels between reception signals corresponding to transmission antennas with different polarizations (for example, when the difference in reception levels exceeds a threshold), radar apparatus 10 can separate Doppler multiplexed signals, reducing degradation in positioning performance and radar detection capability (exemplary operations will be described later).

The output from Nt Doppler shifters 104 is amplified to a specified transmission power and then radiated into space from each of transmission antennas Tx #1 to Tx #Nt of transmission antenna section 105.

### [Configuration of Radar Receiver 200]

In FIG. 5, radar receiver 200 includes reception antenna section 202 including Na reception antennas Rx #1 to Rx #Na. Radar receiver 200 further includes Na antenna system processors 201-1 to 201-Na, Constant False Alarm Rate (CFAR) section 210, coded Doppler demultiplexer 211, and direction estimator 212.

Reception antennas Rx #1 to Rx Na of reception antenna section 202 each receive a reflected wave signal that is a radar transmission signal reflected from a target object (target), and output the received reflected wave signal to the corresponding one of antenna system processors 201 as a reception signal.

Each of antenna system processors 201 includes reception radio 203 and signal processor 206.

Signals received by Na reception antennas Rx #1 to Rx #Na are output respectively to Na reception radios 203. Further, the output signals from Na reception radios 203 are output respectively to Na signal processors 206.

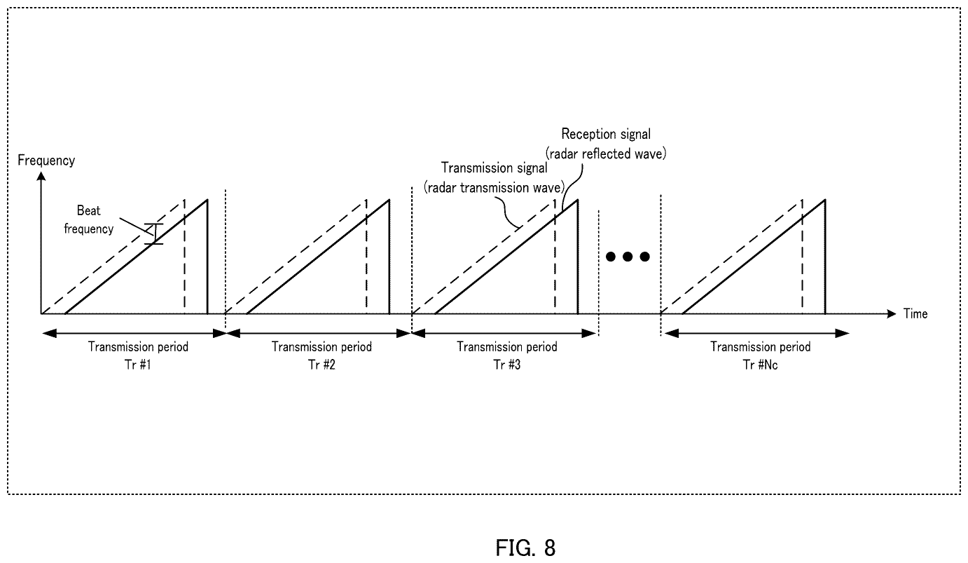

Each of reception radios 203 includes mixer 204 and low pass filter (LPF) 205. Mixer 204 mixes the received reflected wave signal with a chirp signal inputted from radar transmission signal generator 101 which is a transmission signal. Reception radio 203, for example, passes the output of mixer 204 through LPF 205. As a result, a beat signal, which has a frequency depending on a delay time of the reflected wave signal, is output. For example, as shown in FIG. 8, the difference in frequency between the transmitting chirp signal (transmitting frequency modulated wave), which is the transmission signal (radar transmission wave), and the reception chirp signal (received frequency modulated wave), which is the reception signal (radar reflected wave), is obtained as the beat frequency.

Signal processor 206 of each antenna system processor 201-z (where z=any one of 1 to Na) includes AD converter 207, beat frequency analyzer 208, and Doppler analyzer 209.

The signal (for example, beat signal) outputted from LPF 205 is converted into discretely sampled data by AD converter 207 in signal processor 206.

Beat frequency analyzer 208 performs frequency analysis processing (for example, FFT processing) on the N_{data} pieces of discrete sample data obtained within a specified time range (range gate) for each transmission period Tr. Signal processor 206 thus outputs a frequency spectrum in which a peak appears at a beat frequency dependent on the delay time of the reflected wave signal (radar reflected wave). In the FFT processing, for example, beat frequency analyzer 208 may perform multiplication by a window function coefficient such as the Han window or the Hamming window. The application of a window function coefficient can suppress sidelobes around the beat frequency peak.

When N_{data} is not a power of 2, FFT processing can be performed with a data size (FFT size) that is a power of 2 by including zero-padded data, for example. In such cases, it is acceptable to treat the data size including the zero-padded data as N_{data}, in the same manner as above.

Here, the beat frequency response output from beat frequency analyzer 208 in zth signal processor 206 obtained by the mth chirp pulse transmission is denoted as “RFT_{z}(f_{b}, m).” Here, f_{b} denotes the beat frequency index and corresponds to an FFT index (bin number). For example, f_{b}=0, . . . , (N_{data}/2)−1, z=1 to Na, and m=1 to N_{C}. A beat frequency having smaller beat frequency index f_{b} indicates a shorter delay time of the reflected wave signal (for example, a shorter distance to the target object).

Further, beat frequency index f_{b} can be converted into distance information R(f_{b}) using following Expression 1. Thus, in the following, beat frequency index f_{b} is also referred to as “distance index f_{b}.”

$$[ 1 ]$$

$$R ( {f}_{b} ) = \frac{{C}_{0} {f}_{b}}{2 {B}_{w}} \qquad ( Expression 1 )$$

Here, B_{w} denotes a frequency-modulation bandwidth within the range gate for a chirp signal, and C₀ denotes the speed of light. Also, in Expression 1, C₀/(2B_{w}) represents the distance resolution.

Doppler analyzer 209 in zth signal processor 206 performs Doppler analysis for each distance index f_{b} using data from Nc transmission periods of the chirp signal (for example, beat frequency responses RFT_{z}(f_{b}, 1), RFT_{z}(f_{b}, 2), . . . , RFT_{z}(f_{b}, Nc) input from beat frequency analyzer 208).

For example, when Nc is a power of 2, Doppler analyzer 209 can apply FFT processing in Doppler analysis as in following Expression 2:

$$\begin{matrix}( Expression 2 ) & \\ V F {T}_{z} ( {f}_{b} , {f}_{s} ) = {\sum }_{m = 1}^{{N}_{c}} RF {T}_{z} ( {f}_{b} , m ) exp [ - \frac{j 2 π ( m - 1 ) {f}_{s}}{{N}_{c}} ] & [ 2 ]\end{matrix}$$

Here, the FFT size is Nc, and the maximum Doppler frequency without aliasing derived from the sampling theorem is ±1/(2Tr). Also, the Doppler frequency interval of Doppler frequency index fₛ is 1/(Nc×Tr), and the range of Doppler frequency index fₛ is fₛ=−N_{c}/2, . . . , 0, . . . , (N_{c}/2)−1. Further, j is the imaginary unit, and z=1 to Na.

By way of example, a description will be given of a case where Nc is a power of 2. When Nc is not a power of 2, FFT processing can be performed with a data size (FFT size) that is a power of 2 by including zero-padded data, for example. In the FFT processing, Doppler analyzer 209 may perform multiplication by a window function coefficient such as the Han window or the Hamming window. The application of a window function can suppress sidelobes around the Doppler frequency peak.

The processing in each component of signal processor 206 has been described above.

In FIG. 5, CFAR section 210 performs CFAR processing (for example, adaptive threshold determination) using the output of Doppler analyzer 209 of each of first to Nath signal processors 206. For example, in CFAR processing, local peaks of the reception signals of the reflected radar transmission signals sent from transmission antenna section 105 may be selectively extracted and adaptive threshold determination may be performed. CFAR section 210, for example, extracts distance index f_{b_cfar} and Doppler frequency index f_{s_cfar} that provide the local peak signals, and outputs them to Doppler demultiplexer 211.

Doppler demultiplexer 211, for example, uses the outputs of Doppler analyzers 209 of first to Nath signal processors 206, and the output of CFAR section 210, to demultiplex (hereinafter referred to as “Doppler demultiplexing”) the radar reflected-wave reception signals for respective radar transmission signals sent from a plurality of transmission antennas using Doppler multiplexing.

The operation of Doppler demultiplexer 211, for example, is related to the operation of Doppler shifters 104 of radar transmitter 100. Similarly, the operation of CFAR section 210, for example, is related to the operation of Doppler shifters 104. Hereinafter, an exemplary operation of Doppler shifters 104 will be described, followed by examples of the operations of CFAR section 210 and Doppler demultiplexer 211.

### [Exemplary Operation of Doppler Shifter 104 in Radar Transmitter 100]

First to Ntth Doppler shifters 104, for example, perform Doppler multiplexing transmission by applying different Doppler shift amounts DOPₙ to the radar transmission signals input respectively to them.

Hereinafter, an example using a chirp signal as the radar transmission signal will be described.

For example, in order to apply specified Doppler shift amount DOPₙ to nth transmission antenna Tx #n, nth Doppler shifter 104 applies phase rotation Φₙ(m) for each transmission period Tr for the input chirp signal and outputs the chirp signal. Here, Doppler shifter 104 may apply and output phase rotation Φₙ(m) that provides a different Doppler shift for each transmission antenna through which the chirp signal is transmitted. Here, n=1 to Nt. For example, phase rotation Φₙ(m) applied for each transmission period Tr of the chirp signal may be set using Φₙ(m)=2πDOPₙ×Tr.

For example, transmission antennas Tx #1 to Tx #Nt of transmission antenna section 105 include at least two types of transmission antennas with different polarizations, constituting a polarimetric radar. For example, transmission antennas Tx #1 to Tx #Nt may include transmission antennas that are orthogonal to each other as different polarizations. Also, there may be a plurality of transmission antennas for at least one of the polarizations, and at least one transmission antenna for the other polarizations.

Radar apparatus 10 may be a polarimetric MIMO radar using Nt transmission antennas Tx #1 to Tx #Nt that include transmission antennas of different polarizations. Radar apparatus 10 may perform uneven-interval Doppler multiplexing transmission using Nt transmission antennas Tx #1 to Tx #Nt.

Further, radar apparatus 10 may, for example, use Doppler multiplexing transmission that satisfies Conditions 1 and 2 to simultaneously perform multiplexing transmission of radar transmission signals from Nt transmission antennas Tx #1 to Tx #Nt.

In the following description, among the plurality of polarizations used in the polarimetric radar, the first polarization is referred to as “PL1 polarization,” and the second polarization is referred to as “PL2 polarization.” Also, for example, the qth polarization is referred to as “PLq polarization.” For example, as combinations of different polarizations that form orthogonal polarizations, right-handed circular polarization and left-handed circular polarization, horizontal polarization and vertical polarization, or right diagonal 45° polarization and left diagonal 45° polarization can be used as PL1 polarization and PL2 polarization.

Further, number Nt of transmission antennas is set to be 3 or more. For example, the number N_{DDM} of Doppler multiplexing is set to be 3 or more.

Further, in transmission antenna section 105, the number of transmission antennas corresponding to PL1 polarization (for example, called “PL1-polarized transmission antenna”) is denoted as N_{PL1}, and the number of transmission antennas corresponding to PL2 polarization (for example, called “PL2-polarized transmission antenna”) is denoted as N_{PL2}. In this case, N_{PL1}+N_{PL2}=Nt.

### <Condition 1>

Doppler multiplexed signals are assigned to PL1 polarization and PL2 polarization so as to achieve:
Uneven-interval Doppler multiplexing by PL1-polarized transmission antennas (considered when N_{PL1}≥2, and does not need to be considered when N_{PL1}=1), and
Uneven-interval Doppler multiplexing by PL2-polarized transmission antennas (considered when N_{PL2}≥2, and does not need to be considered when N_{PL2}=1).

### <Condition 2>

Among the Doppler multiplexed signals assigned to the PL1-polarized transmission antennas and PL2-polarized transmission antennas, one of the following conditions is satisfied:
(1) Different Doppler shift intervals are included;
(2) The number of Doppler multiplexing for each polarization (=number of transmission antennas) differs from each other (N_{PL1}≠N_{PL2}); and
(3) When N_{PL1}≥3 and N_{PL2}≥3 and when the same Doppler shift interval is included in the Doppler shift intervals of each polarization, the orders of the Doppler shift intervals differ for each polarization.

For example, under Condition 1, each interval of the Doppler shift amount assigned to the PL1-polarized transmission antennas is configured as an uneven interval on the Doppler frequency axis. Similarly, under Condition 1, each interval of the Doppler shift amount assigned to the PL2-polarized transmission antennas is configured as an uneven interval on the Doppler frequency axis.

Further, for example, under Condition 2(1), the intervals of the Doppler shift amounts (Doppler shift intervals, or Doppler multiplexing intervals) assigned to the PL1-polarized transmission antennas may include intervals different from intervals of the Doppler shift amounts assigned to the PL2-polarized transmission antennas. Examples of Condition 2(1) include a case where the maximum Doppler shift intervals differ from each other, a case where the minimum Doppler shift intervals differ from each other, or a case where the Doppler shift intervals that are neither the maximum nor the minimum differ from each other, among the Doppler multiplexed signals assigned to each of the PL1 polarization and PL2 polarization.

Further, examples of Condition 2(2) include a case where the number of either the PL1-polarized transmission antennas or the PL2-polarized transmission antennas is one, forming a Single-Input Multiple Output (SIMO) radar configuration (when N_{PL1}=1 and N_{PL2}≥2, or when N_{PL1}≥2 and N_{PL2}=1), and a case where both the PL1 and PL2-polarized transmission antennas are more than two, forming a MIMO radar configuration with the polarized transmission antennas (when N_{PL1}≥2 and N_{PL2}≥2).

For example, under Condition 2(3), the intervals of the Doppler shift amounts assigned to both the PL1 and PL2-polarized transmission antennas (for example, combinations of Doppler shift intervals) are the same, but the order of these intervals within the Doppler frequency range differs between the PL1 and PL2-polarized transmission antennas.

For instance, the combinations of intervals included in an arrangement (for example, a first arrangement) of the intervals of the Doppler shift amounts assigned to the PL1-polarized transmission antennas in ascending order on the Doppler frequency axis match the combinations of intervals included in an arrangement (for example, a second arrangement) of the intervals of the Doppler shift amounts assigned to the PL2-polarized transmission antennas in ascending order on the Doppler frequency axis, and the first and second arrangements differ from each other in their circular permutations.

When Condition 2(3) is met, the Doppler shift intervals of the PL1-polarized antenna and the PL2-polarized antenna do not match, even when either one is cyclically shifted in the Doppler frequency domain.

Thus, in the uneven interval Doppler multiplexing transmission by radar apparatus 10 being a polarimetric radar, the intervals of the Doppler shift amounts assigned to the plurality of transmission antennas in transmission antenna section 105 are uneven intervals within the Doppler frequency range of a Doppler analysis subject. Moreover, for example, among the plurality of transmission antennas included in transmission antenna section 105, the intervals of the Doppler shift amounts assigned to the transmission antennas corresponding to each of the plurality of polarizations are uneven intervals (Condition 1). Further, for example, within the Doppler frequency range of the Doppler analysis subject, the patterns of the Doppler shift amounts assigned (for example, the pattern regarding the intervals of the Doppler shift amounts, the number of transmission antennas (number of Doppler multiplexing), or the order of the intervals of the Doppler shift amounts on the Doppler frequency axis) differ between the PL1-polarized transmission antenna and the PL2-polarized transmission antenna (Condition 2).

As a result, even when the reception power levels of the reflected waves differ significantly between the reception signals from the transmission antennas of different polarizations, radar apparatus 10 can separate the Doppler multiplexed signals, thereby suppressing degradation of positioning performance and radar detection capability.

Since Doppler analyzer 209 analyzes the Doppler frequency of the output from beat frequency analyzer 208 for each distance index with at transmission period Tr, the range of Doppler frequency f_{d} derived according to the sampling theorem where aliasing does not occur is −1/(2Tr)≤f_{d}<1/(2Tr), and even for Doppler frequencies beyond this range, the range of Doppler frequency f_{d} observed is −1/(2Tr)≤f_{d}<1/(2Tr).

For example, when Doppler shifter 104 applies a Doppler shift amount within the range of −1/(2Tr)≤f_{d}<1/(2Tr), the maximum Doppler shift interval for Nt transmission antennas (=the number of Doppler multiplexing) becomes Δfdmax=1/(TrNt)=1/(TrN_{DM}). Doppler shifter 104 may set the Doppler shift interval to a smaller interval than Δfdmax, for example. Phase rotation p that provides such a Doppler shift amount can be configured within the range of −π≤φ<π, for example.

In the following description of the operation of Doppler shifter 104, when phase rotation φ₀ exceeding the range of −π≤φ<π is applied, phase rotation φ₀+2πα, which is in phase within the range from −π to π, may be applied. Here, a is an integer value such that

$$- π \leq {φ}_{0} + 2 π α < π .$$

Further, the Doppler multiplexing interval applied to the Doppler multiplexed signal configured by Doppler shifter 104 may be configured in units of Δfd as shown in following Expression 3, for example. Here, δ>0, and δ can be a positive integer or a positive real number. By setting δ as a positive integer, the processing in CFAR section 210 described later can be simplified. It should be noted that the following shows the case where δ is a positive integer, but is not limited thereto, and a positive real number may also be used.

$$\begin{matrix}( Expression 3 ) & \\ Δ f d = 1 / ( Tr \times ( {N}_{D M} + δ ) ) & [ 3 ]\end{matrix}$$

Further, in Expression 3, when δ is set as a positive integer such that δ>1, there are a plurality of Doppler shift amounts which are not assigned to the Doppler multiplexed signals (for example, the Doppler shift amounts indicated by the “×” mark in the figure used in the following configuration example of Doppler shift amounts). In this case, for example, by assigning the Doppler multiplexed signals such that these Doppler shift amounts are not at even intervals, radar apparatus 10 can set detectable Doppler frequency range fd within the range of −1/(2Tr)≤fd<1/(2Tr).

Below, configuration examples of the Doppler shift amount in Doppler shifter 104 are described.

### <Configuration Example 1 of Doppler Shift Amount>

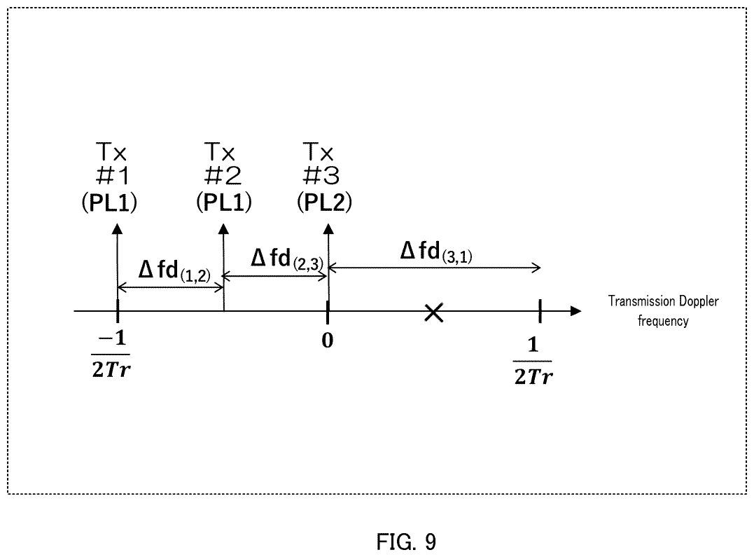

FIG. 9 shows a configuration example of the pattern of Doppler shift amounts for the transmission Doppler frequency in the case of Nt=3 transmission antennas, N_{PL1}=2, and N_{PL2}=1. In FIG. 9, Tx #1 and Tx #2 are PL1-polarized transmission antennas, and Tx #3 is a PL2-polarized transmission antenna.

In Configuration Example 1 of the Doppler shift amount, as shown in FIG. 9, the basic unit of the Doppler shift intervals in Doppler shifters 104 is set to Δfd=1/(Tr×(N_{DM}+δ))=1/(4Tr), and δ=1 is set, but the value of δ is not limited to this. δ can be a positive integer or a positive real number.

In the example shown in FIG. 9, first to third Doppler shifters 104 (or Doppler shifters 104-1, 104-2, and 104-3) may perform the following operations.

To apply Doppler shift amount DOP₁=−1/(2Tr) to first transmission antenna Tx #1, first Doppler shifter 104, for example, applies phase rotation Φ₁(m)=2πDOP₁×Tr=−π(m−1) for each transmission period Tr of the chirp signal and outputs the chirp signal.

To apply Doppler shift amount DOP₂=−1/(4Tr) to second transmission antenna Tx #2, second Doppler shifter 104, for example, applies phase rotation Φ₂(m)=2πDOP₂×Tr=−π(m−1)/2 for each transmission period Tr of the chirp signal and outputs the chirp signal.

To apply Doppler shift amount DOP₃=0 to third transmission antenna Tx #3, third Doppler shifter 104, for example, applies phase rotation Φ₃(m)=2πDOP₃×Tr=0 for each transmission period Tr of the chirp signal and outputs the chirp signal.

Hereinafter, the intervals of the Doppler shift amounts applied to Tx #n1 and Tx #n2 are denoted as the Doppler shift interval “Δfd_{(n1, n2)}.”

In FIG. 9, the pattern of the intervals (Doppler multiplexing intervals) of the Doppler shift amounts applied respectively to transmission antennas Tx #1, Tx #2, and Tx #3 is Δfd_{(1, 2)}=Δfd, Δfd_{(2, 3)}=Δfd, and Δfd_{(3, 1)}=2Δfd. Therefore, in FIG. 9, the intervals of the Doppler shift amounts applied respectively to transmission antennas, number Nt of which is 3 are not all the same, but includes an uneven interval (for example, Δfd_{(1, 2)}=Δfd_{(2, 3)}≠Δfd_{(3, 1)}), resulting in uneven interval Doppler multiplexing transmission (uneven interval DDM transmission).

Also, in FIG. 9, among the transmission antennas, the Doppler shift intervals between transmission antennas Tx #1 and Tx #2, which are to be PL1-polarized, are Δfd_{(1, 2)}=Δfd and Δfd_{(2, 1)}=3Δfd. Therefore, the intervals of the Doppler shift amounts applied respectively to PL1-polarized antennas, number N_{PL1} of which PL1-polarized antennas is 2, are not all the same but include an uneven interval (Δfd_{(1, 2)}≠Δfd_{(2, 1)}), resulting in uneven interval Doppler multiplexing transmission (uneven interval DDM transmission) by PL1-polarized antennas.

Further, in FIG. 9, since the number of transmission antennas Tx #3 that are of PL2 polarization is N_{PL2}=1, a SIMO radar configuration is provided by PL2-polarized antennas and does not become a case related to Doppler multiplexing transmission, thus it does not need to be considered.

Therefore, the example shown in FIG. 9 is a configuration example of a pattern of Doppler shift amounts that satisfies Condition 1.

Also, in FIG. 9, N_{PL1}(=2)≠N_{PL2}(=1). For example, in the example shown in FIG. 9, the pattern of the Doppler shift amounts assigned to the PL1-polarized transmission antennas differs from the pattern of the Doppler shift amount assigned to the PL2-polarized transmission antenna.

Therefore, the example shown in FIG. 9 is a configuration example of a pattern of Doppler shift amounts that satisfies Condition 2(2).

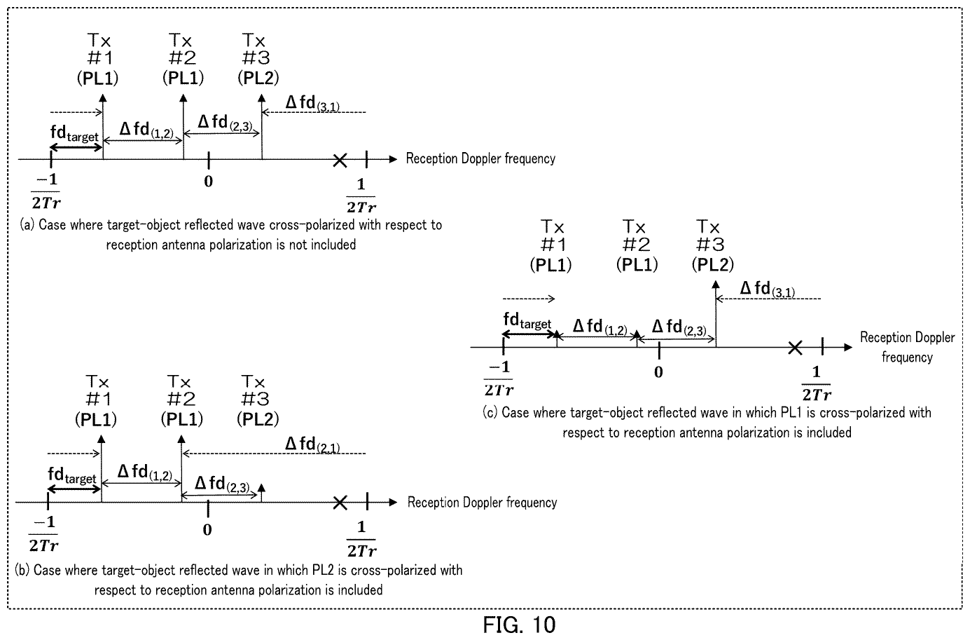

For example, FIG. 10 shows an example of reception signals in the outputs of Doppler analyzers 209, which result when, according to the Doppler shift amount configuration shown in FIG. 9, transmission antenna section 105 in which the PL1 polarization is left-handed circular polarization (LC) and the PL2 polarization is right-handed circular polarization (RC) is used and an LC polarization (PL1 polarization) antenna is used for reception antenna section 202.

FIG. 10 shows the outputs of Doppler analyzers 209 for target-object reflected waves at certain distance indices. For example, the target-object reflected waves include Doppler frequency fd_{target}. Therefore, as shown in FIG. 10, radar apparatus 10 receives a signal that has undergone a Doppler shift of fd_{target} from the Doppler shift amount shown in FIG. 9.

In this case, when the reflected wave of the radar transmission wave reflected by the target object includes many scattered waves or is a reflected wave with many reflections, the reflected wave may contain various polarizations. Therefore, the reception level of the reception signal in radar apparatus 10 is less likely to vary significantly between reception signals corresponding to differently polarized transmission antennas (for example, PL1-polarized transmission antenna and PL2-polarized transmission antenna). Thus, radar apparatus 10 receives the reception signal corresponding to the RC polarization (PL2 polarization) transmission antenna and the reception signal corresponding to the LC polarization (PL1 polarization) transmission antenna at approximately the same reception level.

For example, in the case of the Doppler shift amount configuration shown in FIG. 9, when no target-object reflected wave which is cross-polarized with respect to the polarization of the reception antenna (for example, LC polarization (PL1 polarization)) is included, a reception signal like that at part (a) in FIG. 10 is obtained. As shown at part (a) in FIG. 10, the reception levels of the reception signals corresponding to each of transmission antennas Tx #1 (PL1 polarization), Tx #2 (PL1 polarization), and Tx #3 (PL2 polarization) are approximately the same.

Further, for example, when radar apparatus 10 receives a reflected wave of a radar transmission wave specularly reflected (for example, from a surface with little unevenness) by the target object (for example, one specular reflection), the reception level may vary between polarized transmission antennas. For example, the reception signal corresponding to the LC polarization (PL1 polarization) transmission antenna becomes a signal of the same polarization as the reception antenna of LC polarization (PL1 polarization). On the other hand, for example, the reception signal corresponding to the RC polarization (PL2 polarization) transmission antenna becomes a signal cross-polarized with respect to the reception antenna of LC polarization (PL1 polarization). Therefore, the reception signal corresponding to the RC polarization (PL2 polarization) transmission antenna may have a lower reception level (for example, lower by 10 dB or more depending on the cross-polarization discrimination degree of the antenna) compared to the reception signal corresponding to the LC polarization (PL1 polarization) transmission antenna. For example, depending on the received SNR, the reception signal corresponding to the RC polarization (PL2 polarization) transmission antenna may fall below the noise level, making it difficult for radar apparatus 10 to detect the peak of the Doppler frequency.

For example, in the case of the Doppler shift amount configuration shown in FIG. 9, when target-object reflected waves in which RC polarization (PL2 polarization) is cross-polarized with respect to the polarization of the reception antenna (for example, LC polarization (PL1 polarization)) are included, a reception signal like that at part (b) in FIG. 10 is obtained. As shown at part (b) in FIG. 10, the reception level of the reception signal corresponding to transmission antenna Tx #3 (PL2 polarization) becomes smaller compared to the reception levels of the reception signals corresponding to transmission antennas Tx #1 and Tx #2 (PL1 polarization).

Further, for example, when radar apparatus 10 receives a reflected wave of a radar transmission wave specularly reflected by the target object and then further specularly reflected by a surface such as a road (for example, two specular reflections), the reception level may vary between polarized transmission antennas. For example, the reception signal corresponding to the RC polarization (PL2 polarization) transmission antenna becomes a signal of the same polarization as the reception antenna of LC polarization (PL1 polarization). On the other hand, for example, the reception signal corresponding to the LC polarization (PL1 polarization) transmission antenna becomes a signal cross-polarized with respect to the reception antenna of LC polarization (PL1 polarization). Therefore, the reception signal corresponding to the LC polarization (PL1 polarization) transmission antenna may have a lower reception level compared to the reception signal corresponding to the RC polarization (PL2 polarization) transmission antenna (for example, lower by 10 dB or more depending on the cross-polarization discrimination degree of the antenna reception level). For example, depending on the received SNR, the reception signal from the LC polarization (PL1 polarization) transmission antenna may fall below the noise level, making it difficult for radar apparatus 10 to detect the peak of the Doppler frequency.

For instance, in the case of the Doppler shift amount configuration shown in FIG. 9, when a target-object reflected wave in which LC polarization (PL1 polarization) is cross-polarized with respect to the polarization (for example, LC polarization (PL1 polarization) of the reception antenna) is included, a reception signal like that shown at part (c) in FIG. 10 is obtained. As shown at part (c) in FIG. 10, the reception levels of the reception signals corresponding to transmission antennas Tx #1 and Tx #2 (PL1 polarization) become lower compared to the reception level of the reception signal corresponding to transmission antenna Tx #3 (PL2 polarization).

For example, as shown at part (a) in FIG. 10, when no target-object reflected wave which is cross-polarized with respect to the polarization of the reception antenna is included, radar apparatus 10 receives the reception signal corresponding to each of the RC polarization (PL2 polarization) transmission antenna (Tx #3), and the LC polarization (PL1 polarization) transmission antennas (Tx #1 and Tx #2) at almost the same level. Here, at part (a) in FIG. 10, the signals transmitted from Nt transmission antennas Tx #1, Tx #2, and Tx #3 of RC polarization (PL2 polarization) transmission antenna and LC polarization (PL1 polarization) transmission antenna are transmitted using Doppler multiplexing using Doppler shift intervals that result in uneven interval Doppler multiplexing. Therefore, radar apparatus 10 becomes capable of separating Doppler multiplexed signals based on the existing separation operation of Doppler multiplexed signals.

Further, as shown in parts (b) and (c) in FIG. 10, when a target-object reflected wave that is cross-polarized with respect to the polarization of the reception antenna, radar apparatus 10 receives different Doppler multiplexed signals (for example, Doppler multiplexed signals that meet Condition 2(2)) in the case where PL2 polarization includes target-object reflected waves that are cross-polarized (part (b) in FIG. 10) and in the case where PL1 polarization includes target-object reflected waves that are cross-polarized (part (c) in FIG. 10). For example, radar apparatus 10 receives signals of two Doppler frequency components of Doppler shift intervals Δfd_{(1, 2)} or Δfd_{(2, 1)} at part (b) in FIG. 10, and a signal of one Doppler frequency component at part (c) in FIG. 10.

Thus, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the number of peaks), whether a decrease in the reception level of the reception signal corresponding to the PL1-polarized (LC-polarized) transmission antenna has occurred, or whether a decrease in the reception level of the reception signal corresponding to the PL2-polarized (RC-polarized) transmission antenna has occurred, in Doppler demultiplexer 211 described later.

For example, the Doppler multiplexed signal of LC polarization (PL1 polarization) is transmitted using Doppler multiplexing using Doppler shift intervals that result in uneven interval Doppler multiplexing. Therefore, for example, when the discrimination result by Doppler demultiplexer 211 indicates that the reception signal is discriminated as corresponding to the LC-polarized (PL1-polarized) transmission antenna, radar apparatus 10 can separate the Doppler multiplexed signal using the existing Doppler multiplexed signal separation operation.

Further, the RC polarization (PL2 polarization) transmission antenna is a single antenna transmission. Therefore, for example, when the discrimination result by Doppler demultiplexer 211 indicates that the reception signal is discriminated as corresponding to the RC-polarized (PL2-polarized) transmission antenna, radar apparatus 10 may not need to perform separation processing of the Doppler multiplexed signal for the RC polarization reception signal.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

### <Configuration Example 2 of Doppler Shift Amount>

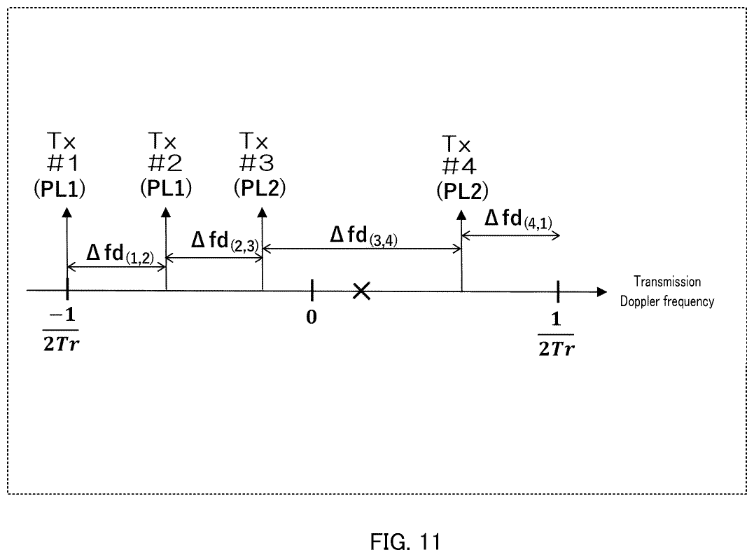

FIG. 11 shows a configuration example of a pattern of Doppler shift amounts for the transmission Doppler frequencies when number Nt of transmission antennas=4, N_{PL1}=2, and N_{PL2}=2. In FIG. 11, Tx #1 and Tx #2 are PL1-polarized transmission antennas, and Tx #3 and Tx #4 are PL2-polarized transmission antennas.

In Configuration Example 2 of the Doppler shift amount, as shown in FIG. 11, the basic unit of the Doppler shift intervals in Doppler shifters 104 is set to Δfd=1/(Tr×(N_{DM}+δ))=1/(5Tr) and δ=1 is set, but the value of δ is not limited to this. δ can be a positive integer or a positive real number.

In the example shown in FIG. 11, first to fourth Doppler shifters 104 (or, Doppler shifters 104-1 to 104-4) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−3/(10Tr) to second transmission antenna Tx #2, second Doppler shifter 104, for example, applies phase rotation Φ₂(m)=−3π(m−1)/5 for each transmission period Tr of the chirp signal and outputs the chirp signal.

To apply Doppler shift amount DOP₃=−1/(10Tr) to third transmission antenna Tx #3, third Doppler shifter 104, for example, applies phase rotation Φ₃(m)=−π(m−1)/5 for each transmission period Tr of the chirp signal and outputs the chirp signal.

To apply Doppler shift amount DOP₄=3/(10Tr) to the fourth transmission antenna Tx #4, fourth Doppler shifter 104, for example, applies phase rotation Φ₄(m)=3π(m−1)/5 for each transmission period Tr of the chirp signal and outputs the chirp signal.

Hereinafter, the intervals of the Doppler shift amounts applied to Tx #n1 and Tx #n2 are denoted as the Doppler shift intervals “Δfd_{(n1, n2)}.”

In FIG. 11, the intervals of the Doppler shift amounts (Doppler shift intervals) assigned to transmission antennas Tx #1 to Tx #4 are Δfd_{(1, 2)}=Δfd, Δfd_{(2, 3)}=Δfd, Δfd_{(3, 4)}=2Δfd, and Δfd_{(4, 1)}=Δfd. Therefore, in FIG. 11, the intervals of the Doppler shift amounts assigned to the Nt=4 transmission antennas are not all the same, but include uneven intervals (for example, Δfd_{(1, 2)}=Δfd_{(2, 3)}=Δfd_{(4, 1)}≠Δfd_{(3, 4)}), resulting in uneven interval Doppler multiplexing transmission (uneven interval DDM transmission).

Further, in FIG. 11, among the transmission antennas, the intervals of the Doppler shift amounts between transmission antennas Tx #1 and Tx #2 to be PL1-polarized are Δfd_{(1, 2)}=Δfd and Δfd_{(2, 1)}=4Δfd. Therefore, the intervals of the Doppler shift amount assigned respectively to PL1-polarized transmission antennas, number N_{PL1} of which PL1-polarized transmission antennas is 2, are not all the same, but includes uneven intervals (Δfd_{(1, 2)}≠Δfd_{(2, 1)}), resulting in uneven interval Doppler multiplexing transmission (uneven interval DDM transmission) by PL1-polarized transmission antennas.

In addition, in FIG. 11, among the transmission antennas, the intervals of the Doppler shift amount between transmission antennas Tx #3 and Tx #4 of PL2 polarization are Δfd_{(3, 4)}=2Δfd, and Δfd_{(4, 3)}=3Δfd. Therefore, the intervals of the Doppler shift amounts assigned respectively to PL2-polarized transmission antennas, number N_{PL2} of which PL2-polarized transmission antennas is 2, are not all the same, but includes uneven intervals (Δfd_{(3, 4)}≠Δfd_{(4, 3)}), resulting in uneven interval Doppler multiplexing transmission (uneven interval DDM transmission) by PL2-polarized antennas.

From the above, the example shown in FIG. 11 is a configuration example of a pattern of Doppler shift amounts that satisfies Condition 1.

Also, in FIG. 11, the interval of the Doppler shift amount between PL1-polarized transmission antennas Tx #1 and Tx #2 is Δfd_{(1, 2)}=Δfd or Δfd_{(2, 1)}=4Δfd, and the interval of the Doppler shift amount between PL2-polarized transmission antennas Tx #3 and Tx #4 is Δfd_{(3, 4)}=2Δfd or Δfd_{(4, 3)}=3Δfd. Therefore, the Doppler shift amounts between PL1-polarized transmission antennas Tx #1 and Tx #2 and between PL2-polarized transmission antennas Tx #3 and Tx #4 include different Doppler shift intervals.

For example, the maximum DDM interval of the Doppler shift amount between PL1-polarized transmission antennas Tx #1 and Tx #2 is Δfd_{(2, 1)}=4Δfd, and the maximum DDM interval of the Doppler shift amount between PL2-polarized transmission antennas Tx #3 and Tx #4 is Δfd_{(4, 3)}=3Δfd, and they are different from each other.

Similarly, for example, the minimum DDM interval of the Doppler shift amount between PL1-polarized transmission antennas Tx #1 and Tx #2 is Δfd_{(1, 2)}=Δfd, and the minimum DDM interval of the Doppler shift amount between PL2-polarized transmission antennas Tx #3 and Tx #4 is Δfd_{(3, 4)}=2Δfd, and they are different from each other.

Thus, in the example shown in FIG. 11, the pattern of Doppler shift amounts assigned to PL1-polarized transmission antennas is different from the pattern of Doppler shift amounts assigned to PL2-polarized transmission antennas.

Therefore, the example shown in FIG. 11 is a configuration example of the pattern of Doppler shift amounts that satisfies Condition 2(1).

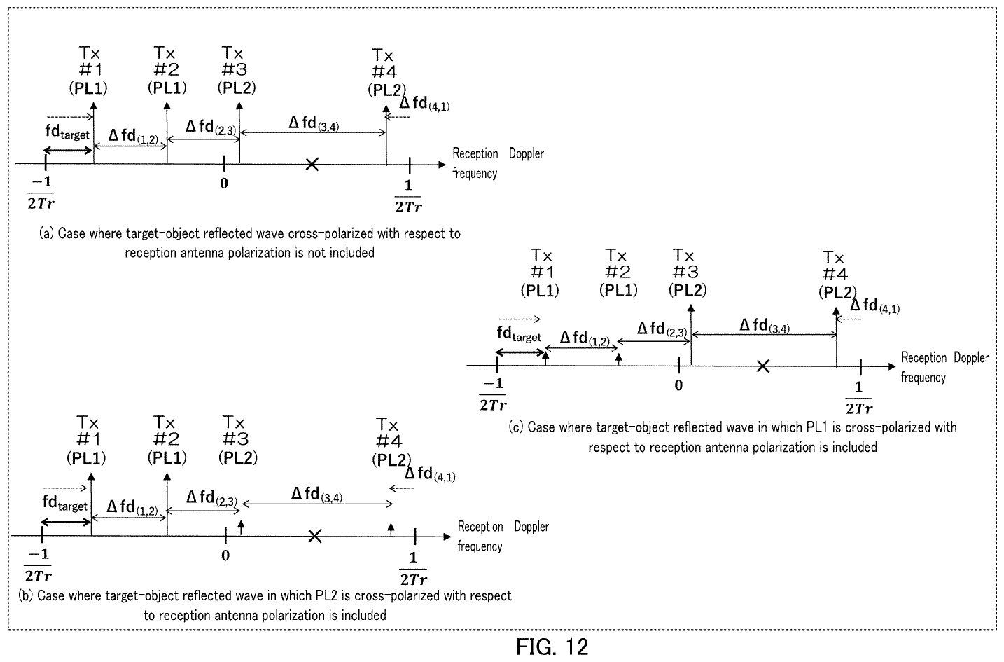

For example, FIG. 12 shows an example of reception signals in the outputs of Doppler analyzers 209, which result when, according to the Doppler shift amount configuration shown in FIG. 11, transmission antenna section 105 in which the PL1 polarization is left-handed circular polarization (LC) and the PL2 polarization is right-handed circular polarization (RC) is used and an LC polarization (PL1 polarization) antenna is used for reception antenna section 202.

FIG. 12 shows the outputs of Doppler analyzers 209 for target-object reflected waves at certain distance indices. For example, the target-object reflected waves include Doppler frequency fd_{target}. Therefore, as shown in FIG. 12, radar apparatus 10 receives a signal that has undergone a Doppler shift of fd_{target} from the Doppler shift amount shown in FIG. 11.

In this case, when the reflected wave of the radar transmission wave reflected by the target object includes many scattered waves or is a reflected wave with many reflections, the reflected wave may contain various polarizations. Therefore, the reception level of the reception signal in radar apparatus 10 is less likely to vary significantly between reception signals corresponding to differently polarized transmission antennas (for example, PL1-polarized transmission antenna and PL2-polarized transmission antenna). Thus, radar apparatus 10 receives the reception signal corresponding to the RC polarization (PL2 polarization) transmission antenna and the reception signal corresponding to the LC polarization (PL1 polarization) transmission antenna at approximately the same reception level.

For example, in the case of the Doppler shift amount configuration shown in FIG. 11, when no target-object reflected wave which is cross-polarized with respect to the polarization of the reception antenna (for example, LC polarization (PL1 polarization)) is included, a reception signal like that at part (a) in FIG. 12 is obtained. As shown at part (a) in FIG. 12, the reception levels of the reception signals corresponding to each of transmission antennas Tx #1, Tx #2 (PL1 polarization), Tx #3, and Tx #4 (PL2 polarization) are approximately the same.

Further, for example, when radar apparatus 10 receives a reflected wave of a radar transmission wave specularly reflected (for example, from a surface with little unevenness) by the target object (for example, one specular reflection), the reception level may vary between polarized transmission antennas. For example, the reception signal corresponding to the LC polarization (PL1 polarization) transmission antenna becomes a signal of the same polarization as the reception antenna. On the other hand, for example, the reception signal corresponding to the RC polarization (PL2 polarization) transmission antenna becomes a signal cross-polarized with respect to the reception antenna of LC polarization (PL1 polarization). Therefore, the reception signal corresponding to the RC polarization (PL2 polarization) transmission antenna may have a lower reception level (for example, lower by 10 dB or more depending on the cross-polarization discrimination degree of the antenna) compared to the reception signal corresponding to the LC polarization (PL1 polarization) transmission antenna. For example, depending on the received SNR, the reception signal corresponding to the RC polarization (PL2 polarization) transmission antenna may fall below the noise level, making it difficult for radar apparatus 10 to detect the peak of the Doppler frequency.

For example, in the case of the Doppler shift amount configuration shown in FIG. 11, when a target-object reflected wave in which RC polarization (PL2 polarization) is cross-polarized with respect to the polarization of the reception antenna (for example, LC polarization (PL1 polarization)) is included, a reception signal like that at part (b) in FIG. 12 is obtained. As shown at part (b) in FIG. 12, the reception levels of the reception signals corresponding to transmission antennas Tx #3 and Tx #4 (PL2 polarization) become smaller compared to the reception levels of the reception signals corresponding to transmission antennas Tx #1 and Tx #2 (PL1 polarization).

Further, for example, when radar apparatus 10 receives a reflected wave of a radar transmission wave specularly reflected by the target object and then further specularly reflected by a surface such as a road (for example, two specular reflections), the reception level may vary between polarized transmission antennas. For example, the reception signal corresponding to the RC polarization (PL2 polarization) transmission antenna becomes a signal of the same polarization as the reception antenna of LC polarization (PL1 polarization). On the other hand, for example, the reception signal corresponding to the LC polarization (PL1 polarization) transmission antenna becomes a signal cross-polarized with respect to the reception antenna of LC polarization (PL1 polarization). Therefore, the reception signal corresponding to the LC polarization (PL1 polarization) transmission antenna may have a lower reception level compared to the reception signal corresponding to the RC polarization (PL2 polarization) transmission antenna (for example, lower by 10 dB or more depending on the cross-polarization discrimination degree of the antenna reception level). For example, depending on the received SNR, the reception signal from the LC polarization (PL1 polarization) transmission antenna may fall below the noise level, making it difficult for radar apparatus 10 to detect the peak of the Doppler frequency.

For example, in the case of the Doppler shift amount configuration shown in FIG. 11, when target-object reflected waves in which LC polarization (PL1 polarization) is cross-polarized with respect to the polarization of the reception antenna (for example, LC polarization (PL1 polarization)) are included, a reception signal like that at part (c) in FIG. 12 is obtained. As shown at part (c) in FIG. 12, the reception levels of the reception signals corresponding to transmission antennas Tx #1 and Tx #2 (PL1 polarization) becomes smaller compared to the reception levels of the reception signals corresponding to transmission antennas Tx #3 and Tx #4 (PL2 polarization).

For example, as shown at part (a) in FIG. 12, when no target-object reflected wave which is cross-polarized with respect to the polarization of the reception antenna is included, radar apparatus 10 receives the reception signal corresponding to each of the RC polarization (PL2 polarization) transmission antennas (Tx #3 and Tx #4), and the LC polarization (PL1 polarization) transmission antennas (Tx #1 and Tx #2) at almost the same level. Here, at part (a) in FIG. 12, the signals transmitted from Nt transmission antennas Tx #1, Tx #2, Tx #3, and Tx #4 of RC polarization (PL2 polarization) transmission antennas and LC polarization (PL1 polarization) transmission antennas are transmitted in a Doppler multiplexing manner using Doppler shift intervals that result in uneven interval Doppler multiplexing. Therefore, radar apparatus 10 becomes capable of separating Doppler multiplexed signals based on the existing separation operation of Doppler multiplexed signals.

Further, as shown in parts (b) and (c) in FIG. 12, when a target-object reflected wave that is cross-polarized with respect to the polarization of the reception antenna, radar apparatus 10 receives different Doppler multiplexed signals (for example, Doppler multiplexed signals that meet Condition 2(1)) in the case where PL2 polarization includes target-object reflected waves that are cross-polarized (part (b) in FIG. 12) and in the case where PL1 polarization includes target-object reflected waves that are cross-polarized (part (c) in FIG. 12). For example, radar apparatus 10 receives signals of two Doppler frequency components of Doppler shift intervals Δfd_{(1, 2)} or Δfd_{(2, 1)} at part (b) in FIG. 12, and signals of two Doppler frequency components of Doppler shift intervals Δfd_{(3, 4)} or Δfd_{(4, 3)} at part (c) in FIG. 12.

Thus, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the interval of peaks), whether a decrease in the reception level of the reception signal corresponding to the PL1-polarized (LC-polarized) transmission antenna has occurred, or whether a decrease in the reception level of the reception signal corresponding to the PL2-polarized (RC-polarized) transmission antenna has occurred, in Doppler demultiplexer 211 described later.

For example, the Doppler multiplexed signal of LC polarization (PL1 polarization) is transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to transmission signals by the LC-polarized (PL1-polarized) transmission antenna, radar apparatus 10 can separate the Doppler multiplexed signal using the existing Doppler multiplexed signal separation operation.

Similarly, for example, the Doppler multiplexed signal of RC polarization (PL2 polarization) is transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to the transmission signal by the RC polarized (PL2-polarized) transmission antenna, radar apparatus 10 can separate the Doppler multiplexed signal using the existing separation operation for Doppler multiplexed signals.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

Configuration Examples 1 and 2 of the Doppler shift amount are described above. Below, different Doppler configuration examples are described. It should be noted that in Configuration Examples 1 and 2, PL1 polarization was described as LC polarization and PL2 polarization as RC polarization, but polarizations are not limited thereto. For example, when using polarizations where PL1 polarization and PL2 polarization are orthogonal to each other, a phenomenon occurs where the transmission signal from one of the polarized transmission antennas includes a target-object reflected wave that is cross-polarized with respect to the polarization of the reception antenna. The following configuration examples will be described using PL1 polarization and PL2 polarization.

### <Configuration Example 3 of Doppler Shift Amount>

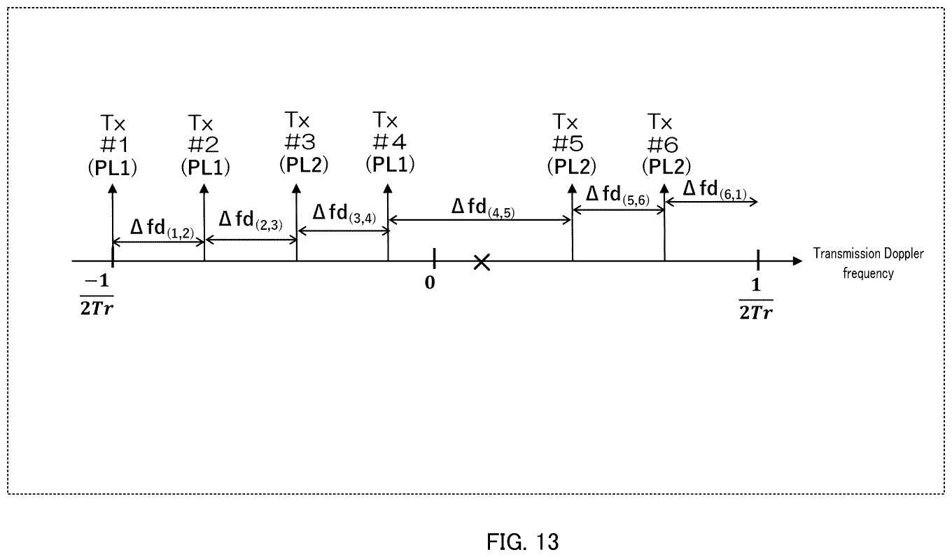

FIG. 13 shows a configuration example of the pattern of Doppler shift amounts for the transmission Doppler frequencies in the case of Nt=6 transmission antennas, N_{PL1}=3, and N_{PL2}=3. In FIG. 13, Tx #1, Tx #2, and Tx #4 are PL1-polarized transmission antennas, and Tx #3, Tx #5, and Tx #6 are PL2-polarized transmission antennas.

In Configuration Example 3 of the Doppler shift amount, as shown in FIG. 13, the basic unit of the Doppler shift intervals in Doppler shifters 104 is set to Δfd=1/(Tr×(N_{DM}+δ))=1/(7Tr), and δ=1 is set, but the value of δ is not limited to this. δ can be a positive integer or a positive real number.

In the example shown in FIG. 13, first to sixth Doppler shifters 104 (or, Doppler shifters 104-1 to 104-6) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−5/(14Tr) to second transmission antenna Tx #2, second Doppler shifter 104, for example, applies phase rotation Φ₂(m)=−5π(m−1)/7 for each transmission period Tr of the chirp signal and outputs the chirp signal.

To apply Doppler shift amount DOP₃=−3/(14Tr) to third transmission antenna Tx #3, third Doppler shifter 104, for example, applies phase rotation Φ₃(m)=−3π(m−1)/7 for each transmission period Tr of the chirp signal and outputs the chirp signal.

To apply Doppler shift amount DOP₄=−1/(14Tr) to fourth transmission antenna Tx #4, fourth Doppler shifter 104, for example, applies phase rotation Φ₄(m)=−π(m−1)/7 for each transmission period Tr of the chirp signal and outputs the chirp signal.

To apply Doppler shift amount DOP₅=3/(14Tr) to fifth transmission antenna Tx #5, fifth Doppler shifter 104, for example, applies phase rotation Φ₅(m)=3π(m−1)/7 for each transmission period Tr of the chirp signal and outputs the chirp signal.

To apply Doppler shift amount DOP₆=5/(14Tr) to sixth transmission antenna Tx #6, sixth Doppler shifter 104, for example, applies phase rotation Φ₆(m)=5π(m−1)/7 for each transmission period Tr of the chirp signal and outputs the chirp signal.

Hereinafter, the intervals of the Doppler shift amounts applied to Tx #n1 and Tx #n2 are denoted as the Doppler shift interval “Δfd_{(n1, n2)}.”

In FIG. 13, the intervals (Doppler shift intervals) of the Doppler shift amounts applied to transmission antennas Tx #1 to Tx #6 are Δfd_{(1, 2)}=Δfd_{(2, 3)}=Δfd_{(3, 4)}=Δfd_{(5, 6)}=Δfd_{(6, 1)}=Δfd, and Δfd_{(4, 5)}=2Δfd. Therefore, in FIG. 13, the intervals of the Doppler shift amounts applied to transmission antennas, number Nt of which is 6, are not all the same but include uneven intervals (for example, Δfd_{(1, 2)}=Δfd_{(2, 3)}=Δfd_{(3, 4)}=Δfd_{(5, 6)}=Δfd_{(6, 1)}≠Δfd_{(4, 5)}), resulting in uneven interval Doppler multiplexing transmission (uneven interval DDM transmission).

Further, in FIG. 13, the intervals of the Doppler shift amounts among the transmission antennas that become PL1 polarization, namely Tx #1, Tx #2, and Tx #4, are Δfd_{(1, 2)}=Δfd, Δfd_{(2, 4)}=2Δfd, and Δfd_{(4, 1)}=4Δfd. Therefore, the intervals of the Doppler shift amounts given respectively to PL1-polarized transmission antennas, a total number N_{PL1} of which PL1-polarized transmission antennas is 3, are not all the same, but include uneven intervals (Δfd_{(1, 2)}≠Δfd_{(2, 4)}≠Δfd_{(4, 1)}), resulting in uneven interval Doppler multiplexing transmission (uneven interval DDM transmission) by the PL1-polarized transmission antennas.

Further, in FIG. 13, among the transmission antennas, the intervals of the Doppler shift amounts between transmission antennas Tx #3, Tx #5, and Tx #6, which are PL2 polarization, are Δfd_{(3, 5)}=3Δfd, Δfd_{(5, 6)}=Δfd, and Δfd_{(6, 3)}=3Δfd. Therefore, the intervals of the Doppler shift amounts given respectively to PL2-polarized transmission antennas, a total number N_{PL2} of which PL2-polarized transmission antennas is 3, are not all the same, but include uneven intervals (Δfd_{(3, 5)}=Δfd_{(6, 3)}≠Δfd_{(5, 6)}), resulting in uneven interval Doppler multiplexing transmission (uneven interval DDM transmission) by the PL2-polarized antennas.

Thus, the example shown in FIG. 13 is a configuration example of a pattern of Doppler shift amounts that satisfies Condition 1.

In addition, in FIG. 13, the intervals of the Doppler shift amounts between PL1-polarized transmission antennas Tx #1, Tx #2, and Tx #4 are Δfd_{(1, 2)}=Δfd, Δfd_{(2, 4)}=2Δfd, and Δfd_{(4, 1)}=4Δfd, and the intervals of the Doppler shift amounts between PL2-polarized transmission antennas Tx #3, Tx #5, and Tx #6 are Δfd_{(3, 5)}=3Δfd, Δfd_{(5, 6)}=Δfd, and Δfd_{(6, 3)}=3Δfd. Therefore, the Doppler shift amounts between PL1-polarized transmission antennas Tx #1, Tx #2, and Tx #4 and the Doppler shift amounts between PL2-polarized transmission antennas Tx #3, Tx #5, and Tx #6 include different Doppler shift intervals.

For example, the intervals of the Doppler shift amounts between PL1-polarized transmission antennas Tx #1, Tx #2, and Tx #4 include 2Δfd and 4Δfd, but the intervals of the Doppler shift amounts between PL2-polarized transmission antennas Tx #3, Tx #5, and Tx #6 do not include 2Δfd and 4Δfd.

Further, for example, the maximum DDM interval of the Doppler shift amounts between PL2-polarized transmission antennas Tx #3, Tx #5, and Tx #6 is 3Δfd, but the intervals of the Doppler shift amounts between PL1-polarized transmission antennas Tx #1, Tx #2, and Tx #4 do not include 3Δfd.

Thus, in the example shown in FIG. 13, the pattern of Doppler shift amounts assigned to the PL1-polarized transmission antennas differs from the pattern of Doppler shift amounts assigned to the PL2-polarized transmission antennas.

Therefore, the example shown in FIG. 13 is a configuration example of a pattern of Doppler shift amounts that satisfies Condition 2(1).

For instance, when no target-object reflected waves that are cross-polarized with respect to the polarization of the reception antenna are included, radar apparatus 10 receives the corresponding reception signals from both the PL1-polarized transmission antennas (Tx #1, Tx #2, and Tx #4) and the PL2-polarized transmission antennas (Tx #3, Tx #5, and Tx #6) at almost the same level. Here, the signals transmitted from Nt transmission antennas Tx #1 to Tx #6, composed of PL1-polarized transmission antennas and PL2-polarized transmission antennas, are transmitted by Doppler multiplexing using Doppler shift intervals that result in uneven interval Doppler multiplexing. Therefore, radar apparatus 10 can separate Doppler multiplexed signals based on the existing separation operation of Doppler multiplexed signals.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Condition 2(1)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the interval of peaks), whether a decrease in the reception level of the reception signal corresponding to the PL1-polarized transmission antenna has occurred, or whether a decrease in the reception level of the reception signal corresponding to the PL2-polarized transmission antenna has occurred, in Doppler demultiplexer 211 described later.

For example, the PL1-polarized Doppler multiplexed signal is transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL1-polarized transmission antenna, radar apparatus 10 can separate the Doppler multiplexed signal using the existing Doppler multiplexed signal separation operation.

Similarly, for example, the PL2-polarized Doppler multiplexed signals are transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL2-polarized transmission antenna, radar apparatus 10 can separate the Doppler multiplexed signals using the existing separation operation of Doppler multiplexed signals.

Through the operation of such Doppler demultiplexer 211, radar apparatus 10 can determine target-object Doppler frequency fd within the range of −1/(2Tr)≤fd<1/(2Tr), and obtain outputs in which transmission antennas are associated respectively with the Doppler multiplexed signals.

<Configuration Example 4 of Doppler Shift Amount>

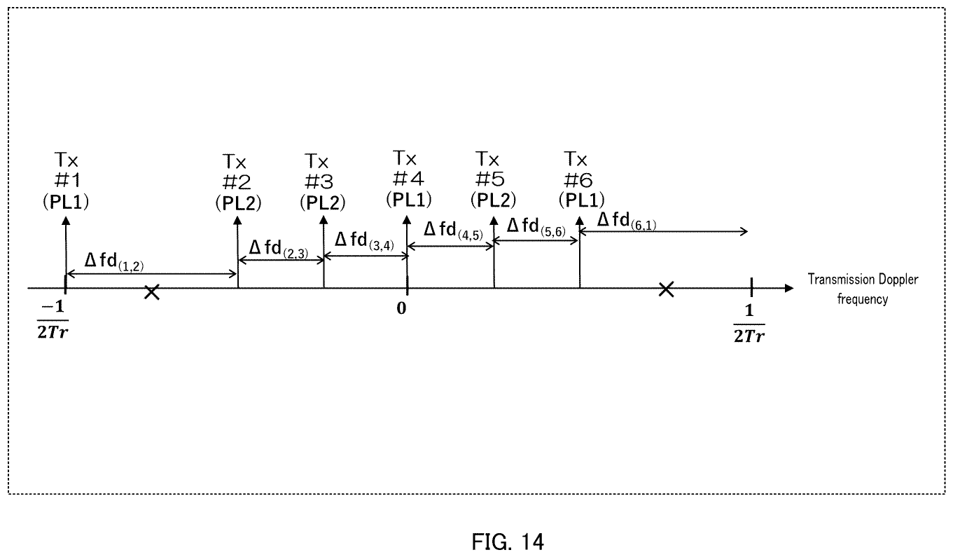

FIG. 14 shows a configuration example of a pattern of Doppler shift amounts for transmission Doppler frequencies in the case of Nt=6 transmission antennas, N_{PL1}=3, and N_{PL2}=3. In FIG. 14, Tx #1, Tx #4, and Tx #6 are PL1-polarized transmission antennas, and Tx #2, Tx #3, and Tx #5 are PL2-polarized transmission antennas.

In Configuration Example 4 of Doppler shift amounts, as shown in FIG. 14, the basic unit of Doppler shift intervals in Doppler shifter 104 is set to Δfd=1/(Tr×(N_{DM}+δ))=1/(8Tr) and δ=2 is set, but the value of δ is not limited to this. δ can be a positive integer or a positive real number.

In the example shown in FIG. 14, first to sixth Doppler shifters 104 (or, Doppler shifters 104-1 to 104-6) may perform the following operations.

To apply Doppler shift amount DOP₁=−1/(2Tr) to first transmission antenna Tx #1, first Doppler shifter 104, for example, applies phase rotation Φ₃(m)=−π(m−1) for each transmission period Tr of the chirp signal and outputs the chirp signal.

To apply Doppler shift amount DOP₂=−1/(4Tr) to second transmission antenna Tx #2, second Doppler shifter 104, for example, applies phase rotation Φ₂(m)=−π(m−1)/2 for each transmission period Tr of the chirp signal and outputs the chirp signal.

To apply Doppler shift amount DOP₃=−1/(8Tr) to third transmission antenna Tx #3, third Doppler shifter 104, for example, applies phase rotation Φ₃(m)=−π(m−1)/4 for each transmission period Tr of the chirp signal and outputs the chirp signal.

To apply Doppler shift amount DOP₄=0 to the fourth transmission antenna Tx #4, fourth Doppler shifter 104, for example, applies phase rotation Φ₄(m)=0 for each transmission period Tr of the chirp signal and outputs the chirp signal.

To apply Doppler shift amount DOP₅=1/(8Tr) to the fifth transmission antenna Tx #5, fifth Doppler shifter 104, for example, applies phase rotation Φ₅(m)=R(m−1)/4 for each transmission period Tr of the chirp signal and outputs the chirp signal.

To apply Doppler shift amount DOP₆=1/(4Tr) to the sixth transmission antenna Tx #6, sixth Doppler shifter 104, for example, applies phase rotation Φ₆(m)=π(m−1)/2 for each transmission period Tr of the chirp signal and outputs the chirp signal.

Hereinafter, the interval of the Doppler shift amounts applied respectively to Tx #n1 and Tx #n2 is denoted as the Doppler shift interval “Δfd_{(n1, n2)}.”

In FIG. 14, the intervals of the Doppler shift amounts (Doppler shift intervals) applied respectively to transmission antennas Tx #1 to Tx #6 are Δfd_{(1, 2)}=2Δfd, Δfd_{(2, 3)}=Δfd_{(3, 4)}=Δfd_{(4, 5)}=Δfd_{(5, 6)}=Δfd, and Δfd_{(6, 1)}=2Δfd. Therefore, in FIG. 14, the intervals of the Doppler shift amounts applied to the transmission antennas, number Nt of which is 6, are not all the same but include uneven intervals (for example, Δfd_{(2, 3)}=Δfd_{(3, 4)}=Δfd_{(4, 5)}=Δfd_{(5, 6)}≠Δfd_{(1, 2)}=Δfd_{(6, 1)}), resulting in uneven interval Doppler multiplexing transmission (uneven interval DDM transmission).

Further, in FIG. 14, among the transmission antennas, the intervals of the Doppler shift amounts between transmission antennas Tx #1, Tx #4, and Tx #6 to be PL1-polarized are Δfd_{(1, 4)}=4Δfd, Δfd_{(4, 6)}=2Δfd and Δfd_{(6, 1)}=2Δfd. Therefore, the intervals of the Doppler shift amounts applied respectively to PL1-polarized transmission antennas, number N_{PL1} of which is 3, are not all the same but include uneven intervals (Δfd_{(1, 4)}≠Δfd_{(4, 6)}=Δfd_{(6, 1)}), resulting in uneven interval Doppler multiplexing transmission (uneven interval DDM transmission) by PL1-polarized transmission antennas.

Further, in FIG. 14, among the transmission antennas, the intervals of the Doppler shift amount between transmission antennas Tx #2, Tx #3, and Tx #5, which are PL2-polarized, are Δfd_{(2, 3)}=Δfd, Δfd_{(3, 5)}=2Δfd, and Δfd_{(5, 2)}=5Δfd. Therefore, the intervals of the Doppler shift amounts assigned respectively to the PL2-polarized transmission antennas, number N_{PL2} of which is 3, are not all the same but include uneven intervals (Δfd_{(2, 3)}≠Δfd_{(3, 5)}≠Δfd_{(5, 2)}), resulting in uneven interval Doppler multiplexing transmission (uneven interval DDM transmission) by the PL2-polarized antennas.

Thus, the example shown in FIG. 14 is a configuration example of a pattern of Doppler shift amounts that satisfies Condition 1.

Also, in FIG. 14, the intervals of the Doppler shift amounts between PL1-polarized transmission antennas Tx #1, Tx #4, and Tx #6 are Δfd_{(1, 4)}=4Δfd, Δfd_{(4, 6)}=2Δfd and Δfd_{(6, 1)}=2Δfd, and the intervals of the Doppler shift amounts between PL2-polarized transmission antennas Tx #2, Tx #3, and Tx #5 are Δfd_{(2, 3)}=Δfd, Δfd_{(3, 5)}=2Δfd and Δfd_{(5, 2)}=5Δfd. Therefore, the Doppler shift amounts between PL1-polarized transmission antennas Tx #1, Tx #4, and Tx #6 and the Doppler shift amounts between PL2-polarized transmission antennas Tx #2, Tx #3, and Tx #5, include different Doppler shift intervals.

For example, the intervals of the Doppler shift amounts between PL1-polarized transmission antennas Tx #1, Tx #4, and Tx #6 include 4Δfd, but the intervals of the Doppler shift amounts between PL2-polarized transmission antennas Tx #2, Tx #3, and Tx #5 do not include 4Δfd.

Also, for example, the maximum DDM interval of the Doppler shift amount between PL2-polarized transmission antennas Tx #2, Tx #3, and Tx #5 includes Δfd and 5Δfd, but the Doppler shift amounts between PL1-polarized transmission antennas Tx #1, Tx #4, and Tx #6 do not include Δfd and 5Δfd.

Thus, in the example shown in FIG. 14, the pattern of Doppler shift amounts assigned to the PL1-polarized transmission antennas differs from the pattern of Doppler shift amounts assigned to the PL2-polarized transmission antennas.

Therefore, the example shown in FIG. 14 is a configuration example of a pattern of Doppler shift amounts that satisfies Condition 2(1).

For instance, when no target-object reflected waves that are cross-polarized with respect to the polarization of the reception antenna are included, radar apparatus 10 receives the corresponding reception signals from both the PL1-polarized transmission antennas (Tx #1, Tx #4, and Tx #6) and the PL2-polarized transmission antennas (Tx #2, Tx #3, and Tx #5) at almost the same level. Here, the signals transmitted from Nt transmission antennas Tx #1 to Tx #6, composed of PL1-polarized transmission antennas and PL2-polarized transmission antennas, are transmitted by Doppler multiplexing using Doppler shift intervals that result in uneven interval Doppler multiplexing. Therefore, radar apparatus 10 can separate Doppler multiplexed signals based on the existing separation operation of Doppler multiplexed signals.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Condition 2(1)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the interval of peaks), whether a decrease in the reception level of the reception signal corresponding to the PL1-polarized transmission antenna has occurred, or whether a decrease in the reception level of the reception signal corresponding to a transmission signal by the PL2-polarized transmission antenna has occurred, in Doppler demultiplexer 211 described later.

For example, the Doppler multiplexed signal of LC polarization (PL1 polarization) is transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to the PL1-polarized transmission antenna, radar apparatus 10 can separate the Doppler multiplexed signal using the existing Doppler multiplexed signal separation operation.

Similarly, for example, the PL2-polarized Doppler multiplexed signals are transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL2-polarized transmission antenna, radar apparatus 10 can separate the Doppler multiplexed signals using the existing separation operation of Doppler multiplexed signals.

Through such operation of Doppler demultiplexer 211, radar apparatus 10 can determine Doppler frequency f_{d} of the target object within the range of −1/(2Tr)≤fd<1/(2Tr), and obtain an output in which each Doppler multiplexed signal is associated with its corresponding transmission antenna.

### <Configuration Example 5 of Doppler Shift Amount>

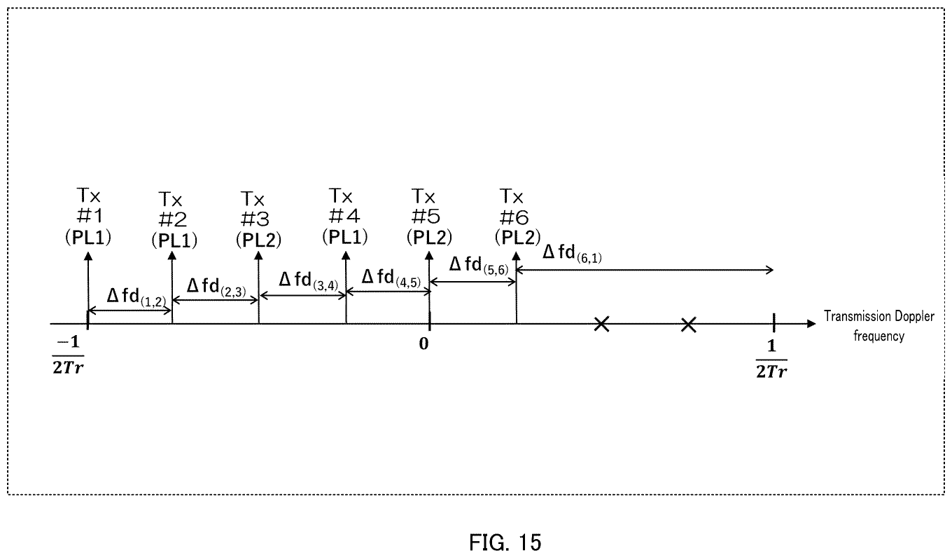

FIG. 15 shows a configuration example of a pattern of Doppler shift amounts for transmission Doppler frequencies when number Nt of transmission antennas=6, N_{PL1}=3, and N_{PL2}=3. In FIG. 15, Tx #1, Tx #2, and Tx #4 are PL1-polarized transmission antennas, and Tx #3, Tx #5, and Tx #6 are PL2-polarized transmission antennas.

In Configuration Example 5 of Doppler shift amount, as shown in FIG. 15, the basic unit of Doppler shift intervals in Doppler shifter 104 is set to Δfd=1/(Tr×(N_{DM}+δ))=1/(8Tr) and δ=2 is set, but the value of δ is not limited to this. δ can be a positive integer or a positive real number.

In the example shown in FIG. 15, first to sixth Doppler shifters 104 (or, Doppler shifters 104-1 to 104-6) may perform the following operations.

To apply Doppler shift amount DOP₁=−1/(2Tr) to first transmission antenna Tx #1, first Doppler shifter 104, for example, applies a phase rotation of Φ₁(m)=−π(m−1) every transmission period Tr for the chirp signal and outputs the chirp signal.

To apply Doppler shift amount DOP₂=−3/(8Tr) to second transmission antenna Tx #2, second Doppler shifter 104, for example, applies a phase rotation of Φ₂(m)=−3π(m−1)/4 every transmission period Tr for the chirp signal and outputs the chirp signal.

To apply Doppler shift amount DOP₃=−1/(4Tr) to third transmission antenna Tx #3, third Doppler shifter 104, for example, applies a phase rotation of Φ₃(m)=−π(m−1)/2 every transmission period Tr for the chirp signal and outputs the chirp signal.

To apply Doppler shift amount DOP₄=−1/(8Tr) to the fourth transmission antenna Tx #4, fourth Doppler shifter 104, for example, applies a phase rotation of Φ₄(m)=−π(m−1)/4 every transmission period Tr for the chirp signal and outputs the chirp signal.

To apply Doppler shift amount DOP₅=0 to the fifth transmission antenna Tx #5, fifth Doppler shifter 104, for example, applies a phase rotation of Φ₅(m)=0 every transmission period Tr for the chirp signal and outputs the chirp signal.

To apply Doppler shift amount DOP₆=1/(8Tr) to the sixth transmission antenna Tx #6, sixth Doppler shifter 104, for example, applies a phase rotation of Φ₆(m)=π(m−1)/4 every transmission period Tr for the chirp signal and outputs the chirp signal.

Hereinafter, the interval of the Doppler shift amounts applied respectively to Tx #n1 and Tx #n2 is denoted as the Doppler shift interval “Δfd_{(n1, n2)}.”

In FIG. 15, the intervals of the Doppler shift amounts (Doppler shift intervals) applied respectively to transmission antennas Tx #1 to Tx #6 are Δfd_{(1, 2)}=Δfd_{(2, 3)}=Δfd_{(3, 4)}=Δfd_{(4, 5)}=Δfd_{(5, 6)}=Δfd, and Δfd_{(6, 1)}=3Δfd. Therefore, in FIG. 15, the intervals of the Doppler shift amounts applied respectively to transmission antennas, number Nt of which is 6, are not all the same but include uneven intervals (for example, Δfd_{(1, 2)}=Δfd_{(2, 3)}=Δfd_{(3, 4)}=Δfd_{(4, 5)}=Δfd_{(5, 6)}≠Δfd_{(6, 1)}), resulting in uneven interval Doppler multiplexing transmission (uneven interval DDM transmission).

Further, in FIG. 15, among the transmission antennas, the intervals of the Doppler shift amounts between transmission antennas Tx #1, Tx #2, and Tx #4 to be PL1-polarized are Δfd_{(1, 2)}=Δfd, Δfd_{(2, 4)}=2Δfd, and Δfd_{(4, 1)}=5Δfd. Therefore, the intervals of the Doppler shift amounts applied respectively to PL1-polarized transmission antennas, number N_{PL1} of which is 3, are not all the same but include uneven intervals (Δfd_{(1, 2)}≠Δfd_{(2, 4)}=Δfd_{(4, 1)}), resulting in uneven interval Doppler multiplexing transmission by PL1-polarized transmission antennas (uneven interval DDM transmission).

In FIG. 15, among the transmission antennas, the intervals of the Doppler shift amounts between transmission antennas Tx #3, Tx #5, and Tx #6, which are PL2-polarized, are Δfd_{(3, 5)}=2Δfd, Δfd_{(5, 6)}=Δfd, and Δfd_{(6, 3)}=5Δfd. Therefore, the intervals of the Doppler shift amounts assigned respectively to PL2-polarized transmission antennas, number N_{PL2} of which PL2-polarized transmission antennas is 3, are not all the same but include uneven intervals (Δfd_{(3, 5)}≠Δfd_{(5, 6)}≠Δfd_{(6, 3)}), resulting in uneven interval Doppler multiplexing transmission (uneven interval DDM transmission) by the PL2-polarized antennas.

Thus, the example shown in FIG. 15 is a configuration example of a pattern of Doppler shift amounts that satisfies Condition 1.

Also, in FIG. 15, the Doppler shift amounts between PL1-polarized transmission antennas Tx #1, Tx #2, and Tx #4 are Δfd_{(1, 2)}=Δfd, Δfd_{(2, 4)}=2Δfd, and Δfd_{(4, 1)}=5Δfd, and the Doppler shift amounts between PL2-polarized transmission antennas Tx #3, Tx #5, and Tx #6 are Δfd_{(3, 5)}=2Δfd, Δfd_{(5, 6)}=Δfd, and Δfd_{(6, 3)}=5Δfd. Thus, the Doppler shift amounts between PL1-polarized transmission antennas Tx #1, Tx #2, and Tx #4, and the Doppler shift amounts between PL2-polarized transmission antennas Tx #3, Tx #5, and Tx #6 include the same combination of Doppler shift intervals, but the orders of the Doppler shift intervals between PL1 and PL2 polarizations in the Doppler frequency domain are different from each other.

For example, in FIG. 15, the order of the intervals of the Doppler shift amounts assigned respectively to PL1-polarized transmission antennas Tx #1, Tx #2, and Tx #4 is Δfd, 2Δfd, and 5Δfd. Also, in FIG. 15, the order of the intervals of the Doppler shift amounts assigned respectively to PL2-polarized transmission antennas Tx #3, Tx #5, and Tx #6 is 2Δfd, Δfd, and 5Δfd. Therefore, in FIG. 15, although the same combination of Doppler shift intervals (for example, Δfd, 2Δfd, and 5Δfd) is included for both PL1- and PL2-polarized transmission antennas, the order of those intervals differs between the polarizations. For instance, in FIG. 15, even when the Doppler shift intervals between PL1-polarized transmission antennas or between PL2-polarized transmission antennas are cyclically shifted in the Doppler frequency domain, the Doppler shift amounts do not match between the polarizations.

Thus, in the example shown in FIG. 15, the pattern of Doppler shift amounts assigned to the PL1-polarized transmission antennas differs from the pattern of Doppler shift amounts assigned to the PL2-polarized transmission antennas.

Therefore, the example shown in FIG. 15 is a configuration example of a pattern of Doppler shift amounts that satisfies Condition 2(3).

For instance, when no target-object reflected waves that are cross-polarized with respect to the polarization of the reception antenna are included, radar apparatus 10 receives the corresponding reception signals from both the PL1-polarized transmission antennas (Tx #1, Tx #2, and Tx #4) and the PL2-polarized transmission antennas (Tx #3, Tx #5, and Tx #6) at almost the same level. Here, the signals transmitted from Nt transmission antennas Tx #1 to Tx #6, composed of PL1-polarized transmission antennas and PL2-polarized transmission antennas, are transmitted by Doppler multiplexing using Doppler shift intervals that result in uneven interval Doppler multiplexing. Therefore, radar apparatus 10 can separate Doppler multiplexed signals based on the existing separation operation of Doppler multiplexed signals.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Condition 2(3)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the order of Doppler shift intervals), whether a decrease in the reception level of the reception signal corresponding to the PL1-polarized (LC-polarized) transmission antenna has occurred, or whether a decrease in the reception level of the reception signal corresponding to the PL2-polarized (RC-polarized) transmission antenna has occurred, in Doppler demultiplexer 211 described later.

For example, the Doppler multiplexed signals of PL1 polarization are transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL1-polarized transmission antenna, radar apparatus 10 can separate the Doppler multiplexed signals using the existing separation operation of Doppler multiplexed signals.

Similarly, for example, the PL2-polarized Doppler multiplexed signals are transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL2-polarized transmission antenna, radar apparatus 10 can separate the Doppler multiplexed signals using the existing separation operation of Doppler multiplexed signals.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

<Configuration Example 6 of Doppler Shift Amount>

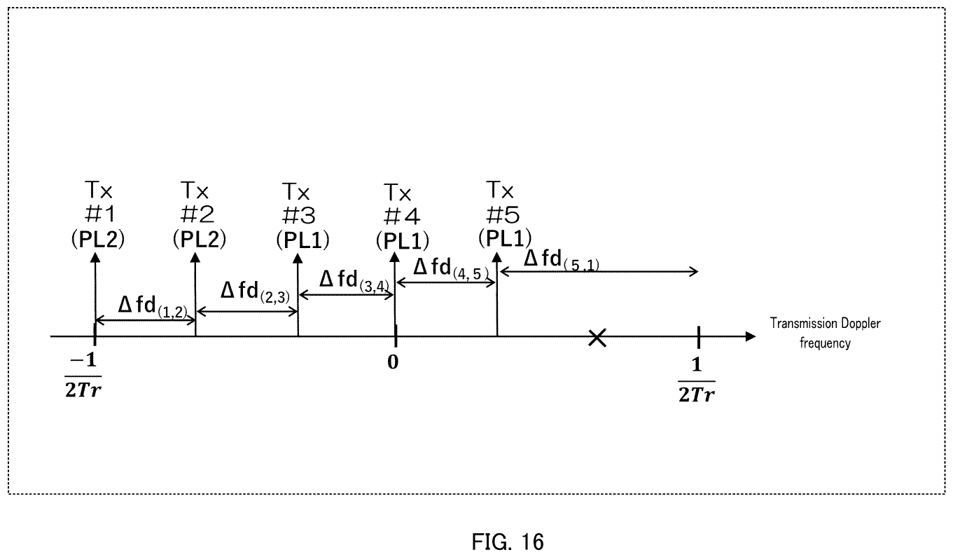

FIG. 16 shows a configuration example of a pattern of Doppler shift amounts for transmission Doppler frequencies in the case of Nt=5 transmission antennas, N_{PL1}=3, and N_{PL2}=2. In FIG. 16, Tx #3, Tx #4, and Tx #5 are PL1-polarized transmission antennas, and Tx #1 and Tx #2 are PL2-polarized transmission antennas.

In Configuration Example 6 of Doppler shift amounts, as shown in FIG. 16, the basic unit of Doppler shift intervals in Doppler shifter 104 is set to Δfd=1/(Tr×(N_{DM}+δ))=1/(6Tr), and δ is set to 1, but the value of δ is not limited to this. δ can be a positive integer or a positive real number.

In the example shown in FIG. 16, first to fifth Doppler shifters 104 (or Doppler shifters 104-1 to 104-5) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−1/(3Tr) to second transmission antenna Tx #2, second Doppler shifter 104, for example, applies phase rotation Φ₂(m)=−2π(m−1)/3 for each transmission period Tr of the chirp signal and outputs the chirp signal.

To apply Doppler shift amount DOP₃=−1/(6Tr) to third transmission antenna Tx #3, third Doppler shifter 104, for example, applies phase rotation Φ₃(m)=−π(m−1)/3 for each transmission period Tr of the chirp signal and outputs the chirp signal.

To apply Doppler shift amount DOP₄=0 to the fourth transmission antenna Tx #4, fourth Doppler shifter 104, for example, applies phase rotation Φ₄(m)=0 for each transmission period Tr of the chirp signal and outputs the chirp signal.

To apply Doppler shift amount DOP₅=1/(6Tr) to the fifth transmission antenna Tx #5, fifth Doppler shifter 104, for example, applies phase rotation Φ₅(m)=R(m−1)/3 for each transmission period Tr of the chirp signal and outputs the chirp signal.

Hereinafter, the interval of the Doppler shift amounts applied respectively to Tx #n1 and Tx #n2 is denoted as the Doppler shift interval “Δfd_{(n1, n2)}.”

In FIG. 16, the intervals (Doppler shift intervals) of the Doppler shift amounts applied respectively to transmission antennas Tx #1 to Tx #5 are Δfd_{(1, 2)}=Δfd_{(2, 3)}=Δfd_{(3, 4)}=Δfd_{(4, 5)}=Δfd and Δfd_{(5, 1)}=2Δfd. Therefore, in FIG. 16, the intervals of the Doppler shift amounts applied respectively to transmission antennas, number Nt of which transmission antennas is 5, are not all the same but include uneven intervals (for example, Δfd_{(1, 2)}=Δfd_{(2, 3)}=Δfd_{(3, 4)}=Δfd_{(4, 5)}≠Δfd_{(5, 1)}), resulting in uneven interval Doppler multiplexing transmission (uneven interval DDM transmission).

Further, in FIG. 16, among the transmission antennas, the intervals of the Doppler shift amounts between transmission antennas Tx #3, Tx #4, and Tx #5 to be PL1-polarized are Δfd_{(3, 4)}=Δfd, Δfd_{(4, 5)}=Δfd and Δfd_{(5, 3)}=4Δfd. Therefore, the intervals of the Doppler shift amounts applied respectively to PL1-polarized transmission antennas, number N_{PL1} of which PL1-polarized transmission antennas is 3, are not all the same but include uneven intervals (Δfd_{(3, 4)}=Δfd_{(4, 5)}≠Δfd_{(5, 3)}), resulting in uneven interval Doppler multiplexing transmission by PL1-polarized transmission antennas (uneven interval DDM transmission).

Additionally, in FIG. 16, among the transmission antennas, the intervals of the Doppler shift amounts between transmission antennas Tx #1 and Tx #2 of PL2 polarization are Δfd(1,2)=Δfd and Δfd_{(2, 1)}=5Δfd. Therefore, the intervals of the Doppler shift amounts assigned to PL2-polarized transmission antennas, number N_{PL2} of which PL2-polarized transmission antennas is 2, are not all the same, but include uneven intervals (Δfd_{(1, 2)}≠Δfd_{(2, 1)}), resulting in uneven interval Doppler multiplexing transmission (uneven interval DDM transmission) by the PL2-polarized antennas.

Thus, the example shown in FIG. 16 is a configuration example of a pattern of Doppler shift amounts that satisfies Condition 1.

In FIG. 16, the intervals of the Doppler shift amounts between PL1-polarized transmission antennas Tx #3, Tx #4, and Tx #5 are Δfd_{(3, 4)}=Δfd, Δfd_{(4, 5)}=Δfd and Δfd_{(5, 3)}=4Δfd, and the intervals of the Doppler shift amounts between PL2-polarized transmission antennas Tx #1 and Tx #2 are Δfd_{(1, 2)}=Δfd and Δfd_{(2, 1)}=5Δfd. Therefore, the Doppler shift amounts between PL1-polarized transmission antennas Tx #3, Tx #4, and Tx #5 and the Doppler shift amounts between PL2-polarized transmission antennas Tx #1 and Tx #2, include different Doppler shift intervals.

For example, the intervals of the Doppler shift amounts between PL1-polarized transmission antennas Tx #3, Tx #4, and Tx #5 include 4Δfd, but the interval between PL2-polarized transmission antennas Tx #1 and Tx #2 does not include 4Δfd.

Further, for example, the interval of the Doppler shift amounts between PL2-polarized transmission antennas Tx #1 and Tx #2 includes 5Δfd, but the intervals between PL1-polarized transmission antennas Tx #3, Tx #4, and Tx #5 do not include 5Δfd.

Also, in FIG. 16, the number of Doppler multiplexing (or, the number of transmission antennas) differs between PL1 polarization and PL2 polarization (N_{PL1}≠N_{PL2}).

Thus, in the example shown in FIG. 16, the pattern of Doppler shift amounts assigned to PL1-polarized transmission antennas differs from the pattern of Doppler shift amounts assigned to PL2-polarized transmission antennas.

Therefore, the example shown in FIG. 16 is a configuration example of a pattern of Doppler shift amounts that satisfies Conditions 2(1) and 2(2).

For instance, when no target-object reflected waves that are cross-polarized with respect to the polarization of the reception antenna are included, radar apparatus 10 receives the corresponding reception signals from both the PL1-polarized transmission antennas (Tx #3, Tx #4, and Tx #5) and the PL2-polarized transmission antennas (Tx #1 and Tx #2) at almost the same level. Here, the signals transmitted from Nt transmission antennas Tx #1 to Tx #5, composed of PL1-polarized transmission antennas and PL2-polarized transmission antennas, are transmitted by Doppler multiplexing using Doppler shift intervals that result in uneven interval Doppler multiplexing. Therefore, radar apparatus 10 can separate Doppler multiplexed signals based on the existing separation operation of Doppler multiplexed signals.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Conditions 2(1) and 2(2)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, Doppler shift intervals or the number of peaks), whether a decrease in the reception level of the reception signal corresponding to the PL1-polarized transmission antenna has occurred, or whether a decrease in the reception level of the reception signal corresponding to the PL2-polarized transmission antenna has occurred, in Doppler demultiplexer 211 described later.

For example, the Doppler multiplexed signals of PL1 polarization are transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL1-polarized transmission antenna, radar apparatus 10 can separate the Doppler multiplexed signals using the existing separation operation of Doppler multiplexed signals.

Similarly, for example, the PL2-polarized Doppler multiplexed signals are transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to a transmission signal by the PL2-polarized transmission antenna, radar apparatus 10 can separate the Doppler multiplexed signals using the existing separation operation of Doppler multiplexed signals.

Through such operation of Doppler demultiplexer 211, radar apparatus 10 can determine Doppler frequency f_{d} of the target object within the range of −1/(2Tr)≤fd<1/(2Tr), and obtain an output in which each Doppler multiplexed signal is associated with its corresponding transmission antenna.

The configuration example for Doppler shift amounts has been described above.

It should be noted that the configuration for Doppler shift amounts is not limited to Examples 1 to 6 described above. For example, at least one of number Nt of transmission antennas (or, the number of Doppler multiplexing), number N_{PL1} of PL1-polarized transmission antennas, number N_{PL2} of PL2-polarized transmission antennas, and the Doppler shift intervals may be other values.

Further, in Doppler shifters 104, phase rotations Φₙ(m) that apply Doppler shift amounts DOPₙ to radar transmission signals transmitted from Nt transmission antennas may be represented as follows in Expression 4:

$$\begin{matrix}( Expression 4 ) & \\ {ϕ}_{n} ( m ) = ( 2 π {T}_{r} \times {DOP}_{n} + Δ {ϕ}_{0} ) \times ( m - 1 ) + {ϕ}_{0} . & [ 4 ]\end{matrix}$$

Here, Φ₀ is the initial phase, and ΔΦ₀ is the reference Doppler shift phase.

For example, when Doppler multiplexing transmission is performed using number Nt=3 of transmission antennas, first Doppler shifter 104 applies phase rotation Φ₁(m) to the radar transmission signal (for example, a chirp signal) input from radar transmission signal generator 101 for each transmission period Tr, as shown in following Expression 5. The output of first Doppler shifter 104 is, for example, output from the first transmission antenna (Tx #1). Here, cp(t) denotes the chirp signal for each transmission period.

$$\begin{matrix}( Expression 5 ) & \\ exp \{ j {ϕ}_{1} ( 1 ) \} c p ( t ) , exp \{ j {ϕ}_{1} ( 2 ) \} c p ( t ) , … , exp \{ j {ϕ}_{1} ( {N}_{c} ) \} cp ( t ) & [ 5 ]\end{matrix}$$

For example, second Doppler shifter 104 applies phase rotation Φ₂(m) to the radar transmission signal (for example, a chirp signal) input from radar transmission signal generator 101 for each transmission period Tr as shown in following Expression 6. The output of second Doppler shifter 104 is, for example, output from the second transmission antenna (Tx #2).

$$\begin{matrix}( Expression 6 ) & \\ exp \{ j {ϕ}_{2} ( 1 ) \} c p ( t ) , exp \{ j {ϕ}_{2} ( 2 ) \} c p ( t ) , … , exp \{ j {ϕ}_{2} ( {N}_{c} ) \} c p ( t ) & [ 6 ]\end{matrix}$$

Similarly, for example, third Doppler shifter 104 applies phase rotation Φ₃(m) to the radar transmission signal (for example, a chirp signal) input from radar transmission signal generator 101 for each transmission period Tr as shown in following Expression 7. The output of third Doppler shifter 104 is, for example, output from the third transmission antenna (Tx #3).

$$\begin{matrix}( Expression 7 ) & \\ exp \{ j {ϕ}_{3} ( 1 ) \} c p ( t ) , exp \{ j {ϕ}_{3} ( 2 ) \} c p ( t ) , … , exp \{ j {ϕ}_{3} ( {N}_{c} ) \} c p ( t ) & [ 7 ]\end{matrix}$$

The configuration example for Doppler shift amounts has been described above.

Next, the exemplary operations of CFAR section 210 and Doppler demultiplexer 211 corresponding to the operation of aforementioned Doppler shifters 104 will be described.

[Exemplary Operation of CFAR section 210]

For example, CFAR section 210 may perform following exemplary operation 1 or exemplary operation 2 to receive the reflected wave signals for the radar transmission signals from radar transmitter 100.

In the following description, an exemplary operation of CFAR section 210 in the case where a plurality of reception antennas of reception antenna section 202 include reception antennas of the same polarization will be described. An exemplary operation of CFAR section 210 in the case where the plurality of reception antennas of reception antenna section 202 include differently polarized reception antennas will be described later.

### <Exemplary Operation 1 of CFAR Section 210>

In exemplary operation 1, an exemplary operation of CFAR section 210 is described when the value of δ shown in Expression 3 is set to a positive integer in Doppler shifter 104.

In this case, the interval of Δfd or an integer multiple of the interval of Δfd is used for the intervals of the Doppler shift amounts assigned to the Doppler multiplexed signals. Therefore, each of the Doppler-multiplexed signals can be detected as if it aliases at the intervals of Δfd in the outputs of Doppler analyzers 209 in the Doppler frequency domain. By using such characteristics, for example, the operation of CFAR section 210 can be simplified as follows.

For example, CFAR section 210 detects a Doppler peak by using a threshold to a power addition value obtained by adding together the reception powers of the reflected wave signals for respective ranges (for example, ranges of Δfd(q)) within the Doppler frequency range of the outputs of Doppler analyzers 209 subjected to the CFAR processing, the ranges serving as units of the intervals of the Doppler shift amounts applied respectively to the radar transmission signals.

For example, CFAR section 210 performs the CFAR processing on the outputs from Doppler analyzers 209 of first to Nath signal processors 206 by calculating power addition value PowerDDM(f_{b}, f_{sddm}) obtained by adding power values PowerqFT(f_{b}, fₛ), which is given by Expression 9, at the intervals of Δfd (for example, corresponding to N_{Δfd}) as shown in following Expression 8:

$$\begin{matrix}( Expression 8 ) & \\ PowerDDM ( {f}_{b} , {f}_{s d d m} ) = {\sum }_{n d m = 1}^{{N}_{D M} + δ} PowerFT ( {f}_{b} , {f}_{s d d m} + ( n d m - 1 ) \times {N}_{Δ {f}_{d} ( q )} ) & [ 8 ]\end{matrix}$$

$$\begin{matrix}( Expression 9 ) & \\ PowerFT ( {f}_{b} , {f}_{s} ) = {\sum }_{z = 1}^{{N}_{a}} {\vert {VFT}_{z} ( {f}_{b} , {f}_{s} ) \vert}^{2} & [ 9 ]\end{matrix}$$

Here, f_{sddm}=−N_{c}/2, . . . , −N_{c}/2+N_{Δfd}−1, where N_{Δfd} represents the number of Doppler frequency indices included in the interval of Δfd, and N_{Δfd}=round(Δfd/(1/(TᵣN_{c})). In addition, round(x) is an operator that rounds off real number x and outputs an integer value.

The operation in the CFAR processing may be based on the operation disclosed in NPL 2, for example, and detailed explanation of the exemplary operation is omitted.

Thus, since the Doppler frequency range subject to CFAR processing in CFAR section 210 can be narrowed from the full range of Doppler frequency index range fₛ (for example, the range of −N_{c}/2 to N_{c}/2−1) to the range of Δfd, the amount of computation for CFAR processing can be reduced to 1/(Nt+δ)=1/(N_{DM}+δ).

Then, CFAR section 210, for example, adaptively sets a threshold and outputs to Doppler demultiplexer 211 distance index f_{b_efar}, Doppler frequency index f_{sddm_cfar}, and reception power information (PowerFT(f_{b_cfar}, f_{sddm_cfar}+(ndm−1)×N_{Δfd})) that provide reception power greater than the threshold. Here, ndm is an integer from 1 to N_{DM}+δ.

### <Exemplary Operation 2 of CFAR Section 210>

In Exemplary Operation 2, an exemplary operation of CFAR section 210 in a case where the value of δ shown in Expression 3 is set to a real number that is not a positive integer in Doppler shifters 104 is described.

CFAR section 210 may, for example, calculate the power addition value of Expression 9 based on the outputs of Doppler analyzers 209 of first to Nath signal processors 206, and detect power peaks that match the Doppler shift intervals configured for a transmission signal for each distance index through adaptive threshold processing (CFAR processing).

Then, CFAR section 210, for example, adaptively sets a threshold and outputs to Doppler demultiplexer 211 distance index f_{b_cfar}, Doppler frequency index f_{s_cfar}(ndm) at the power peak that matches the Doppler shift interval set for the radar transmission signal, and reception power information PowerFT(f_{b_cfar}, f_{s_cfar}(ndm)) of Doppler frequency index f_{s_cfar}(ndm) that provide reception power greater than the threshold. Here, ndm is an integer from 1 to N_{DM}+δ.

The exemplary operation of CFAR section 210 are described above.

By way of example, below-described exemplary operations of Doppler demultiplexer 211 are described later in relation to a case where the output from Exemplary Operation 1 of CFAR section 210 is used, but the present disclosure is not limited to this, and the output from Exemplary Operation 2 of CFAR section 210 may also be used. When using the output from Exemplary Operation 2 of CFAR section 210, the difference is that Doppler frequency index f_{s_cfar}(ndm) is output instead of Doppler frequency index f_{sddm_cfar}+(ndm−1)×N_{Δfd} from Exemplary Operation 1 of CFAR section 210, but the other operations are similar and the same effects can be obtained.

### [Exemplary Operation of Doppler Demultiplexer 211]

Doppler demultiplexer 211 performs the following operations based on distance index f_{b_cfar}, Doppler frequency index f_{sddm_cfar}, and reception power information (PowerFT(f_{b_cfar}, f_{sddm_cfar}+(ndm−1)×N_{Δfd})) inputted from CFAR section 210, for example, when the value of δ shown in Expression 3 is set to a positive integer in Doppler shifters 104. Note that ndm is an integer from 1 to N_{DM}+δ.

In the following description, an exemplary operation of Doppler demultiplexer 211 in the case where a plurality of reception antennas of reception antenna section 202 include reception antennas of the same polarization is described. An exemplary operation of Doppler demultiplexer 211 in the case where the plurality of reception antennas of reception antenna section 202 include differently polarized reception antennas will be described later.

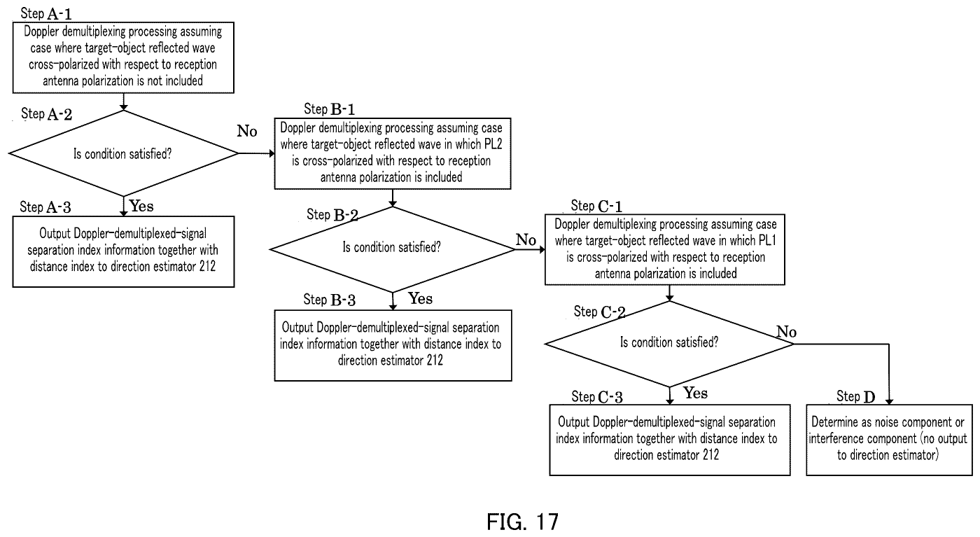

FIG. 17 is a flowchart showing an example of the separation operation of Doppler multiplexed signals in Doppler demultiplexer 211. It is assumed hereafter that the Doppler velocity of the target object is within the range of −1/(2Tr)≤fd<1/(2Tr).

### <Step A-1>

Assuming a case where a target-object reflected wave which is cross-polarized with respect to the polarization of the reception antenna is not included, Doppler demultiplexer 211 performs Doppler demultiplexing processing on Nt (=N_{DM}) Doppler multiplexed signals.

### <Step A-2>

In this case, for example, it is assumed that the N_{DM}+δ Doppler frequency indices (f_{sddm_cfar}+(ndm−1)×N_{Δfd}) for distance index f_{b_cfar} input from CFAR section 210 include N_{DM} Doppler multiplexed signals at uneven intervals.

Doppler demultiplexer 211, for example, compares the received power (PowerFT(f_{b_cfar}, f_{sddm_cfar}+(ndm−1)×N_{Δfd})) for Doppler frequency indices (f_{sddm_cfar}+(ndm−1)×N_{Δfd}) (for example, where ndm is an integer from 1 to N_{DM}+δ), and determines whether the top N_{DM} Doppler frequency indices (f_{sddm_cfar}+(ndm−1)×N_{Δfd}) in terms of reception power match the Doppler shift intervals applied at the time of transmission (for example, this may be referred to as “N_{DM} Doppler shift interval matching determination”).

Further, Doppler demultiplexer 211, for example, determines whether there is a significant difference (or reception level ratio) between the reception levels of the top N_{DM} Doppler frequency indices in terms of reception power and the reception levels of other δ Doppler frequency indices different from the top N_{DM} Doppler frequency indices in terms of reception power (for example, whether the difference exceeds a threshold, or whether the ratio of reception levels exceeds a threshold) (referred to, for example, as “N_{DM} Doppler multiplexed signal reception level difference determination”).

Based on these determinations, Doppler demultiplexer 211, for example, decides the Doppler frequency and the transmission antenna corresponding to the Doppler multiplexed signals within the range of −1/(2Tr)≤fd<1/(2Tr).

Note that the exemplary operation of Doppler demultiplexer 211 for separating Doppler multiplexed signals at uneven intervals is disclosed in PTL 7, for example, so the detailed description of its operation is omitted here.

For example, Doppler demultiplexer 211 determines whether conditions of both the N_{DM} Doppler shift interval matching determination and the N_{DM} Doppler multiplexed signal reception level difference determination (for example, the conditions of step A-2) are satisfied. For example, in the N_{DM} Doppler shift interval matching determination, when the top N_{DM} Doppler frequency indices (f_{sddm_cfar}+(ndm−1)×N_{Δfd}) of reception power are determined to match the Doppler shift intervals applied at transmission, and when in the N_{DM} Doppler multiplexed signal reception level difference determination, the reception level difference is determined to be equal to or greater than the threshold, the conditions of step A-2 are satisfied.

When the conditions of step A-2 are met, Doppler demultiplexer 211 may proceed with the process of step A-3; whereas when the conditions of step A-2 are not met, assuming the case where a target-object reflected wave in which the PL2 polarization is cross-polarized with respect to the polarization of the reception antenna is included, Doppler demultiplexer 211 may proceed with the process of Step B-1.

### <Step A-3>

For example, based on the relationship between the δ Doppler frequency indices for low reception levels among the Doppler frequency indices (f_{sddm_cfar}+(ndm−1)×N_{Δfd}) and the top N_{DM} Doppler frequency indices for high reception power, Doppler demultiplexer 211 associates Doppler shift amounts DOP₁, DOP₂, . . . , DOP_{Nt} of the Nt transmitted Doppler multiplexed signals with the Doppler frequency indices, and outputs them as Doppler-multiplexed-signal separation index information DDM_RXindex(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 may output the outputs of Doppler analyzers 209 corresponding to these distances and Doppler separation indices to direction estimator 212.

It should be noted that the Doppler shift amounts applied to transmission antennas of transmission antenna section 105 are known in Doppler shifters 104 of radar transmitter 100. Therefore, the difference between the Doppler frequency indicated by Doppler-multiplexed-signal separation index information DDM_RXindex(f_{b_cfar}) and the Doppler shift amounts applied to transmission antennas in radar transmitter 100 becomes the Doppler frequency of the target object. Therefore, Doppler demultiplexer 211 may output to direction estimator 212 the Doppler frequency of the target object estimated within the range of −1/(2Tr)≤fd<1/(2Tr) instead of separation index information DDM_RXindex(f_{b_cfar}). In this case, direction estimator 212 can perform a similar operation by generating Doppler-multiplexed-signal separation index information DDM_RXindex(f_{b_cfar}) based on the Doppler frequency of the target object input from Doppler demultiplexer 211 and the Doppler shift amounts applied to transmission antennas in Doppler shifters 104 of radar transmitter 100.

### <Step B-1>

Doppler demultiplexer 211 performs Doppler demultiplexing processing on N_{PL1} Doppler multiplexed signals, assuming the case where the target-object reflected wave in which PL2 polarization is cross-polarized with respect to the polarization of the reception antenna is included.

### <Step B-2>

In this case, it is assumed that N_{PL1} Doppler multiplexed signals from the PL1-polarized transmission antennas are included in the N_{DM}+δ Doppler frequency indices (f_{sddm_cfar}+(ndm−1)×N_{Δfd}) for distance index f_{b_cfar} input from CFAR section 210.

Doppler demultiplexer 211, for example, compares the reception power (PowerFT(f_{b_cfar}, f_{sddm_cfar}+(ndm−1)×N_{Δfd})) (for example, integers from ndm=1 to N_{DM}+δ) for the Doppler frequency indices (f_{sddm_cfar}+(ndm−1)×N_{Δfd}), to determine whether the top N_{PL1} Doppler frequency indices f_{sddm_cfar}+(ndm−1)×N_{Δfd}) match the Doppler shift intervals applied to the PL1-polarized transmission antenna at the time of transmission (for example, called “PL1 polarization Doppler shift interval matching determination”).

Further, Doppler demultiplexer 211, for example, determines whether there is a significant difference (or reception level ratio) in the reception level between the top N_{PL1} Doppler frequency indices of reception power and the reception levels of other Doppler frequency indices (N_{DM}+δ−N_{PL1}) that are different from the top N_{PL1} Doppler frequency indices (for example, whether the difference exceeds a threshold, or the reception level ratio exceeds a threshold) (for example, called “PL1 polarization Doppler multiplexed signal reception level difference determination”).

Doppler demultiplexer 211, for example, determines the Doppler frequency and transmission antenna corresponding to the Doppler multiplexed signals within the range of −1/(2Tr)≤fd<1/(2Tr) based on these determinations.

Note that since the exemplary operation of Doppler demultiplexer 211, which separates Doppler multiplexed signals at uneven intervals, is disclosed in PTL 7, for example, the detailed description of its operation is omitted here.

For example, Doppler demultiplexer 211 determines whether conditions of both the PL1 polarization Doppler shift interval matching determination and the PL1 polarization Doppler multiplexed signal reception level difference determination (for example, the conditions of Step B-2) are satisfied. For example, in the PL1 polarization Doppler shift interval matching determination, when the top N_{PL1} Doppler frequency indices (f_{sddm_cfar}+(ndm−1)×N_{Δfd}) of reception power are determined to match the Doppler shift intervals applied to PL1-polarized transmission antennas at transmission, and when in the PL1 polarization Doppler multiplexed signal reception level difference determination, the reception level difference is determined to be equal to or greater than the threshold, the conditions of Step B-2 are satisfied.

When the conditions of Step B-2 are met, Doppler demultiplexer 211 may proceed with the process of Step B-3; whereas when the conditions of Step B-2 are not met, assuming the case where a target-object reflected wave in which the PL1 polarization is cross-polarized with respect to the polarization of the reception antenna is included, Doppler demultiplexer 211 may proceed with the process of Step C-1.

Note that, when N_{PL1}=1, the PL1 polarization Doppler shift interval matching determination process may not be performed.

### <Step B-3>

For example, based on the relationship between the N_{DM}+δ−N_{PL1} Doppler frequency indices for low reception levels among the Doppler frequency indices (f_{sddm_cfar}+(ndm−1)×N_{Δfd}) and the top N_{PL1} Doppler frequency indices for high reception power, Doppler demultiplexer 211 associates Doppler shift amounts DOP₁, DOP₂, . . . , DOP_{Nt} of the Nt transmitted Doppler multiplexed signals with the Doppler frequency indices, and outputs them as Doppler-multiplexed-signal separation index information DDM_RXindex__{PL1}(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 may output the outputs of Doppler analyzers 209 corresponding to these distances and Doppler separation indices to direction estimator 212.

It should be noted that the Doppler shift amounts applied to transmission antennas of transmission antenna section 105 are known in Doppler shifters 104 of radar transmitter 100. Therefore, the difference between the Doppler frequency indicated by Doppler-multiplexed-signal separation index information DDM_RXindex__{PL1}(f_{b_cfar}) and the Doppler shift amounts applied to transmission antennas in radar transmitter 100 becomes the Doppler frequency of the target object. Therefore, Doppler demultiplexer 211 may output to direction estimator 212 the Doppler frequency of the target object estimated within the range of −1/(2Tr)≤fd<1/(2Tr) instead of separation index information DDM_RXindex__{PL1}(f_{b_cfar}). In this case, direction estimator 212 can perform a similar operation by generating Doppler-multiplexed-signal separation index information DDM_RXindex PL1(f_{b_cfar}) based on the Doppler frequency of the target object input from Doppler demultiplexer 211 and the Doppler shift amounts applied to transmission antennas in Doppler shifters 104 of radar transmitter 100.

Alternatively, Doppler demultiplexer 211 may associate the Doppler shift amounts of the Doppler multiplexed signals from the N_{PL1} transmission antennas among the Nt transmission antennas from which PL1 polarized waves are transmitted, with the Doppler frequency indices, and output the PL1 polarization separation index information of the Doppler multiplexed signals as DDM_Rxindex__{PL1}(f_{b_cfar}) along with distance indices f_{b_cfar} to direction estimator 212.

### <Step C-1>

Assuming the case where the PL1 polarization is cross-polarized to the polarization of the reception antenna, Doppler demultiplexer 211 performs Doppler demultiplexing processing for N_{PL2} Doppler multiplexed signals that include target-object reflected waves.

### <Step C-2>

In this case, for example, it is assumed that the N_{DM}+δ Doppler frequency indices (f_{sddm_cfar}+(ndm−1)×N_{Δfd}) for distance index f_{b_cfar} input from CFAR section 210 include N_{PL2} Doppler multiplexed signals from PL2-polarized transmission antennas.

Doppler demultiplexer 211, for example, compares the received power (PowerFT(f_{b_cfar}, f_{sddm_cfar}+(ndm−1)×N_{Δfd})) for Doppler frequency indices (f_{sddm_cfar}+(ndm−1)×N_{Δfd}) (for example, where ndm is an integer from 1 to N_{DM}+δ), and determines whether the top N_{PL2} Doppler frequency indices (f_{sddm_cfar}+(ndm−1)×N_{Δfd}) in terms of reception power match the Doppler shift intervals applied to the PL2-polarized transmission antennas at the time of transmission (for example, this may be referred to as “PL2 polarization Doppler shift interval matching determination”).

Further, Doppler demultiplexer 211, for example, determines whether there is a significant difference in reception level (or reception power ratio) between the top N_{PL2} Doppler frequency indices in terms of reception power and other (N_{DM}+δ−N_{PL2}) Doppler frequency indices different from the top N_{PL2} Doppler frequency indices in terms of reception power (for example, whether the difference exceeds a threshold, or whether the ratio of reception levels exceeds a threshold) (referred to, for example, as “PL2-polarized Doppler multiplexed signal reception level difference determination”).

Based on these determinations, Doppler demultiplexer 211, for example, decides the Doppler frequency and the transmission antenna within the range of −1/(2Tr)≤fd<1/(2Tr).

Note that the exemplary operation of Doppler demultiplexer 211 for separating Doppler multiplexed signals at uneven intervals is disclosed in PTL 7, for example, so the detailed description of its operation is omitted here.

For example, Doppler demultiplexer 211 determines whether conditions of both the PL2 polarization Doppler shift interval matching determination and the PL2-polarized Doppler multiplexed signal reception level difference determination (for example, the conditions of Step C-2) are satisfied. For example, in the PL2 polarization Doppler shift interval matching determination, when the top N_{PL2} Doppler frequency indices (f_{sddm_cfar}+(ndm−1)×N_{Δfd}) of reception power are determined to match the Doppler shift intervals applied to PL2-polarized transmission antennas at transmission, and when in the PL2-polarized Doppler multiplexed signal reception level difference determination, the reception level difference is determined to be equal to or greater than the threshold, the conditions of Step C-2 are satisfied.

When the conditions of Step C-2 are met, Doppler demultiplexer 211 may proceed with the processing of Step C-3. Further, when the conditions of Step C-2 are not met, Doppler demultiplexer 211 may determine that the reception signal is a noise component or an interference component and may not perform any output to direction estimator 212 (step D).

Note that when N_{PL2}=1, the PL2 polarization Doppler shift interval matching determination process may not be performed.

### <Step C-3>

For example, based on the relationship between the N_{DM}+δ−N_{PL2} Doppler frequency indices for low reception levels among the Doppler frequency indices (f_{sddm_cfar}+(ndm−1)×N_{Δfd}) and the top N_{PL2} Doppler frequency indices for high reception power, Doppler demultiplexer 211 associates Doppler shift amounts DOP₁, DOP₂, . . . , DOP_{Nt} of the Nt transmitted Doppler multiplexed signals with the Doppler frequency indices, and outputs them as Doppler-multiplexed-signal separation index information DDM_RXindex__{PL2}(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 may output the outputs of Doppler analyzers 209 corresponding to these distances and Doppler separation indices to direction estimator 212.

It should be noted that the Doppler shift amounts applied to transmission antennas of transmission antenna section 105 are known in Doppler shifters 104 of radar transmitter 100. Therefore, the difference between the Doppler frequency indicated by Doppler-multiplexed-signal separation index information DDM_RXindex__{PL2}(f_{b_cfar}) and the Doppler shift amounts applied to transmission antennas in radar transmitter 100 becomes the Doppler frequency of the target object. Therefore, Doppler demultiplexer 211 may output to direction estimator 212 the Doppler frequency of the target object estimated within the range of −1/(2Tr)≤fd<1/(2Tr) instead of separation index information DDM_RXindex__{PL2}(f_{b_cfar}). In this case, direction estimator 212 can perform a similar operation by generating Doppler-multiplexed-signal separation index information DDM_RXindex PL2(f_{b_cfar}) based on the Doppler frequency of the target object input from Doppler demultiplexer 211 and the Doppler shift amounts applied to transmission antennas in Doppler shifters 104 of radar transmitter 100.

Further, Doppler demultiplexer 211 may associate the Doppler shift amounts of the Doppler multiplexed signals from the N_{PL2} transmission antennas among the Nt transmission antennas from which PL2 polarized waves are transmitted, with the Doppler frequency indices, and output the PL2 polarization separation index information of the Doppler multiplexed signals as DDM_Rxindex__{PL2}(f_{b_cfar}) along with distance indices f_{b_cfar} to direction estimator 212.

The exemplary operations of Doppler demultiplexer 211 have been described above.

Further, when there are a plurality of distance indices f_{b_cfar}, a plurality of Doppler frequency indices f_{sddm_cfar}, and a plurality of pieces of reception power information (PowerFT(f_{b_cfar}, f_{sddm_cfar}+(ndm−1)×N_{Δfd})) input from CFAR section 210, Doppler demultiplexer 211 may perform the aforementioned Doppler demultiplexing operation multiple times for each distance index, Doppler frequency index, and reception power information.

### [Exemplary Operation of Direction Estimator 212]

Next, an exemplary operation of direction estimator 212 shown in FIG. 5 will be described.

In the following description, an exemplary operation of direction estimator 212 in a case where a plurality of reception antennas of reception antenna section 202 include reception antennas of the same polarization is described. An exemplary operation of direction estimator 212 in a case where the plurality of reception antennas of reception antenna section 202 include differently polarized reception antennas will be described later.

Direction estimator 212, for example, performs direction estimation processing on a target object based on information input from Doppler demultiplexer 211 (for example, distance indices f_{b_cfar}, Doppler-multiplexed-signal separation index information (DDM_Rxindex(f_{b_cfar})=(f_{demul_Tx #1}, f_{demul_Tx #2}, . . . , f_{demul_Tx #Nt}) or DDM_Rxindex__{PLq}(f_{b_cfar})), and the outputs of Doppler analyzers 209 corresponding to these distances and Doppler separation indices. Here, for example, q=1 or 2.

Below, exemplary operations 1 and 2 of direction estimator 212 are described.

### <Exemplary Operation 1 of Direction Estimator 212>

For example, direction estimator 212 extracts the outputs of Doppler analyzers 209 based on distance indices f_{b_cfar} and Doppler-multiplexed-signal separation index information DDM_Rxindex(f_{b_cfar}), generates a virtual reception array correlation vector h(f_{b_cfar}, DDM_Rxindex(f_{b_cfar})) of direction estimator 212 as shown in following Expression 10, and performs direction estimation processing.

Virtual reception array correlation vector h(f_{b_cfar}, DDM_Rxindex(f_{b_cfar})) of direction estimator 212 includes Nt×Na elements, which is the product of number Nt of transmission antennas and number Na of reception antennas, as shown in Expression 10. Direction estimator 212 uses virtual reception array correlation vector h(f_{b_cfar}, DDM_Rxindex(f_{b_cfar})) to perform direction estimation based on the phase difference between each transmission and reception antenna for the reflected wave signal from the target object.

$$\begin{matrix}( Expression 10 ) & \\ h ( {f}_{b \_ cfar} , DDM\_Rxindex ( {f}_{b \_ cfar} ) ) = [ \begin{matrix}{h}_{cal [ 1 ]} {VFT}_{1} ( {f}_{b \_ cfar} , {f}_{demul \_ Tx \#1} ) \\ {h}_{cal [ 2 ]} {VFT}_{2} ( {f}_{b \_ cfar} , {f}_{demul \_ Tx \#1} ) \\ ⋮ \\ {h}_{cal [ {N}_{a} ]} {VFT}_{{N}_{a}} ( {f}_{b \_ cfar} , {f}_{demul \_ Tx \#1} ) \\ {h}_{cal [ {N}_{a} + 1 ]} {VFT}_{1} ( {f}_{b \_ cfar} , {f}_{demul \_ Tx \#2} ) \\ {h}_{cal [ {N}_{a} + 2 ]} {VFT}_{2} ( {f}_{b \_ cfar} , {f}_{demul \_ Tx \#2} ) \\ ⋮ \\ {h}_{cal [ 2 {N}_{a} ]} {VFT}_{{N}_{a}} ( {f}_{b \_ cfar} , {f}_{demul \_ Tx \#2} ) \\ ⋮ \\ {h}_{cal [ {N}_{a} ( {N}_{t} - 1 ) + 1 ]} {VFT}_{1} ( {f}_{b \_ cfar} , {f}_{demul \_ Tx \# {N}_{t}} ) \\ {h}_{cal [ {N}_{a} ( {N}_{t} - 1 ) + 2 ]} {VFT}_{2} ( {f}_{b \_ cfar} , {f}_{demul \_ Tx \# {N}_{t}} ) \\ ⋮ \\ {h}_{cal [ {N}_{a} {N}_{t} ]} {VFT}_{{N}_{a}} ( {f}_{b \_ cfar} , {f}_{demul \_ Tx \# {N}_{t}} )\end{matrix} ] & [ 10 ]\end{matrix}$$

In Expression 10, h_{cal[b]} is an array correction value that corrects for phase and amplitude deviations between transmission antennas and between reception antennas. b is an integer from 1 to (Nt×Na).

For example, direction estimator 212 extracts reception signals corresponding to like-polarized transmission antennas from virtual reception array correlation vector h(f_{b_cfar}, DDM_Rxindex(f_{b_cfar})) for performing the direction estimation processing for each polarized transmission antenna.

For example, when the PL1-polarized transmission antennas are Tx #1 and Tx #3, the PL2-polarized transmission antennas are Tx #2 and Tx #4, N_{PL1}=2, N_{PL2}=2, Nt=4, and number Na of reception antennas is 4, transmission polarization antenna extraction vector SP_{PL1} for extracting the reception signal corresponding to the PL1-polarized transmission antenna, and transmission polarization antenna extraction vector SP_{PL2} for extracting the reception signal corresponding to the PL2-polarized transmission antenna, may be represented as 16 (=Nt×Na)-th order column vectors as shown in following Expressions 11 and 12. Here, superscript T denotes vector transposition.

$$\begin{matrix}( Expression 11 ) & \\ S {P}_{P L 1} = {[ 1 , 1 , 1 , 1 , 0 , 0 , 0 , 0 , 1 , 1 , 1 , 1 , 0 , 0 , 0 , 0 ]}^{T} & [ 11 ]\end{matrix}$$

$$\begin{matrix}( Expression 12 ) & \\ S {P}_{PL 2} = {[ 0 , 0 , 0 , 0 , 1 , 1 , 1 , 1 , 0 , 0 , 0 , 0 , 1 , 1 , 1 , 1 ]}^{T} & [ 12 ]\end{matrix}$$

Direction estimator 212, for example, uses the element index whose element is 1 in transmission polarization antenna extraction vector SP_{PL1} for extracting the reception signal from the PL1-polarized transmission antenna, to extract the element component from virtual reception array correlation vector h(f_{b_cfar}, DDM_Rxindex(f_{b_cfar})) using the element index, and generates a column vector arranged in ascending order of the element index as virtual reception array correlation vector h_{PL1}(f_{b_cfar}, DDM_Rxindex(f_{b_cfar})) of the PL1-polarized transmission antenna. For example, transmission polarization antenna extraction vector SP_{PL2} shown in Expression 11 has elements that are 1 at the first to 4th and 9th to 12th element indices. In this case, direction estimator 212 extracts the element components in the order of the first to 4th and 9th to 12th element indices from virtual reception array correlation vector h(f_{b_cfar}, DDM_Rxindex(f_{b_cfar})), and generates virtual reception array correlation vector h_{PL1}(f_{b_cfar}, DDM_Rxindex(f_{b_cfar})) of the PL1-polarized transmission antenna.

Further, direction estimator 212 uses the element index whose element is 1 in transmission polarization antenna extraction vector SP_{PL2} for extracting the reception signal from the PL2-polarized transmission antenna, to extract the element component from virtual reception array correlation vector h(f_{b_cfar}, DDM_Rxindex(f_{b_cfar})), and generates a column vector arranged in ascending order of the element index as virtual reception array correlation vector h_{PL2}(f_{b_cfar}, DDM_Rxindex(f_{b_cfar})) of the PL2-polarized transmission antenna. Here, h_{PL1}(f_{b_cfar}, DDM_Rxindex(f_{b_cfar})) is a column vector containing N_{PL1}×Na elements, and h_{PL2}(f_{b_cfar}, DDM_Rxindex(f_{b_cfar})) is a column vector containing N_{PL2}×Na elements. For example, transmission polarization antenna extraction vector SP_{PL2} shown in Expression 12 has elements that are 1 at the 5th to 8th and 13th to 16th element indices. In this case, direction estimator 212 extracts the element components in the order of the 5th to 8th and 13th to 16th element indices from virtual reception array correlation vector h(f_{b_cfar}, DDM_Rxindex(f_{b_cfar})), and generates virtual reception array correlation vector h_{PL2}(f_{b_cfar}, DDM_Rxindex(f_{b_cfar})) of the PL2-polarized transmission antenna.

For example, by using virtual reception array correlation vector h_{PL1}(f_{b_cfar}, DDM_Rxindex(f_{b_cfar})) of the PL1-polarized transmission antenna, and virtual reception array correlation vector h_{PL2}(f_{b_cfar}, DDM_Rxindex(f_{b_cfar})) of the PL2-polarized transmission antenna, direction estimator 212 calculates the spatial profile for each transmission polarization while varying azimuth direction θᵤ within a predetermined angle range in direction estimation evaluation function P_{H-PLq}(θᵤ, f_{b_cfar}, DDM_Rxindex(f_{b_cfar})) and. Here, q=1 and 2.

Direction estimator 212 may extract a predetermined number of local maximum peaks of the calculated spatial profiles for each PLq polarization in descending order and output the azimuth direction of the local maximum peaks as the direction-of-arrival estimation value for the PLq polarization (for example, as positioning output). Here, q is 1 and 2.

It should be noted that there are various methods with direction estimation evaluation function value P_{H-PLq}(θᵤ, f_{b_cfar}, DDM_Rxindex(f_{b_cfar})) depending on the direction-of-arrival estimation algorithm. For example, an estimation method using an array antenna disclosed in NPL 3 may be used.

For example, when the number of virtual reception antennas of the PLq-polarized transmission antenna is N_{PLq}×Na, and are arranged in a straight line at equal spacings dH, the beamformer method can be expressed as follows in Expression 13. In addition to the beamformer method, techniques such as Capon and MUSIC can also be applied similarly.

$$\begin{matrix}( Expression 13 ) & \\ {P}_{H - P L q} ( {θ}_{u} , {f}_{b \_ cfar} , DDM\_Rxindex ( {f}_{b \_ cfar} ) ) = {a}_{P L q}^{H} ( {θ}_{u} ) {h}_{P L q} ( {f}_{b \_ cfar} , DDM\_Rxindex ( {f}_{b \_ cfar} ) ) & [ 13 ]\end{matrix}$$

In Expression 13, superscript H denotes the Hermitian transpose operator. Further, in Expression 13, a_{PLq}(θᵤ) represents the direction vector of the virtual reception array of the PLq-polarized transmission antenna for an incoming wave in azimuth direction θᵤ at center frequency f_{c} of the radar transmission signal, and is a column vector with N_{PLq}×Na elements as expressed in Expression 14. In Expression 14, λ is the wavelength of the radar transmission signal (for example, a chirp signal) at center frequency fc, where λ=C₀/f_{c}.

$$\begin{matrix}( Expression 14 ) & \\ {a}_{P L q} ( {θ}_{u} ) = [ \begin{matrix}1 \\ exp ( - j 2 π {d}_{H} sin {θ}_{u} / λ ) \\ ⋮ \\ exp ( - j 2 π ( {N}_{PLq} {N}_{a} - 1 ) {d}_{H} sin {θ}_{u} / λ )\end{matrix} ] & [ 14 ]\end{matrix}$$

Moreover, azimuth direction θᵤ is a vector that changes at a predetermined azimuth interval β₁ within the azimuth range where direction-of-arrival estimation is performed. For example, θᵤ may be set as follows:

$${θ}_{u} = {θ}_{min} + u {β}_{1} , where integer u is 0 to NU ; and$$

$$NU = floor [ ( θ max - θmin ) / {β}_{1} ] + 1 .$$

Here, floor(x) is a function that returns the largest integer value not greater than real number x.

Further, although the example described above involves direction estimator 212 calculating the azimuth direction as the direction-of-arrival estimation value, the present disclosure is not limited to such, and direction-of-arrival estimation in both the azimuth and elevation directions is also possible by using MIMO antennas arranged in a rectangular grid. For example, direction estimator 212 may calculate both the azimuth and elevation directions as direction-of-arrival estimation values for each differently polarized transmission antenna, and output them as positioning outputs.

Through the above operations, direction estimator 212 of radar apparatus 10 may, for example, output as positioning outputs the direction-of-arrival estimation values for each differently polarized transmission antenna for distance index f_{b_cfar}, and Doppler-multiplexed-signal separation index information DDM_Rxindex(f_{b_cfar})=(f_{demul_Tx #1}, . . . , f_{demul_Tx #NDM}). Further, direction estimator 212 may further output distance index f_{b_cfar}, and Doppler-multiplexed-signal separation index information DDM_Rxindex(f_{b_cfar}) as the positioning outputs.

Additionally, direction estimator 212 may output the Doppler frequency estimation value of a target object based on Doppler-multiplexed-signal separation index information DDM_Rxindex(f_{b_cfar}), for example.

Further, distance index f_{b_cfar} may be converted into distance information using Expression 1 and outputted.

When there are a plurality of information inputs from Doppler demultiplexer 211 (for example, distance index f_{b_cfar}, and Doppler-multiplexed-signal separation index information DDM_Rxindex(f_{b_cfar})=(f_{demul_Tx #1}, f_{demul_Tx #2}, . . . , f_{demul_Tx #Nt})), direction estimator 212 may calculate the direction-of-arrival estimation values in the same manner as the aforementioned process for them and output the positioning results.

### <Exemplary Operation 2 of Direction Estimator 212>

For example, based on distance index f_{b_cfar} and Doppler-multiplexed-signal separation index information DDM_Rxindex__{PLq}(f_{b_cfar}), direction estimator 212 extracts the outputs of Doppler analyzers 209, generates virtual reception array correlation vector h_{PLq}(f_{b_cfar}, DDM_Rxindex__{PLq}(f_{b_cfar})) of direction estimator 212, and performs direction estimation processing. Here, q=1 or 2. Direction estimator 212, for example, performs the direction estimation processing for the polarization (PLq polarization) corresponding to q that matches Doppler-multiplexed-signal separation index information DDM_Rxindex__{PLq}(f_{b_cfar}).

For example, to perform direction estimation processing based on the reception signal corresponding to the radar transmission signal from the PLq-polarized transmission antenna, direction estimator 212 uses the element index where the element of transmission polarization antenna extraction vector SP_{PLq} corresponding to the PLq-polarized transmission antenna is 1, extracts the element component from virtual reception array correlation vector h(f_{b_cfar}, DDM_Rxindex__{PLq}(f_{b_cfar})) at that element index, and generates a column vector arranged in ascending order of that element index as h_{PLq}(f_{b_cfar}, DDM_Rxindex__{PLq}(f_{b_cfar})). Here, h_{PLq}(f_{b_cfar}, DDM_Rxindex__{PLq}(f_{b_cfar})) is a column vector having N_{PLq}×Na elements.

For example, by using virtual reception array correlation vector h_{PLq}(f_{b_cfar}, DDM_Rxindex__{PLq}(f_{b_cfar})) corresponding to the reception signal from the PLq-polarized transmission antenna, direction estimator 212 calculates the spatial profile for each transmission polarization while varying azimuth direction θᵤ within a predetermined angle range in direction estimation evaluation function P_{H-PLq}(θᵤ, f_{b_cfar}, DDM_Rxindex__{PLq}(f_{b_cfar})). Here, q=1 or 2.

Direction estimator 212 may extract a predetermined number of local maximum peaks of the calculated spatial profile based on the reception signal corresponding to the PLq-polarized transmission antenna in descending order and output the azimuth direction of the local maximum peaks as the direction-of-arrival estimation value (for example, positioning output) of the PLq polarization transmission.

Note that there are various methods with direction estimation evaluation function value P_{H-PLq}(θᵤ, f_{b_cfar}, DDM_Rxindex__{PLq}(f_{b_cfar})) depending on the direction-of-arrival estimation algorithm. For example, an estimation method using an array antenna, as disclosed in NPL 3, may be used.

Further, although the example described above involves direction estimator 212 calculating the azimuth direction as the direction-of-arrival estimation value, the present disclosure is not limited to such, and direction-of-arrival estimation in both the azimuth and elevation directions is also possible by using MIMO antennas arranged in a rectangular grid. For example, direction estimator 212 may calculate both the azimuth and elevation directions as direction-of-arrival estimation values for each differently polarized transmission antenna, and output them as positioning outputs.

Through the above operations, direction estimator 212 of radar apparatus 10 may, for example, output as positioning outputs the direction-of-arrival estimation values for PLq-polarized transmission based on reception signals from PLq-polarized transmission antennas for distance index f_{b_cfar}, and Doppler-multiplexed-signal separation index information DDM_Rxindex_PLq(f_{b_cfar})=(f_{demul_Tx #1}, . . . , f_{demul_Tx #NDM}). Further, direction estimator 212 may further output distance index f_{b_cfar}, and Doppler-multiplexed-signal separation index information DDM_Rxindex_PLq(f_{b_cfar}) as the positioning outputs.

Additionally, direction estimator 212 may output the Doppler frequency estimation value of a target object based on Doppler-multiplexed-signal separation index information DDM_Rxindex_PLq(f_{b_cfar}), for example.

Further, distance index f_{b_cfar} may be converted into distance information using Expression 1 and outputted.

When there are a plurality of information inputs from Doppler demultiplexer 211 (for example, distance index f_{b_cfar}, and Doppler-multiplexed-signal separation index information DDM_Rxindex_PLq(f_{b_cfar})=(f_{demul_Tx #1}, f_{demul_Tx #2}, . . . , f_{demul_Tx #Nt})), direction estimator 212 may calculate the direction-of-arrival estimation values in the same manner as the aforementioned process for them and output the positioning results.

Exemplary operations 1 and 2 of direction estimator 212 have been described above.

With the operations as described above, direction estimator 212 can perform direction estimation processing based on the output corresponding to the separation operation of Doppler demultiplexer 211. For example, direction estimator 212 can perform direction estimation processing based on the output of Doppler demultiplexer 211 corresponding to each case where no target-object reflected wave which is cross-polarized with respect to the polarization of the reception antenna is included, where a target-object reflected wave in which PL2 is cross-polarized with respect to the polarization of the reception antenna is included, and where a target-object reflected wave in which PL1 is cross-polarized with respect to the polarization of the reception antenna is included.

For instance, when no target-object reflected wave which is cross-polarized with respect to the polarization of the reception antenna is included, direction estimator 212 can perform direction estimation processing for each polarization included in the transmission antenna. Further, for example, when a target-object reflected wave in which PL2 is cross-polarized with respect to the polarization of the reception antenna is included, direction estimator 212 can perform direction estimation processing for PL1 polarized transmission. Further, for example, when a target-object reflected wave in which PL1 is cross-polarized with respect to the polarization of the reception antenna is included, direction estimator 212 can perform direction estimation processing for PL2-polarized transmission.

Through the operation of direction estimator 212, direction estimation processing results for each transmission polarization, or direction estimation results for some transmission polarizations depending on the situation of the reflected waves, are obtained, resulting in direction estimation results dependent on the transmission polarization. Since the response of the reflected waves from the target object may vary depending on the transmission polarization, radar apparatus 10 can improve the detection or identification performance of the target object based on such direction estimation results dependent on the transmission polarization.

The exemplary operations of the direction estimator have been described above.

As described above, in the present embodiment, when differently polarized transmission antenna are used in a polarimetric MIMO radar using uneven-interval Doppler multiplexing, radar apparatus 10 can achieve Doppler demultiplexing even when receiving reflected waves that significantly attenuate the reception level of reflected waves from a transmission antenna of a certain polarization compared to a transmission antenna of another polarization, and it is thus possible to suppress degradation of target object detection performance, or misestimation of Doppler frequency or degradation of angle measurement performance.

For example, when Conditions 1 and 2 mentioned above are met, in radar apparatus 10, detectable Doppler frequency range fd becomes −1/(2Tr)≤fd<1/(2Tr), which is an expansion from the detectable Doppler frequency range of −1/(2Nt×Tr)≤fd<1/(2Nt×Tr) in even-interval Doppler multiplexing.

Therefore, according to the present embodiment, the detection performance of the polarimetric MIMO radar using uneven-interval Doppler multiplexing transmission can be improved.

Further, in the present embodiment, radar apparatus 10 includes a reception antenna that receives a reflected wave signal of a radar transmission signal reflected by a target object using one of a plurality of polarizations (for example, PL1 polarization and PL2 polarization). In addition, radar apparatus 10 performs direction estimation based on the reflected wave signal received by the reception antenna. Thus, radar apparatus 10 can identify the transmission antenna corresponding to the Doppler multiplexed signal, even when it includes a reflected wave having a cross-polarization relationship with the polarization of the reception antenna, and can resolve the ambiguity of the Doppler frequency. Moreover, in the present embodiment, even when the reception antenna is reception antennas of the same polarization, Doppler demultiplexing is possible, and there is thus no need to additionally use different types of polarized reception antennas in radar receiver 200, reducing the number of reception antennas.

### Variation 1 of Embodiment 1

In the embodiment, as an example, the operation of CFAR section 210, Doppler demultiplexer 211, and direction estimator 212 when a plurality of reception antennas of reception antenna section 202 are of the same polarization was described.

The plurality of reception antennas of reception antenna section 202 may include reception antennas of different polarizations. In Variation 1 of Embodiment 1, the exemplary operation of the CFAR section, Doppler demultiplexer, and direction estimator when the plurality of reception antennas of reception antenna section 202 include reception antennas of different polarizations is described.

For example, when the plurality of reception antennas include reception antennas of different polarizations, the reception level of the target-object reflected waves may significantly differ for each polarization. Therefore, for example, radar apparatus 10 may perform CFAR processing, Doppler separation processing, and direction estimation processing individually for the outputs of Doppler analyzer 209 corresponding to the reception antennas of different polarizations.

Further, the direction estimation processing may be performed using the output of Doppler separation processing by reception antennas of a plurality of polarizations.

Hereinafter, as an example, the case where reception antenna section 202 includes reception antennas of at least two different polarizations, from Rx #1 to Rx #Na, will be described.

For example, two different polarizations are denoted as “RxPL1 polarization” and “RxPL2 polarization.” Also, out of Na reception antennas, the number of reception antennas for RxPL1 polarization is N_{RxPL1}, and the number for RxPL2 polarization is N_{RxPL2}. Here, N_{RxPL1}+N_{RxPL2}=Na.

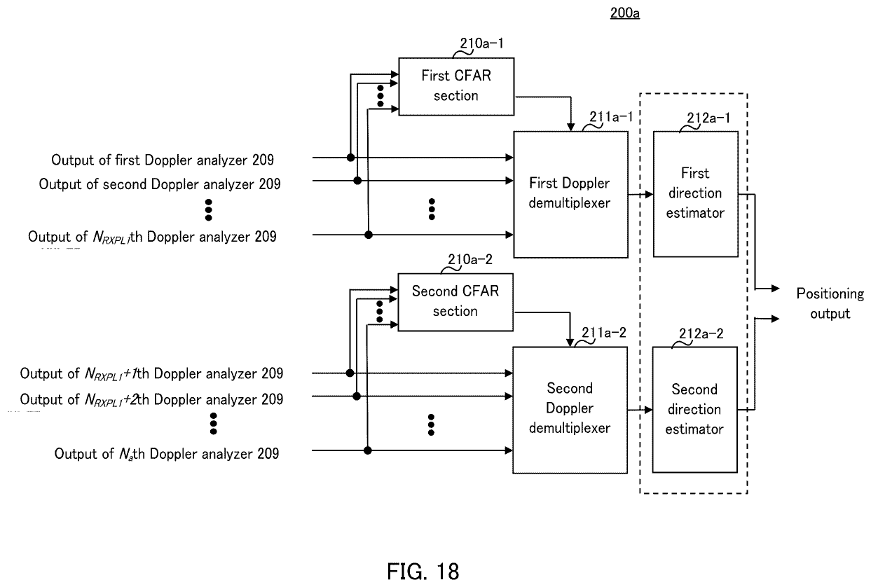

FIG. 18 is a block diagram showing an example configuration of CFAR sections 210a, Doppler demultiplexers 211a, and direction estimators 212a of radar receiver 200a in Variation 1 of Embodiment 1 of radar apparatus 10.

In FIG. 18, as an example, reception antennas Rx #1 to Rx #N_{RxPL1} are RxPL1-polarized reception antennas, and Rx #N_{RxPL1}+1 to Rx #Na are RxPL2-polarized reception antennas. Note that the relationship between the reception antenna numbers and polarizations is not limited to the example shown in FIG. 18.

Further, as shown in FIG. 18, Doppler demultiplexing using peak detection results of the reception antennas of the same polarization is possible, and since power addition operations between reception antennas of two different polarizations may not be performed, a reduction in the amount of computation in radar receiver 200a can be achieved.

For example, among the outputs of Na Doppler analyzers 209, the outputs of first to N_{RxPL1}th Doppler analyzers 209 correspond to the reception signals of the RxPL1-polarized reception antennas and are input to first CFAR section 210a-1, which performs CFAR processing on the reception signals of RxPL1 polarization.

Also, for example, among the outputs of Na Doppler analyzers 209, the outputs from Rx #N_{RxPL1}th+1 to Nath Doppler analyzers 209 correspond to the reception signals of the RxPL2-polarized reception antennas and are input to second CFAR section 210a-2, which performs CFAR processing on the reception signals of RxPL2 polarization.

The operation of first CFAR section 210a-1, for example, differs from that of CFAR section 210 in FIG. 5 in that the outputs of first to N_{RxPL1}th Doppler analyzers 209 are input to first CFAR section 210a-1, and instead of Expression 9, following Expression 15 is used to calculate the power addition value, and other operations may be similar to those of the aforementioned CFAR section 210:

$$\begin{matrix}( Expression 15 ) & \\ PowerFT ( {f}_{b} , {f}_{s} ) = {\sum }_{z = 1}^{{N}_{R x P L 1}} {\vert {VFT}_{z} ( {f}_{b} , {f}_{s} ) \vert}^{2} . & [ 15 ]\end{matrix}$$

The operation of second CFAR section 210a-2, for example, differs from that of CFAR section 210 in FIG. 5 in that the outputs of N_{RxPL1}+1th to Nath Doppler analyzers 209 are input to second CFAR section 210a-2, and instead of Expression 9, following Expression 16 is used to calculate the power addition value, and other operations may be similar to those of the aforementioned CFAR section 210:

$$\begin{matrix}( Expression 16 ) & \\ PowerFT ( {f}_{b} , {f}_{s} ) = {\sum }_{z = {N}_{R x P L 1} + 1}^{{N}_{a}} {\vert VF {T}_{z} ( {f}_{b} , {f}_{s} ) \vert}^{2} . & [ 16 ]\end{matrix}$$

First Doppler demultiplexer 211a-1 performs the separation operation of the Doppler multiplexed signals for the reception signal of the RxPL1-polarized reception antenna based on distance index f_{b_cfar}, the Doppler frequency index (f_{sddm_cfar}+(ndm−1)×N_{Δfd}), and the reception power information (PowerFT(f_{b_cfar}, f_{sddm_cfar}+(ndm−1)×N_{Δfd})) input from first CFAR section 210a-1, for example, when δ set in Expression 3 is a positive integer. The character “ndm” is an integer from 1 to N_{DM}+δ. The operation of first Doppler demultiplexer 211a-1 differs from that of Doppler demultiplexer 211 shown in FIG. 5 in that it uses the reception power information based on Expression 15, and other operations may be the same as those of Doppler demultiplexer 211.

Second Doppler demultiplexer 211a-2 performs the separation operation of the Doppler multiplexed signals for the reception signal of the RxPL2-polarized reception antenna based on distance index f_{b_cfar}, the Doppler frequency index (f_{sddm_cfar}+(ndm−1)×N_{Δfd}), and the reception power information (PowerFT(f_{b_cfar}, f_{sddm_cfar}+(ndm−1)×N_{Δfd})) input from the second CFAR section 210a-2, for example, when δ set in Expression 3 is a positive integer. The character “ndm” is an integer from 1 to N_{DM}+δ. The operation of second Doppler demultiplexer 211a-2 differs from that of Doppler demultiplexer 211 shown in FIG. 5 in that it uses the reception power information based on Expression 16, and other operations may be the same as those of Doppler demultiplexer 211.

Next, examples of the operations of first direction estimator 212a-1 and second direction estimator 212a-2 will be explained.

Hereinafter, first direction estimator 212a-1 and second direction estimator 212a-2 will be collectively described as “yth direction estimator 212a.” Here, y is 1 or 2.

The yth direction estimator 212a performs the target-object direction estimation processing based on the information (for example, distance index f_{b_cfar}, and the Doppler-multiplexed-signal separation index information (DDM_Rxindex(f_{b_cfar})=(f_{demul_Tx #1}, f_{demul_Tx #2}, . . . , f_{demul_Tx #Nt}) or DDM_Rxindex__{PLq}(f_{b_cfar})) input from yth Doppler demultiplexer 211a, and the output of Doppler analyzer 209 corresponding to such a distance and Doppler separation index. Here, q is 1 or 2.

Below, exemplary operations 1 and 2 of yth direction estimator 212a will be explained.

<Exemplary Operation 1 of yth Direction Estimator 212a>

For example, yth direction estimator 212a extracts the output of Doppler analyzer 209 based on the information, distance index f_{b_cfar} and Doppler-multiplexed-signal separation index information DDM_Rxindex(f_{b_cfar}), input from yth Doppler demultiplexer 211a, and generates virtual reception array correlation vector h_{RxPLy}(f_{b_cfar}, DDM_Rxindex(f_{b_cfar})) of yth direction estimator 212a as shown in Expressions 17 and 18, and performs the direction estimation processing. Here, y is 1 or 2.

Virtual reception array correlation vector h_{RxPLy}(f_{b_cfar}, DDM_Rxindex(f_{b_cfar})) of yth direction estimator 212a includes Nt×N_{RxPLy} elements, which is the product of number Nt of transmission antennas and number N_{RxPLy} of RxPLy-polarized reception antennas, as shown in Expressions 17 and 18. The yth direction estimator 212a performs direction estimation on the reflected wave signal from the target object based on the phase difference between transmission and reception antennas using virtual reception array correlation vector h_{RxPLy}(f_{b_cfar}, DDM_Rxindex(f_{b_cfar})).

$$\begin{matrix}[ 17 ] & \\ {h}_{RxPL 1} ( {f}_{b\_cfar} , DDM\_Rxindex ( {f}_{b\_cfar} ) ) = [ \begin{matrix}{h}_{calRxPL 1 [ 1 ]} {VFT}_{1} ( {f}_{b\_cfar} , {f}_{demul\_Tx \#1} ) \\ {h}_{calRxPL 1 [ 2 ]} {VFT}_{2} ( {f}_{b\_cfar} , {f}_{demul\_Tx \#1} ) \\ ⋮ \\ {h}_{calRxPL 1 [ {N}_{{N}_{RxPL 1}} ]} {VFT}_{{N}_{RxPL 1}} ( {f}_{b\_cfar} , {f}_{demul\_Tx \#1} ) \\ {h}_{calRxPL 1 [ {N}_{RxPL 1} + 1 ]} {VFT}_{1} ( {f}_{b\_cfar} , {f}_{demul\_Tx \#2} ) \\ {h}_{calRxPL 1 [ {N}_{RxPL 1} + 2 ]} {VFT}_{2} ( {f}_{b\_cfar} , {f}_{demul\_Tx \#2} ) \\ ⋮ \\ {h}_{calRxPL 1 [ 2 {N}_{RxPL 1} ]} {VFT}_{{N}_{RxPL 1}} ( {f}_{b\_cfar} , {f}_{demul\_Tx \#2} ) \\ ⋮ \\ {h}_{calRxPL 1 [ {N}_{RxPL 1} ( {N}_{t} - 1 ) + 1 ]} {VFT}_{1} ( {f}_{b\_cfar} , {f}_{demul\_Tx \# {N}_{t}} ) \\ {h}_{calRxPL 1 [ {N}_{RxPL 1} ( {N}_{t} - 1 ) + 2 ]} {VFT}_{2} ( {f}_{b\_cfar} , {f}_{demul\_Tx \# {N}_{t}} ) \\ ⋮ \\ {h}_{calRxPL 1 [ {N}_{RxPL 1} {N}_{t} ]} {VFT}_{{N}_{RxPL 1}} ( {f}_{b\_cfar} , {f}_{demul\_Tx \# {N}_{t}} )\end{matrix} ] & ( Expression 17 )\end{matrix}$$

$$\begin{matrix}[ 18 ] & \\ {h}_{RxPL 2} ( {f}_{b\_cfar} , DDM\_Rxindex ( {f}_{b\_cfar} ) ) = [ \begin{matrix}{h}_{calRxPL 2 [ 1 ]} {VFT}_{{N}_{RxPL 1} + 1} ( {f}_{b\_cfar} , {f}_{demul\_Tx \#1} ) \\ {h}_{calRxPL 2 [ 2 ]} {VFT}_{{N}_{RxPL 1} + 2} ( {f}_{b\_cfar} , {f}_{demul\_Tx \#1} ) \\ ⋮ \\ {h}_{calRxPL 2 [ {N}_{{N}_{RxPL 2}} ]} {VFT}_{{N}_{a}} ( {f}_{b\_cfar} , {f}_{demul\_Tx \#1} ) \\ {h}_{calRxPL 2 [ {N}_{RxPL 2} + 1 ]} {VFT}_{{N}_{RxPL 1} + 1} ( {f}_{b\_cfar} , {f}_{demul\_Tx \#2} ) \\ {h}_{calRxPL 2 [ {N}_{RxPL 2} + 2 ]} {VFT}_{{N}_{RxPL 1} + 2} ( {f}_{b\_cfar} , {f}_{demul\_Tx \#2} ) \\ ⋮ \\ {h}_{calRxPL 2 [ 2 {N}_{RxPL 2} ]} {VFT}_{{N}_{RxPL 1}} ( {f}_{b\_cfar} , {f}_{demul\_Tx \#2} ) \\ ⋮ \\ {h}_{calRxPL 2 [ {N}_{RxPL 2} ( {N}_{t} - 1 ) + 1 ]} {VFT}_{{N}_{RxPL 1} + 1} ( {f}_{b\_cfar} , {f}_{demul\_Tx \# {N}_{t}} ) \\ {h}_{calRxPL 2 [ {N}_{RxPL 2} ( {N}_{t} - 1 ) + 2 ]} {VFT}_{{N}_{RxPL 1} + 2} ( {f}_{b\_cfar} , {f}_{demul\_Tx \# {N}_{t}} ) \\ ⋮ \\ {h}_{calRxPL 2 [ {N}_{RxPL 2} {N}_{t} ]} {VFT}_{{N}_{Ra}} ( {f}_{b\_cfar} , {f}_{demul\_Tx \# {N}_{t}} )\end{matrix} ] & ( Expression 18 )\end{matrix}$$

In Expression 17, h_{calRxPL1[bRxPL1]} is an array correction value that corrects phase and amplitude deviations between transmission and reception antennas. bRxPL1 is an integer from 1 to (Nt×N_{RxPL1}). Also, in Expression 18, h_{calRxPL2[bRxPL2]} is an array correction value that corrects phase and amplitude deviations between the transmission and reception antennas. bRxPL2 is an integer from 1 to (Nt×N_{RxPL2}).

For example, yth direction estimator 212a extracts the reception signals corresponding to the transmission antennas of the same polarization from virtual reception array correlation vector h_{RxPLy}(f_{b_cfar}, DDM_Rxindex(f_{b_cfar})) to perform direction estimation processing on transmission antennas for each polarization. The following operations are performed for extraction: for example, yth direction estimator 212a uses the element index where the element of transmission polarization antenna extraction vector SP_{PL1,RxPLy} corresponding to the reception signal of the PL1-polarized transmission antenna is 1, extracts the element component from virtual reception array correlation vector h_{RxPLy}(f_{b_cfar}, DDM_Rxindex(f_{b_cfar})) corresponding to this element index, and generates a column vector arranged in ascending order of this element index as virtual reception array correlation vector h_{PL1, RxPLy}(f_{b_cfar}, DDM_Rxindex(f_{b_cfar})) by the PL1-polarized transmission antenna. Similarly, yth direction estimator 212a uses the element index where the element of transmission polarization antenna extraction vector SP_{PL2,RxPLy} corresponding to the reception signal of the PL2-polarized transmission antenna is 1, extracts the element component from virtual reception array correlation vector h_{RxPLy}(f_{b_cfar}, DDM_Rxindex(f_{b_cfar})) corresponding to this element index, and generates a column vector arranged in ascending order of this element index as virtual reception array correlation vector h_{PL2, RxPLy}(f_{b_cfar}, DDM_Rxindex(f_{b_cfar})) by the PL2-polarized transmission antenna. Here, h_{PL1, RxPLy}(f_{b_cfar}, DDM_Rxindex(f_{b_cfar})) is a column vector with N_{PL1}×N_{RxPLy} elements, and h_{PL2, RxPLy}(f_{b_cfar}, DDM_Rxindex(f_{b_cfar})) is a column vector with N_{PL2}×N_{RxPLy} elements.

Here, transmission polarization antenna extraction vector SP_{PLq,RxPLy}, which extracts the reception signal of the RxPLy-polarized reception antenna corresponding to the transmission signal sent from the PLq-polarized transmission antenna, is set based on the polarization of each transmission and reception antenna.

For example, the case where the RxPL1-polarized reception antennas are Rx #1 and Rx #2 and the RxPL2-polarized reception antennas are Rx #3 and Rx #4 when the PL1-polarized transmission antennas are Tx #1 and Tx #3, the PL2-polarized transmission antennas are Tx #2 and Tx #4, N_{PL1}=2, N_{PL2}=2, Nt=4, the number of reception antennas Na=4, N_{RxPL1}=2, and N_{RxPL2}=2 will be described.

In this case, transmission polarized antenna extraction vector SP_{PL1, RxPL1} for extracting the reception signal corresponding to the PL1-polarized transmission antenna from the reception signal of the RxPL1-polarized reception antenna, and transmission polarized antenna extraction vector SP_{PL2, RxPL1} for extracting the reception signal corresponding to the PL2-polarized transmission antenna from the reception signal of the RxPL1-polarized reception antenna, may be represented as 16th (=Nₜ×Na) order column vectors as shown in following Expressions 19 and 20. Further, transmission polarized antenna extraction vector SP_{PL1, RxPL2} for extracting the reception signal corresponding to the PL1-polarized transmission antenna from the reception signal of the RxPL2-polarized reception antenna, and transmission polarized antenna extraction vector S_{PPL2, RxPL2} for extracting the reception signal corresponding to the PL2-polarized transmission antenna from the reception signal of the RxPL2-polarized reception antenna, may be represented as 16th (=Nₜ×Na) order column vectors as shown in following Expressions 21 and 22. Here, superscript T denotes vector transposition.

$$\begin{matrix}[ 19 ] & \\ S {P}_{PL 1 , RxPL 1} = {[ 1 , 1 , 0 , 0 , 0 , 0 , 0 , 0 , 1 , 1 , 0 , 0 , 0 , 0 , 0 , 0 ]}^{T} & ( Expression 19 )\end{matrix}$$

$$\begin{matrix}[ 20 ] & \\ S {P}_{P L 2 , R x P L 1} = {[ 0 , 0 , 0 , 0 , 1 , 1 , 0 , 0 , 0 , 0 , 0 , 0 , 1 , 1 , 0 , 0 ]}^{T} & ( Expression 20 )\end{matrix}$$

$$\begin{matrix}[ 21 ] & \\ S {P}_{P L 1 , R x P L 2} = {[ 0 , 0 , 1 , 1 , 0 , 0 , 0 , 0 , 0 , 0 , 1 , 1 , 0 , 0 , 0 , 0 ]}^{T} & ( Expression 21 )\end{matrix}$$

$$\begin{matrix}[ 22 ] & \\ S {P}_{PL 2 , RxPL 2} = {[ 0 , 0 , 0 , 0 , 0 , 0 , 1 , 1 , 0 , 0 , 0 , 0 , 0 , 0 , 1 , 1 ]}^{T} & ( Expression 22 )\end{matrix}$$

For example, by using virtual reception array correlation vector h_{PL1, RxPLy}(f_{b_cfar}, DDM_Rxindex(f_{b_cfar})) of the PL1-polarized transmission antenna, and virtual reception array correlation vector h_{PL2, RxPLy}(f_{b_cfar}, DDM_Rxindex(f_{b_cfar})) of the PL2-polarized transmission antenna, yth direction estimator 212a calculates the spatial profile for each transmission polarization while varying azimuth direction θᵤ within a predetermined angle range in direction estimation evaluation function P_{H-PLq, RxPLy}(θᵤ, f_{b_cfar}, DDM_Rxindex(f_{b_cfar})) and. Here, q=1 and 2.

The yth direction estimator 212a may extract a predetermined number of local maximum peaks of the calculated spatial profiles for each PLq polarization in descending order and output the azimuth direction of the local maximum peaks as the direction-of-arrival estimation value with the RxPLy-polarized reception antenna for the PLq polarization (for example, as positioning output). Here, q is 1 and 2.

It should be noted that there are various methods with direction estimation evaluation function value P_{H-PLq, RxPL1}(θᵤ, f_{b_cfar}, DDM_Rxindex(f_{b_cfar})) depending on the direction-of-arrival estimation algorithm. For example, an estimation method using an array antenna disclosed in NPL 3 may be used.

For example, when the number of virtual reception antennas of the PLq-polarized transmission antenna is N_{PLq}×N_{RxPL1}, and are arranged in a straight line at equal spacings dH, the beamformer method can be expressed as follows in Expression 23. In addition to the beamformer method, techniques such as Capon and MUSIC can also be applied similarly.

$$\begin{matrix}[ 23 ] & \\ {P}_{H - PLq , RxPL 1} ( {θ}_{u} , {f}_{b\_cfar} , DDM\_Rxindex ( {f}_{b\_cfar} ) ) = {a}_{PLq , RxPL 1}^{H} ( {θ}_{u} ) {h}_{P L q , R x P L 1} ( {f}_{b\_cfar} , DDM\_Rxindex ( {f}_{b\_cfar} ) ) & ( Expression 23 )\end{matrix}$$

In Expression 23, superscript H denotes the Hermitian transpose operator. Further, in Expression 23, a_{PLq, RxPLy}(θᵤ) represents the direction vector of the virtual reception array of the PLq-polarized transmission antenna and the RxPLy-polarized reception antenna for an incoming wave in azimuth direction θᵤ at center frequency f_{c} of the radar transmission signal, and is a column vector with N_{PLq}×N_{RxPLy} elements as expressed in Expression 24. In Expression 24, λ is the wavelength of the radar transmission signal (for example, a chirp signal) at center frequency fc, where λ=C₀/f_{c}.

$$\begin{matrix}[ 24 ] & \\ {a}_{PLq , RxPLy} ( {θ}_{u} ) = [ \begin{matrix}1 \\ exp ( - j 2 π {d}_{H} sin {θ}_{u} / λ ) \\ ⋮ \\ exp ( - j 2 π ( {N}_{PLq} {N}_{R xPLy} - 1 ) {d}_{H} sin {θ}_{u} / λ )\end{matrix} ] & ( Expression 24 )\end{matrix}$$

Moreover, azimuth direction θᵤ is a vector that changes at a predetermined azimuth interval β₁ within the azimuth range where direction-of-arrival estimation is performed. For example, θᵤ may be set as follows:

$${θ}_{u} = {θ}_{min} + u {β}_{1} , where integer u is 0 to NU ; and$$

$$NU = floor [ ( θ max - θ min ) / {β}_{1} ] + 1 .$$

Here, floor(x) is a function that returns the largest integer value not greater than real number x.

Further, although the example described above involves yth direction estimator 212a calculating the azimuth direction as the direction-of-arrival estimation value, the present disclosure is not limited to such, and direction-of-arrival estimation in both the azimuth and elevation directions is also possible by using MIMO antennas arranged in a rectangular grid. For example, yth direction estimator 212a may calculate both the azimuth and elevation directions as direction-of-arrival estimation values with the RxPLy-polarized reception antenna for each differently polarized transmission antenna, and output them as positioning outputs.

Through the above operations, yth direction estimator 212a may, for example, output as positioning outputs the direction-of-arrival estimation values with the RxPLy-polarized reception antenna for each differently polarized transmission antenna for distance index f_{b_cfar}, and Doppler-multiplexed-signal separation index information DDM_Rxindex(f_{b_cfar})=(f_{demul_Tx #1}, . . . , f_{demul_Tx #NDM}) being information input from yth Doppler demultiplexer 211a. Further, yth direction estimator 212a may further output distance index f_{b_cfar}, and Doppler-multiplexed-signal separation index information DDM_Rxindex(f_{b_cfar}) as the positioning outputs.

Additionally, yth direction estimator 212a may output the Doppler frequency estimation value of a target object based on Doppler-multiplexed-signal separation index information DDM_Rxindex(f_{b_cfar}), for example.

Further, distance index f_{b_cfar} may be converted into distance information using Expression 1 and outputted.

When there are a plurality of information inputs from yth Doppler demultiplexer 211a (for example, distance index f_{b_cfar}, and Doppler-multiplexed-signal separation index information DDM_Rxindex(f_{b_cfar})=(f_{demul_Tx #1}, f_{demul_Tx #2}, . . . , f_{demul_Tx #Nt})), yth direction estimator 212a may calculate the direction-of-arrival estimation values in the same manner as the aforementioned process for them and output the positioning results.

<Exemplary Operation 2 of yth Direction Estimator 212a>

For example, yth direction estimator 212a extracts the outputs of Doppler analyzers 209 based on distance index f_{b_cfar} and Doppler-multiplexed-signal separation index information DDM_Rxindex__{PLq}(f_{b_cfar}) input from yth Doppler demultiplexer 211a, generates virtual reception array correlation vector h_{PLq,RxPLy}(f_{b_cfar}, DDM_Rxindex__{PLq}(f_{b_cfar})) by the PLq-polarized transmission antenna, and performs direction estimation processing. Here, q is either 1 or 2. The yth direction estimator 212a, for example, performs direction estimation processing for the polarization (PLq polarization) corresponding to q that matches Doppler-multiplexed-signal separation index information DDM_Rxindex__{PLq}(f_{b_cfar}).

For example, yth direction estimator 212a performs direction estimation processing based on the reception signal received with the RxPLy-polarized reception antenna corresponding to the radar transmission signal from the PLq-polarized transmission antenna, using the element index where the element is 1 in transmission polarization antenna extraction vector SP_{PLq,RxPLy} corresponding to the reception signal of the PLq-polarized transmission antenna, extracts the element component of that element index from virtual reception array correlation vector h_{RxPLy}(f_{b_cfar}, DDM_Rxindex_{PLq}(f_{b_cfar})) (for example, Expression 17 or Expression 18), and generates a column vector arranged in ascending order of that element index as virtual reception array correlation vector h_{PLq,RxPLy}(f_{b_cfar}, DDM_Rxindex__{PLq}(f_{b_cfar})) by the PLq-polarized transmission antenna. Here, h_{PLq, RxPLy}(f_{b_cfar}, DDM_Rxindex_{PLq}(f_{b_cfar})) is a column vector having N_{PLq}×N_{RxPLy} elements.

By using virtual reception array correlation vector h_{PLq, RxPLy}(f_{b_cfar}, DDM_Rxindex_{PLq}(f_{b_cfar})) by the reception signal transmitted from the PLq-polarized transmission antenna and received by the RxPLy-polarized reception antenna, yth direction estimator 212a calculates the spatial profile of the PLq transmission polarization while varying azimuth direction θᵤ within a predetermined angle range in direction estimation evaluation function P_{H-PLq,RxPLy}(θᵤ, f_{b_cfar}, DDM_Rxindex__{PLq}(f_{b_cfar})). Here, q is either 1 or 2.

The yth direction estimator 212a may extract a predetermined number of local maximum peaks of the calculated spatial profile based on the reception signal corresponding to the PLq-polarized transmission antenna in descending order and perform positioning output of the azimuth direction of the local maximum peaks as the direction-of-arrival estimation value (for example, positioning output) in the case of PLq-polarized transmission and RxPLy-polarized reception.

It should be noted that there are various methods with direction estimation evaluation function value P_{H-PLq, RxPLy}(θᵤ, f_{b_cfar}, DDM_Rxindex_PLq(f_{b_cfar})) depending on the direction-of-arrival estimation algorithm. For example, an estimation method using an array antenna disclosed in NPL 3 may be used.

Further, although the example described above involves yth direction estimator 212a calculating the azimuth direction as the direction-of-arrival estimation value, the present disclosure is not limited to such, and direction-of-arrival estimation in both the azimuth and elevation directions is also possible by using MIMO antennas arranged in a rectangular grid. For example, yth direction estimator 212a may calculate both the azimuth and elevation directions as the direction-of-arrival estimation values of RxPLy-polarized reception antennas for each differently polarized transmission antenna, and output them as positioning outputs.

Through the above operations, yth direction estimator 212a may, for example, output as positioning outputs the direction-of-arrival estimation values for the PLq-polarized transmission antenna by RxPLy-polarized reception antenna based on a reception signal from each PLq-polarized transmission antenna for distance index f_{b_cfar}, and Doppler-multiplexed-signal separation index information DDM_Rxindex_PLq(f_{b_cfar})=(f_{demul_Tx #1}, f_{demul_Tx #NDM}) input from yth Doppler demultiplexer 211a. Further, yth direction estimator 212a may further output distance index f_{b_cfar}, and Doppler-multiplexed-signal separation index information DDM_Rxindex_PLq(f_{b_cfar}) as the positioning outputs.

Additionally, direction estimator 212a may output the Doppler frequency estimation value of a target object based on Doppler-multiplexed-signal separation index information DDM_Rxindex_PLq(f_{b_cfar}), for example.

Further, distance index f_{b_cfar} may be converted into distance information using Expression 1 and outputted.

When there are a plurality of information inputs from Doppler demultiplexer 211 (for example, distance index f_{b_cfar}, and Doppler-multiplexed-signal separation index information DDM_Rxindex_PLq(f_{b_cfar})=(f_{demul_Tx #1}, f_{demul_Tx #2}, . . . , f_{demul_Tx #Nt})), yth direction estimator 212a may calculate the direction-of-arrival estimation values in the same manner as the aforementioned process for them and output the positioning results.

Exemplary operations 1 and 2 of yth direction estimator 212a are described above.

Through such operations, yth direction estimator 212a can obtain the results of direction estimation processing with the RxPLy-polarized reception antenna for each transmission polarization, or the direction estimation results with the RxPLy-polarized reception antenna for some transmission polarizations depending on the situation of the reflected waves, thus obtaining direction estimation results dependent on the transmission and reception polarization antennas. Since the response of the reflected waves from the target object can vary depending on the transmission and reception polarizations, radar apparatus 10 can improve the detection or identification performance of the target object based on such direction estimation results dependent on the transmission and reception polarizations.

Further, here, the description has been given of the case where yth direction estimator 212a performs the target-object direction estimation processing based on the information input from yth Doppler demultiplexer 211a (for example, distance index f_{b_cfar}, and Doppler-multiplexed-signal separation index information (DDM_Rxindex(f_{b_cfar})=(f_{demul_Tx #1}, f_{demul_Tx #2}, . . . , f_{demul_Tx #Nt}) or DDM_Rxindex__{PLq}(f_{b_cfar})) and the outputs of Doppler analyzers 209 corresponding to these distances and Doppler separation indices, but the present disclosure is not limited to this.

For example, yth direction estimator 212a may perform the target-object direction estimation processing based on the information input from first Doppler demultiplexer 211a-1 (for example, distance index f_{b_cfar}, and Doppler-multiplexed-signal separation index information (DDM_Rxindex(f_{b_cfar})=(f_{demul_Tx #1}, f_{demul_Tx #2}, . . . , f_{demul_Tx #Nt}) or DDM_Rxindex__{PLq}(f_{b_cfar})), the outputs of Doppler analyzers 209 corresponding to these distances and Doppler separation indices, and the information input from second Doppler demultiplexer 211a-2 (for example, distance index f_{b_cfar}, and Doppler-multiplexed-signal separation index information (DDM_Rxindex(f_{b_cfar})=(f_{demul_Tx #1}, f_{demul_Tx #2}, . . . , f_{demul_Tx #Nt}) or DDM_Rxindex__{PLq}(f_{b_cfar})), and the outputs of Doppler analyzers 209 corresponding to these distances and Doppler separation indices.

For example, yth direction estimator 212a calculates virtual reception array correlation vector h_{PL1, RxPL1}(f_{b_cfar}, DDM_Rxindex(f_{b_cfar})) based on the reception signal transmitted from the PL1-polarized transmission antenna and received by the RxPL1-polarized reception antenna, using the information input from first Doppler demultiplexer 211a-1. Further, yth direction estimator 212a calculates virtual reception array correlation vector h_{PL2, RxPL2}(f_{b_cfar}, DDM_Rxindex(f_{b_cfar})) based on the reception signal transmitted from the PL2-polarized transmission antenna and received by the RxPL2-polarized reception antenna, using the information input from second Doppler demultiplexer 211a-2. Then, yth direction estimator 212a may perform the target-object direction estimation processing based on virtual reception array correlation vector h_{PL1, RxPL1}(f_{b_cfar}, DDM_Rxindex(f_{b_cfar})) and virtual reception array correlation vector h_{PL2, RxPL2}(f_{b_cfar}, DDM_Rxindex(f_{b_cfar})).

Alternatively, for example, yth direction estimator 212a calculates virtual reception array correlation vector h_{PL2, RxPL1}(f_{b_cfar}, DDM_Rxindex(f_{b_cfar})) based on the reception signal transmitted from the PL2-polarized transmission antenna and received by the RxPL1-polarized reception antenna, using the information input from first Doppler demultiplexer 211a-1. Further, yth direction estimator 212a calculates virtual reception array correlation vector h_{PL1, RxPL2}(f_{b_cfar}, DDM_Rxindex(f_{b_cfar})) based on the reception signal transmitted from the PL1-polarized transmission antenna and received by the RxPL2-polarized reception antenna, using the information input from second Doppler demultiplexer 211a-2. Then, yth direction estimator 212a may perform target-object direction estimation processing based on virtual reception array correlation vectors h_{PL2, RxPL1}(f_{b_cfar}, DDM_Rxindex(f_{b_cfar})) and h_{PL1, RxPL2}(f_{b_cfar}, DDM_Rxindex(f_{b_cfar})).

### Variation 2 of Embodiment 1

Embodiment 1 has been described in relation to the operation where simultaneous multiplexing transmission of the Doppler multiplexed signals, which are transmitted using the Nt transmission antennas of transmission antenna section 105 at uneven intervals and to which the Doppler shift amounts are applied by Doppler shifters 104, is performed from the Nt transmission antennas using Doppler multiplexing transmission (DDM) that satisfies both Condition 1 and Condition 2, but the present disclosure is not limited to this.

In Variation 2 of Embodiment 1, for example, the Doppler multiplexed signals, which are transmitted using the Nt transmission antennas of transmission antenna section 105 at uneven intervals and to which the Doppler shift amounts are applied by Doppler shifters 104, may be simultaneously transmitted from the Nt transmission antennas using Doppler multiplexing transmission (DDM) that does not satisfy Condition 1 but satisfies Condition 2.

Such a configuration of the Doppler shift amounts in Doppler shifters 104, for example, differs in that it includes the operation of Doppler demultiplexing of even-interval Doppler multiplexed signals in the operation of <Step B-1> or <Step C-1> in Doppler demultiplexer 211.

Here, when the Doppler frequency range of an assumed target object is within the below-described detectable Doppler frequency range, radar apparatus 10 can separate the Doppler multiplexed signals through the existing separation operation of even-interval Doppler multiplexed signals.

Examples of the case where the Doppler multiplexed signals, to which the Doppler shift amounts are applied by Doppler shifters 104, do not satisfy Condition 1, include the following three cases.

### (Case 1)

A case of even-interval Doppler multiplexing for both PL1 polarization and PL2 polarization (provided that N_{PL1}≥2 and N_{PL2}≥2). In this case, detectable Doppler frequency range fd is within the range of −1/(2 max(N_{PL1}, N_{PL2})Tr)≤fd<1/(2 max(N_{PL1}, N_{PL2})Tr). Here, max(N_{PL1}, N_{PL2}) is a function that returns the larger value of N_{PL1} and N_{PL2} (when N_{PL1} and N_{PL2} are equal to each other, either value may be output).

### (Case 2)

A case of uneven interval Doppler multiplexing for PL1 polarization and even-interval Doppler multiplexing for PL2 polarization (provided that N_{PL1}≥2, N_{PL2}≥2). In this case, detectable Doppler frequency range fd is within the range of −1/(2 N_{PL2}Tr)≤fd<1/(2 N_{PL2}Tr).

### (Case 3)

A case of even interval Doppler multiplexing for PL1 polarization and uneven-interval Doppler multiplexing for PL2 polarization (provided that N_{PL1}≥2, N_{PL2}≥2). In this case, detectable Doppler frequency range f_{d} is in the range of −1/(2 N_{PL1}Tr)≤f_{d}<1/(2 N_{PL1} Tr).

For example, when Conditions 1 and 2 are met, detectable Doppler frequency range fd of the target object is −1/(2Tr)≤fd<1/(2Tr). On the other hand, when Condition 2 is met, detectable Doppler frequency range fd of the target object narrows, but in any of the cases 1 to 3, it is possible to expand the detectable Doppler detection range beyond the range of −1/(2Nt×Tr)≤fd<1/(2Nt×Tr) being the Doppler detection range in existing even-interval Doppler multiplexing compared to the case where both Conditions 1 and 2 are met.

Thus, by using Doppler multiplexing transmission (DDM) that meets Condition 2, the same effects as in Embodiment 1 can be obtained. For example, in a polarimetric MIMO radar using uneven-interval Doppler multiplexing, even in situations where the reflected wave reception level from a transmission antenna of one polarization is significantly attenuated compared to the reception level of the reflected wave from a transmission antenna of a different polarization, radar apparatus 10 can perform Doppler demultiplexing, thereby suppressing degradation of target object detection performance, or errors in Doppler frequency estimation or degradation of angle measurement performance.

Below, an exemplary configuration of the Doppler shift amounts in Doppler shifters 104 in Variation 2 is described.

### <Configuration Example 7 of Doppler Shift Amount>

In Configuration Example 7, the case of uneven-interval Doppler multiplexing for PL1 polarization and even-interval Doppler multiplexing for PL2 polarization is described.

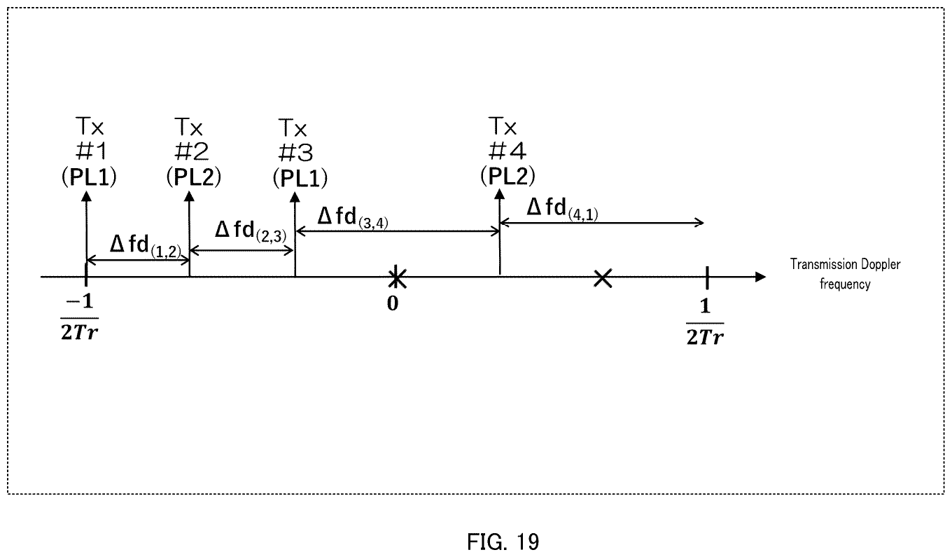

FIG. 19 shows a configuration example of the pattern of Doppler shift amounts for the transmission Doppler frequencies in the case of number Nt of transmission antennas=4, N_{PL1}=2, and N_{PL2}=2. In FIG. 19, Tx #1 and Tx #3 are PL1-polarized transmission antennas, and Tx #2 and Tx #4 are PL2-polarized transmission antennas.

In Configuration Example 7 of the Doppler shift amounts, the basic unit of the Doppler shift intervals in Doppler shifters 104 is set to Δfd=1/(Tr×(N_{DM}+δ))=1/(6Tr), and δ=2 is set, but the value of δ is not limited to this. δ can be a positive integer or a positive real number.

In the example shown in FIG. 19, first to fourth Doppler shifters 104 (or, Doppler shifters 104-1 to 104-4) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−1/(3Tr) to second transmission antenna Tx #2, second Doppler shifter 104, for example, applies phase rotation Φ₂(m)=−2π(m−1)/3 for each transmission period Tr of the chirp signal and outputs the chirp signal.

To apply Doppler shift amount DOP₃=−1/(6Tr) to third transmission antenna Tx #3, third Doppler shifter 104, for example, applies phase rotation Φ₃(m)=−π(m−1)/3 for each transmission period Tr of the chirp signal and outputs the chirp signal.

To apply Doppler shift amount DOP₄=1/(6Tr) to the fourth transmission antenna Tx #4, fourth Doppler shifter 104, for example, applies phase rotation Φ₄(m)=(m−1)/3 for each transmission period Tr of the chirp signal and outputs the chirp signal.

Hereinafter, the interval of the Doppler shift amounts applied respectively to Tx #n1 and Tx #n2 is denoted as the Doppler shift interval “Δfd_{(n1, n2)}.”

In FIG. 19, the intervals (Doppler shift intervals) of the Doppler shift amounts applied respectively to transmission antennas Tx #1 to Tx #4 are Δfd_{(1, 2)}=Δfd_{(2, 3)}=Δfd and Δfd_{(3, 4)}=Δfd_{(4, 1)}=2Δfd. Therefore, in FIG. 19, the intervals of the Doppler shift amounts applied respectively to transmission antennas, number Nt of which is 4, are not all the same but include uneven intervals (for example, Δfd_{(1, 2)}=Δfd_{(2, 3)}≠Δfd_{(3, 4)}=Δfd_{(4, 1)}), resulting in uneven interval Doppler multiplexing transmission (uneven interval DDM transmission).

Also, in FIG. 19, the intervals of the Doppler shift amounts between transmission antennas Tx #1 and Tx #3 to be PL1-polarized are Δfd_{(1, 3)}=2Δfd and Δfd_{(3, 1)}=4Δfd. Therefore, the intervals of the Doppler shift amounts applied respectively to PL1-polarized transmission antennas, number N_{PL1} of which is 2, are not all the same but include uneven intervals (Δfd_{(1, 3)} Δfd_{(3, 1)}), resulting in uneven interval Doppler multiplexing transmission (uneven interval DDM transmission) by PL1-polarized transmission antennas.

Further, in FIG. 19, the intervals (Doppler shift intervals) of the Doppler shift amount between transmission antennas Tx #2 and Tx #4 of PL2 polarization are Δfd_{(2, 4)}=3Δfd and Δfd_{(4, 2)}=3Δfd. Therefore, the intervals of the Doppler shift amounts applied to PL2-polarized transmission antennas, number N_{PL2} of which PL2-polarized transmission antennas is 2, are all the same (Δfd_{(2, 4)}=Δfd_{(4, 2)}), resulting in even-interval Doppler multiplexing transmission (even-interval DDM transmission) by PL2-polarized transmission antennas.

Thus, the example shown in FIG. 19 is a configuration example of a pattern of Doppler shift amounts that does not meet Condition 1.

Also, in FIG. 19, the intervals of the Doppler shift amounts between PL1-polarized transmission antennas Tx #1 and Tx #3 are Δfd_{(1, 3)}=2Δfd and Δfd_{(3, 1)}=4Δfd, and the interval of the Doppler shift amount between PL2-polarized transmission antennas Tx #2 and Tx #4 is Δfd_{(2, 4)}=Δfd_{(4, 2)}=3Δfd. Therefore, the Doppler shift amounts between PL1-polarized transmission antennas Tx #1 and Tx #3, and the Doppler shift amounts between PL2-polarized transmission antennas Tx #2 and Tx #4, include different Doppler shift intervals.

For example, the Doppler shift amounts between PL1-polarized transmission antennas Tx #1 and Tx #3 includes intervals of 2Δfd and 4Δfd, but the intervals of the Doppler shift amounts between PL2-polarized transmission antennas Tx #2 and Tx #4 do not include 2Δfd and 4Δfd.

Additionally, for example, the maximum DDM interval of the Doppler shift amounts between PL2-polarized transmission antennas Tx #2 and Tx #4 is 3Δfd, but the interval of the Doppler shift amounts between PL1-polarized transmission antennas Tx #1 and Tx #3 does not include 3Δfd.

Thus, in the example shown in FIG. 19, the pattern of Doppler shift amounts assigned to the PL1-polarized transmission antennas differs from the pattern of Doppler shift amounts assigned to the PL2-polarized transmission antennas.

Therefore, the example shown in FIG. 19 is a configuration example of a pattern of Doppler shift amounts that satisfies Condition 2(1).

For instance, when no target-object reflected waves cross-polarized with respect to the polarization of the reception antenna are included, radar apparatus 10 receives the reception signals corresponding to both the PL1-polarized transmission antennas (Tx #1 and Tx #3) and the PL2-polarized transmission antennas (Tx #2 and Tx #4) at almost the same level. Here, the signals transmitted from Nt transmission antennas Tx #1 to Tx #4, which include PL1-polarized transmission antennas and PL2-polarized transmission antennas, are transmitted in a Doppler multiplexing manner using Doppler shift intervals that result in uneven interval Doppler multiplexing. Therefore, radar apparatus 10 (for example, Doppler demultiplexer 211) can separate Doppler multiplexed signals based on the existing separation operation of Doppler multiplexed signals.

Through the operation of such Doppler demultiplexer 211, radar apparatus 10 can determine Doppler frequency fd of the target object within the range of −1/(2Tr)≤fd<1/(2Tr) and obtain outputs in which the transmission antennas are associated with respective Doppler multiplexed signals.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Condition 2(1)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the interval of peaks), whether a decrease in the reception level of the reception signal corresponding to the PL1-polarized transmission antenna has occurred, or whether a decrease in the reception level of the reception signal corresponding to the PL2-polarized transmission antenna has occurred, in Doppler demultiplexer 211.

For example, the PL1-polarized Doppler multiplexed signal is transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to the transmission signal by the PL1-polarized transmission antenna, radar apparatus 10 can determine Doppler frequency fd of the target object within the range of −1/(2Tr)≤fd<1/(2Tr) using the existing operation of separating Doppler multiplexed signals, making it possible to separate the Doppler multiplexed signals and obtain outputs in which the transmission antennas are associated respectively with the Doppler multiplexed signals.

Moreover, for example, the PL2-polarized Doppler multiplexed signals are transmitted in a Doppler multiplexing manner using Doppler shift intervals that result in even-interval Doppler multiplexing. Therefore, for example, when the discrimination result by Doppler demultiplexer 211 indicates that the reception signal is discriminated as corresponding to the transmission signal by the PL2-polarized transmission antenna, radar apparatus 10 can determine Doppler frequency fd of the target object within the range of −1/(4Tr)≤fd<1/(4Tr), and obtain outputs in which the transmission antennas are associated respectively with the Doppler multiplexed signals.

Through such operation of Doppler demultiplexer 211, radar apparatus 10 can determine Doppler frequency fd of the target object and obtain outputs in which the transmission antennas are associated respectively with the Doppler multiplexed signals.

### <Configuration Example 8 of Doppler Shift Amount>

Example 8 is described in relation to the case of even-interval Doppler multiplexing for PL1 polarization and uneven-interval Doppler multiplexing for PL2 polarization.

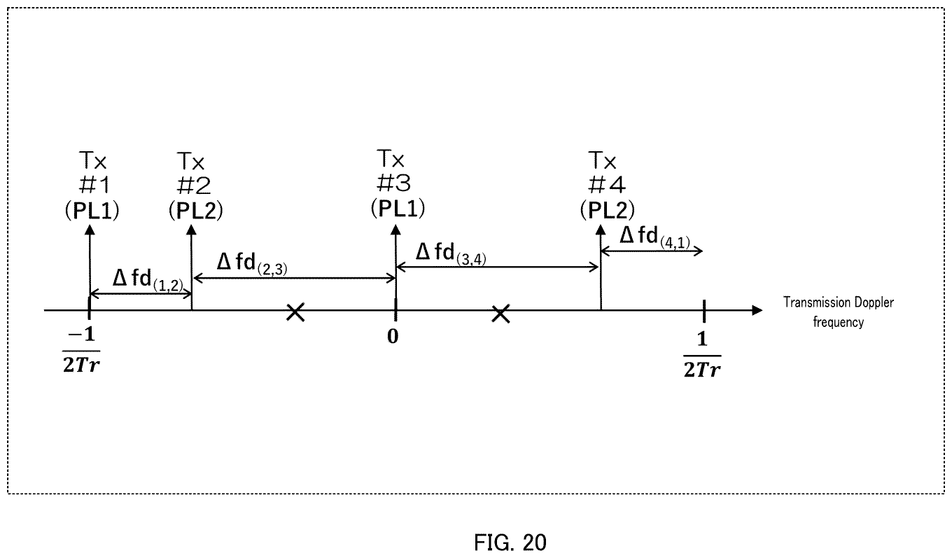

FIG. 20 shows a configuration example of a pattern of Doppler shift amounts for the transmission Doppler frequencies in the case of Nt=4 transmission antennas, N_{PL1}=2, and N_{PL2}=2. In FIG. 20, Tx #1 and Tx #3 are PL1-polarized transmission antennas, and Tx #2 and Tx #4 are PL2-polarized transmission antennas.

In Configuration Example 8 of the Doppler shift amounts, the basic unit of the Doppler shift intervals in Doppler shifters 104 is set to Δfd=1/(Tr×(N_{DM}+δ))=1/(6Tr), and δ is set to 2, but the value of δ is not limited to this. δ can be a positive integer or a positive real number.

In the example shown in FIG. 20, first to fourth Doppler shifters 104 (or, Doppler shifters 104-1 to 104-4) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−1/(3Tr) to second transmission antenna Tx #2, second Doppler shifter 104, for example, applies phase rotation Φ₂(m)=−2π(m−1)/3 for each transmission period Tr of the chirp signal and outputs the chirp signal.

To apply Doppler shift amount DOP₃=0 to third transmission antenna Tx #3, third Doppler shifter 104, for example, applies phase rotation Φ₃(m)=0 for each transmission period Tr of the chirp signal and outputs the chirp signal.

To apply Doppler shift amount DOP₄=1/(3Tr) to the fourth transmission antenna Tx #4, fourth Doppler shifter 104, for example, applies phase rotation Φ₄(m)=2π(m−1)/3 for each transmission period Tr of the chirp signal and outputs the chirp signal.

Hereinafter, the interval of the Doppler shift amounts applied respectively to Tx #n1 and Tx #n2 is denoted as the Doppler shift interval “Δfd_{(n1, n2)}.”

In FIG. 20, the intervals of the Doppler shift amounts (Doppler shift intervals) applied respectively to transmission antennas Tx #1 to Tx #4 is Δfd_{(1, 2)}=Δfd_{(4, 1)}=Δfd and Δfd_{(2, 3)}=Δfd_{(3, 4)}=2Δfd. Therefore, in FIG. 20, the intervals of the Doppler shift amounts applied respectively to transmission antennas, number Nt of which antennas is 4, are not all the same but include uneven intervals (for example, Δfd_{(1, 2)}=Δfd_{(4, 1)}≠Δfd_{(2, 3)}=Δfd_{(3, 4)}), resulting in uneven interval Doppler multiplexing transmission (uneven interval DDM transmission).

Further, in FIG. 20, among the transmission antennas, the intervals of the Doppler shift amounts (Doppler shift intervals) between transmission antennas Tx #1 and Tx #3, which are to be PL1-polarized, are Δfd_{(1, 3)}=3Δfd and Δfd_{(3, 1)}=3Δfd. Therefore, since the intervals of the Doppler shift amounts applied respectively to PL1-polarized transmission antennas, number N_{PL1} of which PL1-polarized transmission antennas is 2, are the same (Δfd_{(1, 3)}=Δfd_{(3, 1)}), resulting in even-interval Doppler multiplexing transmission (even-interval DDM transmission) by PL1-polarized transmission antennas.

Additionally, in FIG. 20, among the transmission antennas, the intervals of the Doppler shift amounts (Doppler shift intervals) between transmission antennas Tx #2 and Tx #4, which are PL2-polarized, are Δfd_{(2, 4)}=4Δfd and Δfd_{(4, 2)}=2Δfd. Therefore, since the intervals of the Doppler shift amounts applied to PL2-polarized transmission antennas, number N_{PL2} of which PL2-polarized transmission antennas is 2, are not all the same but include uneven intervals (Δfd_{(2, 4)}≠Δfd_{(4, 2)}), resulting in uneven interval Doppler multiplexing transmission (uneven interval DDM transmission) by PL2-polarized transmission antennas.

From the above, the example shown in FIG. 20 is a configuration example of a pattern of Doppler shift amounts that does not meet Condition 1.

Also, in FIG. 20, the interval of the Doppler shift amounts between PL1-polarized transmission antennas Tx #1 and Tx #3 is Δfd_{(1, 3)}=Δfd_{(3, 1)}=3Δfd, and the intervals of the Doppler shift amount between PL2-polarized transmission antennas Tx #2 and Tx #4 are Δfd_{(2, 4)}=4Δfd and Δfd_{(4, 2)}=2Δfd. Therefore, the Doppler shift amounts between PL1-polarized transmission antennas Tx #1 and Tx #3, and between PL2-polarized transmission antennas Tx #2 and Tx #4, include different Doppler shift intervals.

For example, the interval of the Doppler shift amounts between PL1-polarized transmission antennas Tx #1 and Tx #3 includes 3Δfd, but the intervals of the Doppler shift amount between PL2-polarized transmission antennas Tx #2 and Tx #4 do not include 3Δfd.

For example, the maximum DDM interval of the Doppler shift amounts between PL2-polarized transmission antennas Tx #2 and Tx #4 includes 2Δfd and 4Δfd, but the interval of the Doppler shift amounts between PL1-polarized transmission antennas Tx #1 and Tx #3 does not include 2Δfd and 4Δfd.

Thus, in the example shown in FIG. 20, the pattern of the Doppler shift amounts assigned to the PL1-polarized transmission antennas differs from the pattern of the Doppler shift amounts assigned to the PL2-polarized transmission antennas.

Therefore, the example shown in FIG. 20 is a configuration example of the pattern of the Doppler shift amounts that satisfies Condition 2(1).

For instance, when no target-object reflected waves that are cross-polarized with respect to the polarization of the reception antenna are included, radar apparatus 10 receives the corresponding reception signals from both the PL1-polarized transmission antennas (Tx #1 and Tx #3) and the PL2-polarized transmission antennas (Tx #2 and Tx #4) at almost the same level. Here, the signals transmitted from Nt transmission antennas Tx #1 to Tx #4, composed of PL1-polarized transmission antennas and PL2-polarized transmission antennas, are transmitted by Doppler multiplexing using Doppler shift intervals that result in uneven interval Doppler multiplexing. Therefore, radar apparatus 10 (for example, Doppler demultiplexer 211) can separate Doppler multiplexed signals based on the existing separation operation of Doppler multiplexed signals.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Condition 2(1)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the interval of peaks), whether a decrease in the reception level of the reception signal corresponding to the PL1-polarized transmission antenna has occurred, or whether a decrease in the reception level of the reception signal corresponding to the PL2-polarized transmission antenna has occurred, in Doppler demultiplexer 211.

For example, the PL1-polarized Doppler multiplexed signals are transmitted in a Doppler multiplexing manner using Doppler shift intervals that result in even-interval Doppler multiplexing. Therefore, for example, when the discrimination result by Doppler demultiplexer 211 indicates that the reception signal is discriminated as corresponding to the transmission signal by the PL1-polarized transmission antenna, radar apparatus 10 can determine Doppler frequency fd of the target object within the range of −1/(4Tr)≤fd<1/(4Tr), and obtain outputs in which the transmission antennas are associated respectively with the Doppler multiplexed signals.

For example, the PL2-polarized Doppler multiplexed signal is transmitted in a Doppler multiplexing manner using Doppler shift intervals that result in uneven interval Doppler multiplexing. Therefore, for example, when the discrimination result by Doppler demultiplexer 211 indicates that the reception signal is discriminated as corresponding to the transmission signal by the PL2-polarized transmission antenna, radar apparatus 10 can determine Doppler frequency fd of the target object within the range of −1/(2Tr)≤fd<1/(2Tr) using the existing operation of separating Doppler multiplexed signals, making it possible to separate the Doppler multiplexed signals and obtain outputs in which the transmission antennas are associated respectively with the Doppler multiplexed signals.

### Variation 3 of Embodiment 1

Regarding the transmission polarizations of different polarizations, Embodiment 1 is described in relation to the example of two polarizations, PL1 polarization and PL2 polarization, which are in orthogonal polarization relationship, but the present disclosure is not limited to this, and the number of polarizations may be three or more. For example, in addition to the two polarizations, PL1 polarization and PL2 polarization, which are in orthogonal polarization relationship, a transmission antenna of another polarization different from PL1 polarization and PL2 polarization may be used.

For example, radar apparatus 10 (e.g., polarimetric MIMO radar) may use Nt transmission antennas that include transmission antennas of three or more different polarizations, including two polarizations that are in orthogonal polarization relationship.

Hereinafter, the first polarization is described as PL1 polarization, and the second polarization is described as PL2 polarization. The qth polarization is described as PLq polarization. Also, combinations of different polarizations that are in orthogonal polarization relationship may include, for example, PL1 polarization and PL2 polarization, right-handed circular polarization and left-handed circular polarization, horizontal polarization and vertical polarization, and right diagonal 45° polarization and left diagonal 45° polarization.

Further, number Nt of transmission antennas is set to be 4 or more. For example, number N_{DDM} of Doppler multiplexing is set to be 4 or more.

Further, the transmission antennas include N_{PL1} PL1-polarized antennas and N_{PL2} PL2-polarized antennas. In this case, N_{PL1}+N_{PL2}<Nt.

Radar apparatus 10, for example, performs uneven interval Doppler multiplexing transmission using Nt transmission antennas.

Further, radar apparatus 10 performs simultaneous multiplexing transmission from Nt transmission antennas using Doppler multiplexing transmission (DDM) that satisfies Conditions 1a and 2a to be described later, for Nt transmission antennas that include transmission antennas of PL1 polarization and PL2 polarization, which are cross-polarized to each other, and a transmission antenna of another polarization different from PL1 polarization and PL2 polarization.

Conditions 1a and 2a are, for example, conditions in the case of including a transmission antenna of another polarization different from PL1 polarization and PL2 polarization, in addition to the two polarizations, PL1 polarization and PL2 polarization, which are in orthogonal polarization relationship. For example, when there is no transmission antenna of another different polarization besides the transmission antennas of the two polarizations, PL1 polarization and PL2 polarization, which are in orthogonal polarization relationship, Conditions 1a and 2a become equivalent to Conditions 1 and 2.

For example, the reflected waves corresponding to the radar transmission signals from the transmission antennas of PL1 polarization and PL2 polarization, which are in orthogonal polarization relationship, become cross-polarized with respect to reception antenna section 202, which may result in cases where the reception levels of the reception signals significantly differ. On the other hand, among the Nt transmission antennas, the transmission antennas of a different polarization other than PL1-polarized and PL2-polarized antennas do not become orthogonal polarization relationship with PL1 polarization and PL2 polarization. Therefore, the reflected waves corresponding to the radar transmission signals from the transmission antennas of other polarizations are less likely to significantly differ in reception level of the reception signals from the reception level of the reception signals corresponding to the transmission antennas of PL1 polarization and PL2 polarization.

Therefore, for example, the condition “uneven interval Doppler multiplexing by transmission antennas of a polarization excluding PL2 polarization (the condition is considered when N_{PL1}≥2, and does not need to be considered when N_{PL1}=1)” may be applied for Condition 1a instead of “uneven interval Doppler multiplexing by PL1-polarized antenna” of Condition 1. Similarly, for Condition 1a, instead of “uneven-interval Doppler multiplexing by the PL2-polarized antenna” in Condition 1, the condition “uneven-interval Doppler multiplexing by polarized transmission antennas excluding the PL1 polarization (the condition is considered when N_{PL1}≥2 and does not need to be considered when N_{PL2}=1)” may be applied.

Further, for example, in Condition 2a, instead of “among the Doppler multiplexed signals assigned to the PL1-polarized transmission antennas and PL2-polarized transmission antennas” in Condition 2, the condition “among Doppler multiplexed signals assigned to the polarized transmission antennas excluding the PL2-polarized antenna (for example, (Nt−N_{PL1}) transmission antennas), and the polarized transmission antennas excluding the PL1-polarized antenna (for example, (Nt−N_{PL2}) transmission antennas)” may be applied.

Therefore, Conditions 1a and 2a may be defined as follows.

<Condition 1a>

Doppler multiplexed signals are assigned to the PL1 and PL2 polarizations such that:
Uneven-interval DDM by transmission antennas of a polarization excluding the PL2 polarization (the condition is considered when N_{PL1}≥2, and does not need to be considered when N_{PL1}=1); and
Uneven-interval DDM by transmission antennas of a polarization excluding the PL1 polarization (the condition is considered when N_{PL2}≥2 and does not need to be considered when N_{PL2}=1)).
   <Condition 2a>

Among Doppler multiplexed signals assigned to transmission antennas of a polarization excluding the PL2 polarization (for example, (Nt−N_{PL2}) transmission antennas) and the transmission antennas of a polarization excluding the PL1 polarization (for example, (Nt−N_{PL1}) transmission antennas), one of the following conditions is met:
(1) Different Doppler shift intervals are included;
(2) The number of Doppler multiplexing (=number of transmission antennas) differs between the PL1 polarization and the PL2 polarization (N_{PL1}≠N_{PL2}); and
(3) When Nt−N_{PL1}≥3 and Nt−N_{PL2}≥3 and when the same Doppler shift interval is included in Doppler shift intervals assigned respectively to a transmission antenna of a polarization excluding the PL2 polarization and a transmission antenna of a polarization excluding the PL1 polarization, the orders of the Doppler shift intervals differ for each polarization.

For example, under Condition 1a, each interval of the Doppler shift amount assigned to a polarized transmission antenna different from the PL2 polarization is configured as an uneven interval on the Doppler frequency axis. Similarly, under Condition 1a, each interval of the Doppler shift amount assigned to a polarized transmission antenna different from the PL1 polarization is configured as an uneven interval on the Doppler frequency axis.

Further, for example, under Condition 2a(1), the intervals of the Doppler shift amounts (Doppler shift intervals) assigned to the polarized transmission antenna different from the PL2 polarization may include intervals different from intervals of the Doppler shift amounts assigned to the polarized transmission antenna different from the PL1 polarization. Examples of Condition 2a(1) include a case where the maximum Doppler shift intervals differ from each other, a case where the minimum Doppler shift intervals differ from each other, or a case where the Doppler shift intervals that are neither the maximum nor the minimum differ from each other, among the Doppler multiplexed signals assigned to the transmission antenna of a polarization excluding the PL2 polarization and the transmission antenna of a polarization excluding the PL1 polarization.

Further, examples of Condition 2a(2) include a case where the number of either the PL1-polarized transmission antennas or the PL2-polarized transmission antennas is one, forming a Single-Input Multiple Output (SIMO) radar configuration (a case where N_{PL1}=1 and N_{PL2}≥2, and a case where N_{PL1}≥2 and N_{PL2}=1), and a case where both the PL1 and PL2-polarized transmission antennas are more than two, forming a MIMO radar configuration with the polarized transmission antennas (when N_{PL1}≥2, N_{PL2}≥2, and N_{PL1}≠N_{PL2}).

For example, under Condition 2a(3), a combination of the intervals of the Doppler shift amounts assigned to the polarized transmission antenna different from the PL2 polarization is the same as a combination of the intervals of the Doppler shift amounts assigned to the polarized transmission antenna different from the PL1 polarization, but the order of the intervals of the Doppler shift amounts assigned to the polarized transmission antenna different from the PL2 polarization differs from the order of the intervals of the Doppler shift amounts assigned to the polarized transmission antenna different from the PL1 polarization within the Doppler frequency range.

For instance, the combinations of intervals included in an arrangement (for example, a first arrangement) of the intervals of the Doppler shift amounts assigned to transmission antennas of a polarization excluding the PL1 polarization in ascending order on the Doppler frequency axis match the combinations of intervals included in an arrangement (for example, a second arrangement) of the intervals of the Doppler shift amounts assigned to transmission antennas of a polarization excluding the PL2 polarization in ascending order on the Doppler frequency axis, and the first and second arrangements differ from each other in their circular permutations.

When Condition 2a(3) is met, the Doppler shift intervals of the transmission antennas of a polarization excluding the PL2 polarization and the Doppler shift intervals of the transmission antennas of a polarization excluding the PL1 polarization do not match, even when either one is cyclically shifted in the Doppler frequency domain.

Below, configuration examples of the Doppler shift amounts in Doppler shifters 104 are described.

### <Configuration Example 9 of Doppler Shift Amount>

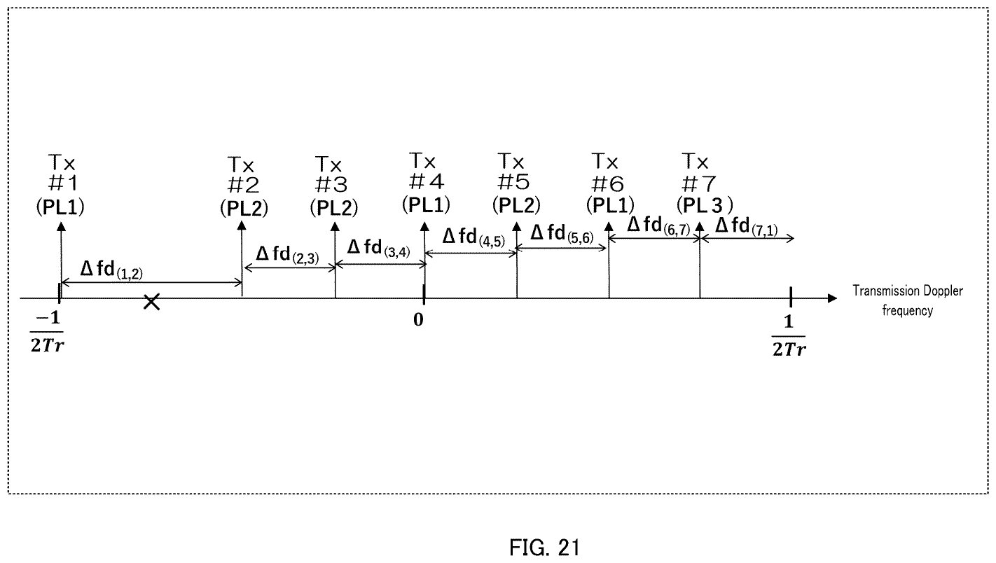

FIG. 21 shows a configuration example of the pattern of Doppler shift amounts for the transmission Doppler frequency in the case of number Nt of transmission antennas=7, N_{PL1}=3, N_{PL2}=3, and N_{PL3}=1. In FIG. 21, Tx #1, Tx #4, and Tx #6 are PL1-polarized antennas, Tx #2, Tx #3, and Tx #5 are PL2-polarized antennas, and Tx #3 is a PL3-polarized antenna. For example, the PL1 and PL2 polarizations are considered to be orthogonal polarizations to each other.

In Configuration Example 9 of the Doppler shift amount, as shown in FIG. 21, the basic unit of the Doppler shift intervals in Doppler shifters 104 is set to Δfd=1/(Tr×(N_{DM}+δ))=1/(8Tr), and δ=1 is set, but the value of δ is not limited to this. δ can be a positive integer or a positive real number.

In the example shown in FIG. 21, first to seventh Doppler shifters 104 (or, Doppler shifters 104-1 to 104-7) may perform the following operations.

To apply Doppler shift amount DOP₁=−1/(2Tr) to first transmission antenna Tx #1, first Doppler shifter 104, for example, applies phase rotation Φ₁(m)=−π(m−1) every transmission period Tr of the chirp signal and outputs the chirp signal.

To apply Doppler shift amount DOP₂=−1/(4Tr) to second transmission antenna Tx #2, second Doppler shifter 104, for example, applies phase rotation Φ₂(m)=−π(m−1)/2 every transmission period Tr of the chirp signal and outputs the chirp signal.

To apply Doppler shift amount DOP₃=−1/(8Tr) to third transmission antenna Tx #3, third Doppler shifter 104, for example, applies phase rotation Φ₃(m)=−π(m−1)/4 every transmission period Tr of the chirp signal and outputs the chirp signal.

To apply Doppler shift amount DOP₄=0 to the fourth transmission antenna Tx #4, fourth Doppler shifter 104, for example, applies phase rotation Φ₄(m)=0 every transmission period Tr of the chirp signal and outputs the chirp signal.

To apply Doppler shift amount DOP₅=1/(8Tr) to the fifth transmission antenna Tx #5, fifth Doppler shifter 104, for example, applies phase rotation Φ₅(m)=π(m−1)/4 every transmission period Tr of the chirp signal and outputs the chirp signal.

To apply Doppler shift amount DOP₆=1/(4Tr) to the sixth transmission antenna Tx #6, sixth Doppler shifter 104, for example, applies phase rotation Φ₆(m)=R(m−1)/2 every transmission period Tr of the chirp signal and outputs the chirp signal.

To apply Doppler shift amount DOP7=3/(8Tr) to the seventh transmission antenna Tx #7, seventh Doppler shifter 104, for example, applies phase rotation Φ₇(m)=3π(m−1)/4 every transmission period Tr of the chirp signal and outputs the chirp signal.

Hereinafter, the interval of the Doppler shift amounts applied to Tx #n1 and Tx #n2 is denoted as the Doppler shift interval “Δfd_{(n1, n2)}.”

In FIG. 21, the intervals of the Doppler shift amounts (Doppler shift intervals) applied respectively to transmission antennas Tx #1 to Tx #7 are Δfd_{(1, 2)}=2Δfd and Δfd_{(2, 3)}=Δfd_{(3, 4)}=Δfd_{(4, 5)}=Δfd_{(5, 6)}=Δfd_{(6, 7)}=Δfd_{(7, 1)}=Δfd. Therefore, in FIG. 21, the intervals of the Doppler shift amounts applied respectively to the transmission antennas, number Nt of which is 7, are not all the same, but include uneven intervals (for example, Δfd_{(2, 3)}=Δfd_{(3, 4)}=Δfd_{(4, 5)}=Δfd_{(5, 6)}=Δfd_{(6, 7)}=Δfd_{(7, 1)} Δfd_{(1, 2)}), resulting in uneven interval Doppler multiplexing transmission (uneven interval DDM transmission).

Further, in FIG. 21, the intervals of the Doppler shift amounts between transmission antennas Tx #1, Tx #4, Tx #6, and Tx #7, excluding the PL2-polarized transmission antenna, are Δfd_{(1, 4)}=4Δfd, Δfd_{(4, 6)}=2Δfd, and Δfd_{(6, 7)}=Δfd_{(7, 1)}=Δfd. Therefore, the intervals of the Doppler shift amounts assigned respectively to polarized transmission antennas, which exclude the PL2-polarized transmission antenna and number (Nt−N_{PL2}) of which transmission antennas is 4, are not all the same but include uneven intervals (Δfd_{(1, 4)}≠Δfd_{(4, 6)} Δfd_{(6, 7)}=Δfd_{(7, 1)}), resulting in uneven interval Doppler multiplexing transmission (uneven interval DDM transmission) by the transmission antennas of a polarization excluding the PL2-polarized transmission antenna.

Further, in FIG. 21, among the transmission antennas, the intervals of the Doppler shift amounts (Doppler shift intervals) between transmission antennas Tx #2, Tx #3, Tx #5, and Tx #7, excluding the PL1-polarized transmission antenna, are Δfd_{(2, 3)}=Δfd, Δfd_{(3, 5)}=Δfd_{(5, 7)}=2Δfd and Δfd_{(7, 2)}=3Δfd. Therefore, the intervals of the Doppler shift amounts assigned respectively to polarized transmission antennas, which exclude the PL1-polarized transmission antenna and number (Nt−N_{PL1}) of which transmission antennas is 4, are not all the same but include uneven intervals (Δfd_{(2, 3)}≠Δfd_{(3, 5)}=Δfd_{(5, 7)}≠Δfd_{(7, 2)}), resulting in uneven interval Doppler multiplexing transmission (uneven interval DDM transmission) by the transmission antennas of a polarization excluding the PL1-polarized transmission antenna.

Thus, the example shown in FIG. 21 is a configuration example of a pattern of Doppler shift amounts that satisfies Condition 1a.

Also, in FIG. 21, the Doppler shift amounts between transmission antennas Tx #1, Tx #4, Tx #6, and Tx #7, excluding the PL2-polarized transmission antenna, are Δfd_{(1, 4)}=4Δfd, Δfd_{(4, 5)}=2Δfd and Δfd_{(6, 7)}=Δfd_{(7, 1)}=Δfd, and the Doppler shift amounts between transmission antennas Tx #2, Tx #3, Tx #5, and Tx #7, excluding the PL1-polarized transmission antenna, are Δfd_{(2, 3)}=Δfd, Δfd_{(3, 5)}=Δfd_{(5, 7)}=2Δfd and Δfd_{(7, 2)}=3Δfd. Therefore, the Doppler shift amounts between transmission antennas Tx #1, Tx #4, Tx #6, and Tx #7, excluding the PL2-polarized transmission antenna, and between transmission antennas Tx #2, Tx #3, Tx #5, and Tx #7, excluding the PL1-polarized transmission antenna, include different Doppler shift intervals.

For example, the intervals of the Doppler shift amounts between transmission antennas Tx #1, Tx #4, Tx #6, and Tx #7, excluding the PL2-polarized transmission antenna, include 4Δfd, but the intervals of the Doppler shift amounts between transmission antennas Tx #2, Tx #3, Tx #5, and Tx #7, excluding the PL1-polarized transmission antenna, do not include 4Δfd.

Further, for example, the maximum DDM interval of the Doppler shift amounts between transmission antennas Tx #2, Tx #3, Tx #5, and Tx #7, excluding the PL1-polarized transmission antenna, is 3Δfd, but the intervals of the Doppler shift amounts between transmission antennas Tx #1, Tx #4, Tx #6, and Tx #7, excluding the PL2-polarized transmission antenna, do not include 3Δfd.

Thus, the example shown in FIG. 21 is a configuration example of a pattern of Doppler shift amounts that satisfies Condition 2a(1).

For instance, when no target-object reflected waves that are cross-polarized with respect to the polarization of the reception antenna are included, radar apparatus 10 receives the corresponding reception signals respectively from the PL1-polarized transmission antennas (Tx #1, Tx #4, and Tx #6) and the PL2-polarized transmission antennas (Tx #2, Tx #3, and Tx #5) at almost the same level. Here, the signals transmitted from Nt transmission antennas Tx #1 to Tx #7, composed of PL1-polarized transmission antennas, PL2-polarized transmission antennas, and PL3-polarized transmission antennas are transmitted by Doppler multiplexing using Doppler shift intervals that result in uneven interval Doppler multiplexing. Therefore, radar apparatus 10 can separate Doppler multiplexed signals based on the existing separation operation of Doppler multiplexed signals.

In cases where the target-object reflected waves that are cross-polarized with respect to the polarization of the reception antenna are included, radar apparatus 10 receives Doppler multiplexed signals different between the case where the target-object reflected waves in which PL1 polarization is cross-polarized are included and the case where the target-object reflected waves in which PL2 polarization is cross-polarized are included (for example, Doppler multiplexed signals that satisfy Condition 2a(1)).

For example, when a target-object reflected wave that is cross-polarized with respect to the polarization of the reception antenna, radar apparatus 10 receives reflected wave signals containing patterns of Doppler frequency components different between a case where the reception level of the reception signal corresponding to the PL1-polarized transmission antenna decreases, and a case where the reception level of the reception signal corresponding to the PL2-polarized transmission antenna decreases.

As a result, radar apparatus 10 becomes capable of determining, for example, based on the detected peaks of the Doppler frequency (for example, the interval of peaks), whether a decrease in the reception level of the reception signal corresponding to the PL1-polarized transmission antenna has occurred, or whether a decrease in the reception level of the reception signal corresponding to the PL2-polarized transmission antenna has occurred, in Doppler demultiplexer 211.

For example, Doppler multiplexed signals of a polarization excluding PL2 polarization are transmitted in a Doppler multiplexing manner using Doppler shift intervals that result in uneven interval Doppler multiplexing. Therefore, for example, when the discrimination result by Doppler demultiplexer 211 indicates that a reception signal is discriminated as corresponding to a transmission signal from polarized transmission antennas excluding the PL2-polarized transmission antenna, radar apparatus 10 can separate the Doppler multiplexed signals using the existing separation operation of Doppler multiplexed signals.

Similarly, for example, Doppler multiplexed signals of a polarization excluding PL1 polarization are transmitted in a Doppler multiplexing manner using Doppler shift intervals that result in uneven interval Doppler multiplexing. Therefore, for example, when the discrimination result by Doppler demultiplexer 211 indicates that a reception signal is discriminated as corresponding to a transmission signal from polarized transmission antennas excluding the PL1-polarized transmission antenna, radar apparatus 10 can separate the Doppler multiplexed signals using the existing separation operation of Doppler multiplexed signals.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

The exemplary configurations for Doppler shift amounts has been described above.

### [Exemplary Operation of Doppler Demultiplexer 211]

For example, when using transmission antennas not only of the two polarizations, PL1 polarization and PL2 polarization, which are orthogonal to each other, but also of another polarization different from the PL1 and PL2 polarizations, the Doppler multiplexed signals applied in aforementioned Doppler shifters 104 can be separated by the operation of Doppler demultiplexer 211 as follows. Below, the operation of Doppler demultiplexer 211 related to Variation 3, which differs from Embodiment 1, will be described.

Doppler demultiplexer 211 performs Doppler demultiplexing based on distance index f_{b_cfar}, Doppler frequency index (f_{sddm_cfar}+(ndm−1)×N_{Δfd}), and reception power information (PowerFT(f_{b_cfar}, f_{sddm_cfar}+(ndm−1)×N_{Δfd})) inputted from CFAR section 210, for example, when δ shown in Expression 3 is set to a positive integer in Doppler shifters 104. Note that ndm is an integer from 1 to N_{DM}+δ.

In Variation 3, among the separation operations of Doppler multiplexed signals in Doppler demultiplexer 211 shown in FIG. 17, the operations of Step B and Step C differ from those of Embodiment 1 as described below.

### <Step B-1>

Doppler demultiplexer 211 performs Doppler demultiplexing processing on (Nt−N_{PL2}) Doppler multiplexed signals of polarizations excluding PL2 polarization, assuming the case where a target-object reflected wave in which the PL2 polarization is cross-polarized with respect to the polarization of the reception antenna.

### <Step B-2>

In this case, it is assumed that the N_{DM}+δ Doppler frequency indices (f_{sddm_cfar}+(ndm−1)×N_{Δfd}) at distance index f_{b_cfar} input from CFAR section 210 include Nt−N_{PL2} Doppler multiplexed signals from transmission antennas excluding the PL2-polarized antenna.

Doppler demultiplexer 211, for example, compares the received power (PowerFT(f_{b_cfar}, f_{sddm_cfar}+(ndm−1)×N_{Δfd})) for Doppler frequency indices (f_{sddm_cfar}+(ndm−1)×N_{Δfd}) (for example, where ndm is an integer from 1 to N_{DM}+δ), and determines whether the top Nt−N_{PL2} Doppler frequency indices (f_{sddm_cfar}+(ndm−1)×N_{Δfd}) in terms of reception power match the Doppler shift intervals applied to the transmission antenna excluding the PL2-polarized transmission antenna at the time of transmission (for example, this may be referred to as “PL2-polarized-transmission-antenna-excluded Doppler shift interval matching determination”).

Further, Doppler demultiplexer 211, for example, determines whether there is a significant difference (or reception level ratio) in reception level between the top Nt−N_{PL2} Doppler frequency indices in terms of reception power and other (N_{DM}+δ−(Nt−N_{PL2})) Doppler frequency indices different from the top Nt−N_{PL2} Doppler frequency indices in terms of reception power (for example, whether the difference exceeds a threshold, or whether the ratio of reception levels exceeds a threshold) (referred to, for example, as “PL2-polarized-transmission-antenna-excluded Doppler multiplexed signal reception level difference determination”).

Based on these determinations, Doppler demultiplexer 211, for example, decides the Doppler frequency and the transmission antenna corresponding to the Doppler multiplexed signals within the range of −1/(2Tr)≤fd<1/(2Tr).

Note that the exemplary operation of Doppler demultiplexer 211 for separating Doppler multiplexed signals at uneven intervals is disclosed in PTL 7, for example, so the detailed description of its operation is omitted here.

For example, Doppler demultiplexer 211 determines whether both the conditions (for example, the conditions of Step B-2) of the PL2-polarized-transmission-antenna-excluded Doppler shift interval matching determination and the PL2-polarized-transmission-antenna-excluded Doppler multiplexed signal reception level difference determination are met. When the conditions of Step B-2 are met, Doppler demultiplexer 211 may proceed with the processing of Step B-3, and when the conditions of Step B-2 are not met, it may proceed with the processing of Step C-1, assuming the case where the target-object reflected wave in which the PL1 polarization is cross-polarized with respect to the polarization of the reception antenna.

### <Step B-3>

For example, based on the relationship between the N_{DM}+δ−(Nt−N_{PL2}) Doppler frequency indices for low reception levels among the Doppler frequency indices (f_{sddm_cfar}+(ndm−1)×N_{Δfd}) and the top Nt−N_{PL2} Doppler frequency indices for high reception power, Doppler demultiplexer 211 associates Doppler shift amounts DOP₁, DOP₂, . . . , DOP_{Nt} of the Nt transmitted Doppler multiplexed signals with the Doppler frequency indices, and outputs them as Doppler-multiplexed-signal separation index information DDM_RXindex PL1(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 may output the outputs of Doppler analyzers 209 corresponding to these distances and Doppler separation indices to direction estimator 212.

Alternatively, Doppler demultiplexer 211 may associate the Doppler shift amounts of the N_{PL1} Doppler multiplexed signals by which PL1 polarized waves are transmitted among the Nt transmission antennas, with the Doppler frequency indices, and output the PL1 polarization separation index information of the Doppler multiplexed signals as DDM_Rxindex__{PL1}(f_{b_cfar}) along with distance indices f_{b_cfar} to direction estimator 212.

### <Step C-1>

Assuming the case where a target-object reflected wave in which PL1 is cross-polarized with respect to the polarization of the reception antenna is included, Doppler demultiplexer 211 performs Doppler demultiplexing processing on the Doppler multiplexed signals of the polarizations excluding the Nt−N_{PL1} PL1 polarizations.

### <Step C-2>

In this case, for example, it is assumed that the N_{DM}+δ Doppler frequency indices (f_{sddm_cfar}+(ndm−1)×N_{Δfd}) for distance index f_{b_cfar} input from CFAR section 210 include the Nt−N_{PL1} Doppler multiplexed signals from the transmission antennas excluding the PL1-polarized transmission antenna.

Doppler demultiplexer 211, for example, compares the reception power (PowerFT(f_{b_cfar}, f_{sddm_cfar}+(ndm−1)×N_{Δfd})) for Doppler frequency index (f_{sddm_cfar}+(ndm−1)×N_{Δfd}) (for example, where ndm is an integer from 1 to N_{DM}+δ), and determines whether the top Nt−N_{PL1} Doppler frequency indices (f_{sddm_cfar}+(ndm−1)×N_{Δfd}) in terms of reception power match the Doppler shift intervals assigned to the transmission antennas excluding the PL1-polarized transmission antenna at the time of transmission (for example, this is called “PL1-polarized-transmission-antenna-excluded Doppler shift interval matching determination”).

Further, Doppler demultiplexer 211, for example, determines whether there is a significant difference (or reception level ratio) in the reception level between the top Nt−N_{PL1} Doppler frequency indices in terms of reception power and other (N_{DM}+δ−(Nt−N_{PL1})) Doppler frequency indices than the top Nt−N_{PL1} Doppler frequency indices in terms of reception power (for example, whether the difference exceeds a threshold, or whether the ratio of reception levels exceeds a threshold), which is referred to as “PL1-polarized-transmission-antenna-excluded Doppler multiplexed signal reception level difference determination.”

Based on these determinations, Doppler demultiplexer 211, for example, decides the Doppler frequency and transmission antenna within the range of −1/(2Tr)≤fd<1/(2Tr).

Note that the exemplary operation of Doppler demultiplexer 211 for separating Doppler multiplexed signals at uneven intervals is disclosed in PTL 7, for example, so the detailed description of its operation is omitted here.

Doppler demultiplexer 211 determines whether both the conditions (for example, the conditions of Step C-2) of the PL1-polarized-transmission-antenna-excluded Doppler shift interval matching determination and the PL1-polarized-transmission-antenna-excluded Doppler multiplexed signal reception level difference determination are met. When the conditions of Step C-2 are met, Doppler demultiplexer 211 may proceed with the processing of Step C-3. In addition, when the conditions of Step C-2 are not met, Doppler demultiplexer 211 may determine that the reception signal is a noise component or an interference component and does not need to perform the output to direction estimator 212 (Step D).

### <Step C-3>

For example, based on the relationship between the N_{DM}+δ−(Nt−N_{PL1}) Doppler frequency indices for low reception levels among the Doppler frequency indices (f_{sddm_cfar}+(ndm−1)×N_{Δfd}) and the top Nt−N_{PL1} Doppler frequency indices for high reception power, Doppler demultiplexer 211 associates Doppler shift amounts DOP₁, DOP₂, . . . , DOP_{Nt} of the Nt transmitted Doppler multiplexed signals with the Doppler frequency indices, and outputs them as Doppler-multiplexed-signal separation index information DDM_RXindex PL2(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 may output the outputs of Doppler analyzers corresponding to these distances and Doppler separation indices to direction estimator 212.

Alternatively, Doppler demultiplexer 211 may associate the Doppler shift amounts of the N_{PL2} Doppler multiplexed signals by which PL2 polarized waves are transmitted among the Nt transmission antennas, with the Doppler frequency indices, and output the PL2 polarization separation index information of the Doppler multiplexed signals as DDM_Rxindex__{PL2}(f_{b_cfar}) along with distance indices f_{b_cfar} to direction estimator 212.

The above describes an exemplary operation of Doppler demultiplexer 211.

### Embodiment 2

Embodiment 1 is described in relation to the case where, in a polarimetric MIMO radar using Nt transmission antennas including antennas of different polarizations, radar apparatus 10 performs simultaneous multiplexing transmission using all the Nt transmission antennas with uneven interval Doppler multiplexing transmission, and Doppler shifters 104 transmit Doppler multiplexed signals that meet at least Condition 2 (“Condition 1 and Condition 2,” or, “Condition 2”). Thus, in Embodiment 1, even when the reception levels of reflected waves differ significantly between transmission polarization antennas, Doppler demultiplexer 211 can distinguish the transmission polarization antennas, enabling the separation of Doppler multiplexed signals, thereby suppressing degradation of detection performance of the polarimetric MIMO radar using uneven interval Doppler multiplexing transmission.

Thus, the method that enables the discrimination of transmission polarization antennas and the separation of Doppler multiplexed signals in Doppler demultiplexer 211, even when the reception levels of reflected waves differ significantly between transmission polarization antennas, is not limited to the method described in Embodiment 1.

In the present embodiment, a method is described for performing, using a plurality of antennas of the same polarization, uneven interval Doppler multiplexing transmission on transmission signals transmitted from transmission antennas of different polarizations at transmission periods offset from one another.

For example, in the present embodiment, the timing of the transmission signal from the PL1-polarized transmission antenna may differ from the timing of the transmission signal from the PL2-polarized transmission antenna.

With such a method, even when the reception levels of reflected waves differ significantly between transmission polarization antennas, it is possible for the radar apparatus to distinguish the transmission polarization antennas since the polarization of the transmission antenna for each transmission period is known. Therefore, the reception levels of reflected waves from a plurality of transmission antennas of the same polarization are less likely to differ significantly, enabling Doppler separation with uneven interval Doppler multiplexing transmission, and suppressing degradation of detection performance of the polarimetric MIMO radar using uneven interval Doppler multiplexing transmission.

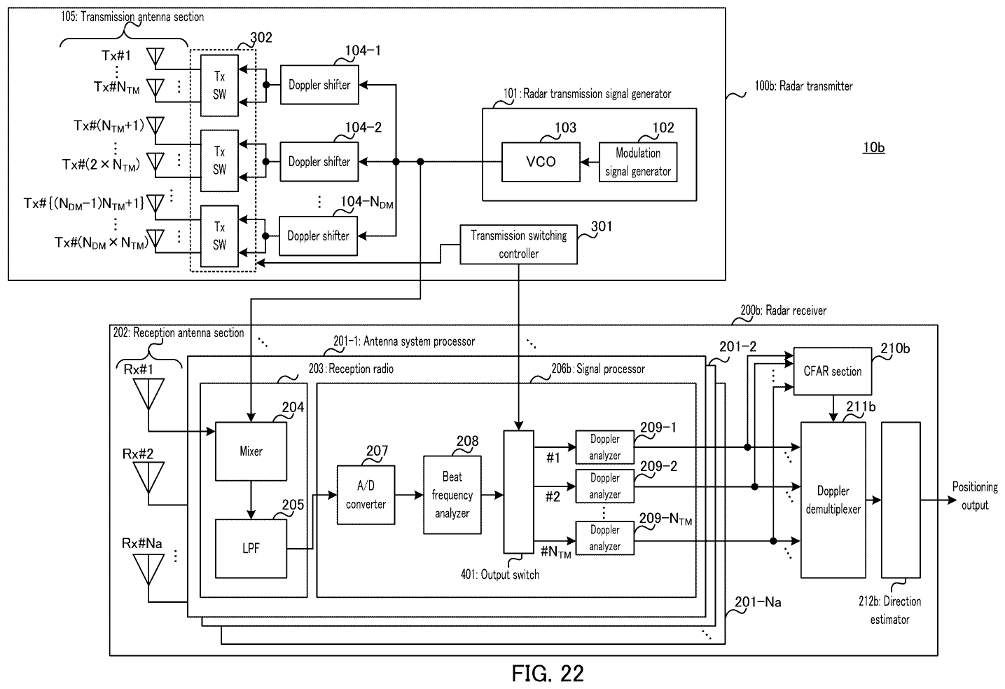

FIG. 22 shows a configuration diagram of radar apparatus 100c in the present embodiment. Below, an exemplary operation of radar apparatus 100c is described using FIG. 22. In FIG. 22, the same reference numerals are assigned to the same configurations as in Embodiment 1 (for example, FIG. 5). Further, the present embodiment is described with respect to operations different from those in Embodiment 1.

For example, in radar apparatus 10b shown in FIG. 22, compared to radar apparatus 10 shown in FIG. 5, transmission switching controller 301 and transmission switch 302 are added in radar transmitter 100b, and an output switch 401 is added in the radar receiver 200b.

FIG. 22 is a polarimetric MIMO radar using Nt transmission antennas, and the Nt transmission antennas in transmission antenna section 105 include PL1-polarized transmission antennas and PL2-polarized transmission antennas that are orthogonal to each other. Hereinafter, the qth polarization is referred to as “PLq polarization.”

Combinations of different polarizations that are orthogonal to each other can include, for example, right-handed circular polarization and left-handed circular polarization, horizontal polarization and vertical polarization, and right 450 diagonal polarization and left 450 diagonal polarization as the (PL1, PL2) polarizations.

Further, transmission antenna section 105 includes transmission antennas including PL1-polarized transmission antennas, number N_{PL1} of which is equal to or greater than 2, and PL2-polarized transmission antennas, number N_{PL2} of which is equal to or greater than 2. For example, number Nt of transmission antennas=N_{PL1}+N_{PL2}≥4 may be acceptable.

In the following example, N_{PL1}=N_{PL2} and the number of Doppler multiplexing is set to N_{DM}=N_{PL1}=N_{PL2}, and it is explained that the Doppler shift amount given to each transmission antenna is the same for each time-division transmission, but the present disclosure is not limited to this, and the Doppler shift amount given to each transmission antenna may differ for each time-division transmission.

Further, the present disclosure is not limited to the case where N_{PL1}=N_{PL2}, and N_{PL1}≠N_{PL2} may also be acceptable. In the case of N_{PL1}≠N_{PL2}, the number of Doppler multiplexing may change for each time-division transmission, and number N_{DM1} of Doppler multiplexing in the first transmission period may be N_{DM1}=N_{PL1}, and number N_{DM2} of Doppler multiplexing in the second transmission period may be N_{DM2}=N_{PL2}.

Further, below, the number of time-division multiplexing is denoted as “N_{TM}.” N_{TM}, for example, may be set to N_{TM}=2 when the Nt transmission antennas include PL1-polarized transmission antennas and PL2-polarized transmission antennas that are orthogonal to each other. For example, number N_{TM} of time-division multiplexing may be set equal to the number of polarizations included in the transmission antennas.

By way of example, a description is given below of a case where N_{DM}=N_{PL1}=N_{PL2}, and number Nt of transmission antennas in transmission antenna section 105 is Nt=N_{DM}×N_{TM}, using number N_{DM} of Doppler multiplexing and number N_{TM} of time-division multiplexing.

[Example Configuration of Radar Transmitter 100b]

Transmission switching controller 301 generates time-division multiplexing index “TM_INDEX” that indicates switching of the transmission antennas within transmission antenna section 105 for each radar transmission period (Tr) for use in time multiplexing, and outputs time-division multiplexing index TM_INDEX to transmission switch 302 and the output switching section 401.

Here, TM_INDEX=1, 2, . . . , N_{TM}. For example, in the mth transmission period, TM_INDEX=MOD(m−1, N_{TM})+1. Here, MOD(x, y) is a modulo operator and is a function that outputs the remainder after x is divided by y.

Radar transmitter 100b shown in FIG. 22 includes N_{DM} Doppler shifters 104-1 to 104-N_{DM}, for example, when the number of Doppler multiplexing is N_{DM}. Further, radar transmitter 100b includes N_{DM} transmission switching sections 302, the same number as Doppler shifters 104.

Each of Doppler shifters 104 applies predetermined phase rotation φ_{ndm} to the chirp signal input from radar transmission signal generator 101, in order to apply predetermined Doppler shift amount DOP_{ndm}, and outputs the phase-rotated chirp signal to corresponding transmission switch 302. Here, ndm=1 to N_{DM}.

The ndmth transmission switch 302 outputs the output of ndmth Doppler shifter 104 to the {(ndm−1)×N_{TM}+TA_INDEX}th transmission antenna with selective switching in accordance with the indication of time-division multiplexing index TM_INDEX.

Through the operation of Doppler shifters 104 and transmission switches 302 as described above, the nth transmission antenna among the Nt transmission antennas of transmission antenna section 105 outputs the signal being the output of radar transmission signal generator 101 to which Doppler shift DOP_{floor[(n-1)/NTM]+1} is applied by floor[(n−1)/N_{TM}]+1th Doppler shifter 104 when time-division multiplexing index TM_INDEX becomes mod(n−1, N_{TM})+1 by floor[(n−1)/N_{TM}]+1th transmission switch 302.

Here, transmission switch 302 performs outputs such that the polarization of the transmission antenna switches for each time-division multiplexing index TM_INDEX. For example, when N_{TM}=2, transmission switch 302 performs switching such that the transmission signal is output from the PL1-polarized transmission antenna when TM_INDEX=1, and from the PL2-polarized transmission antenna when TM_INDEX=2, among the Nt transmission antennas of transmission antenna section 105.

Therefore, in the operation of transmission switches 302, when N_{TM}=2, among the Nt transmission antennas, the transmission antenna represented by n (for example, Tx #n) may represent the PL1-polarized transmission antenna when n is odd, and the PL2-polarized transmission antenna when n is even.

For example, a case where number Nt transmission antennas is 6, number N_{DM} of Doppler multiplexing is 3, and number N_{TM} of time-division multiplexing is 2 is described. In this case, N_{DM}=N_{PL1}=N_{PL2}=3, and there are three PL1-polarized transmission antennas and three PL2-polarized transmission antennas, respectively. Also, three (=N_{DM}) Doppler shifters 104 each apply Doppler shift amounts DOP₁, DOP₂, and DOP₃ to the chirp signals. Further, time-division multiplexing index TM_INDEX of each of three (=N_{DM}) transmission switches 302 includes two (=N_{TM}) elements.

In this case, for example, the first transmission antenna (Tx #1) is a PL1-polarized transmission antenna and outputs the following signal for each transmission period Tr.

$$\begin{matrix}[ 25 ] & \\ {Λ}_{1} ( 1 ) cp ( t ) , 0 , {Λ}_{1} ( 2 ) cp ( t ) , 0 , {Λ}_{1} ( 3 ) cp ( t ) , 0 , … & ( Expression 25 )\end{matrix}$$

Here, cp(t) represents the chirp signal for each transmission period Tr. Also, a multiplication value used when phase rotation φ_{ndm}(m) is applied in Doppler shifters 104 is denoted by Λ_{ndm}(m) as shown in following Expression 26, which may be zero when there is no transmission signal:

$$\begin{matrix}[ 26 ] & \\ {Λ}_{n d m} ( m ) = exp [ j {ϕ}_{n d m} ( m ) ] . & ( Expression 26 )\end{matrix}$$

Similarly, for example, second transmission antenna (Tx #2) is a PL2-polarized transmission antenna and outputs the following signal for each transmission period Tr:

$$\begin{matrix}[ 27 ] & \\ 0 , {Λ}_{1} ( 1 ) cp ( t ) , 0 , {Λ}_{1} ( 2 ) cp ( t ) , 0 , {Λ}_{1} ( 3 ) c p ( t ) , … . & ( Expression 27 )\end{matrix}$$

Similarly, for example, third transmission antenna (Tx #3) is a PL1-polarized transmission antenna, and outputs the following signal every transmission period Tr:

$$\begin{matrix}[ 28 ] & \\ {Λ}_{2} ( 1 ) c p ( t ) , 0 , {Λ}_{2} ( 2 ) c p ( t ) , 0 , {Λ}_{2} ( 3 ) c p ( t ) , 0 , … . & ( Expression 28 )\end{matrix}$$

Similarly, for example, fourth transmission antenna (Tx #4) is a PL2-polarized transmission antenna, and outputs the following signal every transmission period Tr:

$$\begin{matrix}[ 29 ] & \\ 0 , {Λ}_{2} ( 1 ) cp ( t ) , 0 , {Λ}_{2} ( 2 ) cp ( t ) , 0 , {Λ}_{2} ( 3 ) c p ( t ) , … . & ( Expression 29 )\end{matrix}$$

Similarly, for example, fifth transmission antenna (Tx #5) is a PL1-polarized transmission antenna, and outputs the following signal every transmission period Tr:

$$\begin{matrix}[ 30 ] & \\ {Λ}_{3} ( 1 ) c p ( t ) , 0 , {Λ}_{3} ( 2 ) c p ( t ) , 0 , {Λ}_{3} ( 3 ) c p ( t ) , 0 , … . & ( Expression 30 )\end{matrix}$$

Similarly, for example, sixth transmission antenna (Tx #6) is a PL2-polarized transmission antenna, and outputs the following signal every transmission period Tr:

$$\begin{matrix}[ 31 ] & \\ 0 , {Λ}_{3} ( 1 ) cp ( t ) , 0 , {Λ}_{3} ( 2 ) cp ( t ) , 0 , {Λ}_{3} ( 3 ) c p ( t ) , … . & ( Expression 31 )\end{matrix}$$

Further, radar transmitter 100b transmits signals so that the number of chirp pulse transmissions is an integer multiple of N_{TM} (Ncode times). For example, N_{c}=N_{TM}×Ncode.

[Exemplary Configuration of Radar Receiver 200b]

Next, an exemplary configuration of radar receiver 200b shown in FIG. 22 will be described.

In zth signal processor 206b, output switch 401 outputs the output of beat frequency analyzer 208 for each transmission period Tr with selective switching based on time-division multiplexing index TM_INDEX input from transmission switching controller 301, to TM_INDEXth Doppler analyzer 209 among N_{TM} Doppler analyzers 209-1 to 209-N_{TM}. For example, output switch 401 selects TM_INDEXth Doppler analyzer 209 in mth transmission period Tr.

The zth signal processor 206b includes N_{TM} Doppler analyzers 209.

In zth signal processor 206b, data is input to ntmth Doppler analyzer 209 by output switch 401 for each of N_{TM} transmission periods (N_{TM}×Tr). Therefore, ntmth Doppler analyzer 209 performs Doppler analysis using the data of Ncode transmission periods out of N_{c} transmission periods. Here, ntm=1, . . . , N_{TM}.

Further, Doppler analyzer 209 can apply Fast Fourier Transform (FFT) processing as shown in following Expression 32 when Ncode is a power of two:

$$\begin{matrix}[ 32 ] & \\ V F {T}_{z}^{n t m} ( {f}_{b} , {f}_{s} ) = {\sum }_{s = 0}^{{N}_{c o d e} - 1} R F {T}_{z} ( {f}_{b} , {N}_{T M} \times s + n tm ) exp [ - j \frac{2 π {sf}_{s}}{{N}_{c o d e}} ] & ( Expression 32 )\end{matrix}$$

Here, the FFT size is Ncode, and the maximum Doppler frequency that is derived from the sampling theorem and in which no aliasing occurs is ±1/(2 N_{TM}×Tr). Also, the Doppler frequency interval for Doppler frequency index fₛ is 1/(Ncode×N_{TM}×Tr), and the range of Doppler frequency index fₛ is fₛ=−Ncode/2, . . . , 0, . . . , Ncode/2−1.

In addition, when Ncode is not a power of 2, for example, FFT processing can be performed with a power of two FFT size by including zero-padded data. Also, during FFT processing, multiplication by a window function coefficient such as Han window or Hamming window may be performed, and applying a window function can suppress sidelobes occurring around the beat frequency peak.

CFAR section 210b performs CFAR processing (for example, adaptive threshold determination) using the outputs from first to the N_{TM}th Doppler analyzers 209 of all signal processors 206b, and extracts distance index f_{b_cfar} and Doppler frequency index f_{s_cfar} that provide the peak signal.

CFAR section 210b may perform two-dimensional CFAR processing in two dimensions consisting of a distance axis and a Doppler frequency axis (equivalent to relative velocity), or CFAR processing using one-dimensional CFAR processing in combination. For example, processing disclosed in NPL 1 may be applied as the two-dimensional CFAR processing or the CFAR processing that is a combination of one-dimensional CFAR processing.

In the operation of Doppler shifter 104, the Doppler shift amount may be set in units of Δfd, which is represented by the expression where “Tr” in Expression 3 is replaced with “(N_{TM}×Tr).” In this case, for example, when δ is set to a positive integer, the intervals of the Doppler shift amounts may use the interval of Δfd or an integer multiple of the interval of Δfd, and each signal that is Doppler multiplexed may be detected as being aliased at the interval of Δfd in the Doppler frequency domain in the outputs of Doppler analyzers 209. Utilizing such a character, for example, the operation of CFAR section 210b can be simplified as follows.

For example, CFAR section 210b detects a Doppler peak by using a threshold to a power addition value obtained by adding together the reception powers of the reflected wave signals for respective ranges (for example, ranges of Δfd(q)) within the Doppler frequency range of the outputs from Doppler analyzers 209 subjected to the CFAR processing, the ranges serving as units of the intervals of the Doppler shift amounts applied respectively to the radar transmission signals.

For example, CFAR section 210b performs CFAR processing on the outputs from ntmth Doppler analyzers 209 of first to Nath signal processors 206b by calculating power addition value PowerDDMₙₜₘ(f_{b}, f_{sddm}) by adding power value PowerqFTₙₜₘ(f_{b}, fₛ) shown in Expression 34 at intervals of Δf_{d} (for example, corresponding to N_{Δfd}), as shown in following Expression 33. Here, f_{sddm}=−N_{code}/2, . . . , −N_{code}/2+N_{Δfd}−1, and N_{Δfd}=round(Δfd/(1/(TᵣN_{TM}N_{code})). Also, round(x) is an operator that rounds off real number x and outputs an integer value.

$$\begin{matrix}[ 33 ] & \\ P o w e r D D {M}_{ntm} ( {f}_{b} , {f}_{s d d m} ) = {\sum }_{n d m = 1}^{{N}_{D M} + δ} P o w e r F {T}_{ntm} ( {f}_{b} , {f}_{s d d m} + ( n d m - 1 ) \times {N}_{Δ {f}_{d ( q )}} ) & ( Expression 33 )\end{matrix}$$

$$\begin{matrix}[ 34 ] & \\ Powe r F {T}_{ntm} ( {f}_{b} , {f}_{s} ) = {\sum }_{z = 1}^{{N}_{a}} {\vert {VFT}_{z}^{ntm} ( {f}_{b} , {f}_{s} ) \vert}^{2} & ( Expression 34 )\end{matrix}$$

Thus, since the Doppler frequency range subjected to CFAR processing in CFAR section 210b can be narrowed from the full range of Doppler frequency index range fₛ (for example, the range of −N_{code}/2 to N_{code}/2−1) to the range of Δfd, the amount of computation for CFAR processing can be reduced to 1/(N_{DM}+δ).

CFAR section 210b, for example, adaptively sets a threshold and, with respect to the outputs from ntmth Doppler analyzers 209 of first to Nath signal processors 206b, outputs to Doppler demultiplexer 211b distance index f_{b_cfar,ntm}, Doppler frequency index f_{sddm_cfar, ntm}, and the reception power information (PowerFTₙₜₘ(f_{b_cfar}, f_{sddm_cfar}+(ndm−1)×N_{Δfd})) from the ntmth Doppler analyzers 209, which provide a reception power greater than the threshold. Here, ndm is an integer from 1 to N_{DM}+δ, and ntm is an integer from 1 to N_{TM}.

Doppler demultiplexer 211b separates a transmission signal sent from each transmission antenna of transmission antenna section 105 using the output from ntmth Doppler analyzer 209, based on the information (for example, distance index f_{b_cfar,ntm}, Doppler frequency index f_{s_cfar,ntm}, and reception power information PowerFTₙₜₘ(f_{b_cfar,ntm}, f_{s_cfar,ntm})) input from CFAR section 210b.

The operation of Doppler demultiplexer 211b will be described below, along with the operation of Doppler shifter 104.

First to N_{DM}th Doppler shifters 104 apply different Doppler shift amounts DOP₁, DOP₂, . . . , DOP_{NDM} to the input chirp signals, respectively. Here, the intervals (Doppler shift intervals) of Doppler shift amounts DOP₁, DOP₂, . . . , DOP_{NDM} may be unevenly divided intervals, instead of values obtained by evenly dividing the Doppler frequency range where no aliasing occurs, as in Embodiment 1 (for example, at least one Doppler interval may be a different interval).

Embodiment 1 is described in relation to the case where the number of Doppler multiplexing is equal to the number of transmission antennas (for example, Nt=N_{DM}). In contrast, in the present embodiment, since time-division multiplexing is used in conjunction with Doppler multiplexing, number N_{DM} of Doppler multiplexing will be less than number Nt of transmission antennas (for example, Nt>N_{DM}).

For example, in the present embodiment, since time-division multiplexing is performed, the transmission periods for each transmission antenna become (N_{TM}×Tr). Therefore, in the present embodiment, an expression resulting from replacement of “Tr” in Expression 3 used in Embodiment 1 with “(N_{TM}×Tr)” may be used. Also, when the same phase rotation is applied for the transmission periods (N_{TM}×Tr) in which time-division multiplexing is performed, same phase rotation φ_{ndm}(m) may be repeatedly output during the transmission periods (N_{TM}×Tr) in which time-division multiplexing is performed.

For example, ndmth Doppler shifter 104 applies phase rotation φ_{ndm}(m) as given by Expression 35 and which provides different Doppler shift amount DOP_{ndm}, to the mth input chirp signal.

$$\begin{matrix}[ 35 ] & \\ {ϕ}_{n d m} ( m ) = 2 π {DOP}_{n d m} {N}_{T M} {T}_{r} \times floor [ \frac{m - 1}{{N}_{T M}} ] & ( Expression 35 )\end{matrix}$$

In the present embodiment, Doppler demultiplexer 211b performs Doppler demultiplexing processing to separate the Doppler multiplexed signals from the outputs of Doppler analyzer 209 for each TM_INDEX (ntm=1, . . . , N_{TM}), which include reflected waves reception signals of transmission signals Doppler multiplexed using like-polarized transmission antennas for each TM_INDEX.

N_{DM}+δ Doppler frequency indices f_{sddm_cfar,ntm}+(ndm−1)×N_{Δfd}) at distance index f_{b_cfar,ntm} input from CFAR section 210b include, for example, N_{DM} uneven-interval Doppler multiplexed signals.

Doppler demultiplexer 211b, for example, compares the received power (PowerFTₙₜₘ(f_{b_cfar, ntm}, f_{sddm_cfar, ntm}+(ndm−1)×N_{Δfd})) for Doppler frequency indices (f_{sddm_cfar, ntm}+(ndm−1)×N_{Δfd}) (for example, where ndm is an integer from 1 to N_{DM}+δ), and determines whether the top N_{DM} Doppler frequency indices (f_{sddm_cfar, ntm}+(ndm−1)×N_{Δfd}) in terms of reception power match the Doppler shift intervals applied at the time of transmission (for example, this may be referred to as “N_{DM} Doppler shift interval matching determination”).

Further, Doppler demultiplexer 211b, for example, determines whether there is a significant difference (or reception level ratio) between the reception levels of the top N_{DM} Doppler frequency indices in terms of reception power and the reception levels of other δ Doppler frequency indices different from the top N_{DM} Doppler frequency indices in terms of reception power (for example, whether the difference exceeds a threshold, or whether the ratio of reception levels exceeds a threshold) (referred to, for example, as “N_{DM} Doppler multiplexed signal reception level difference determination”).

Based on these determinations, Doppler demultiplexer 211b, for example, determines the Doppler frequencies and transmission antennas corresponding to the Doppler multiplexed signals within the range of −1/(2 N_{TM} Tr)≤fd<1/(2 N_{TM} Tr).

Note that the exemplary operation of Doppler demultiplexer 211b for separating Doppler multiplexed signals at uneven intervals is disclosed in PTL 7, for example, so the detailed description of its operation is omitted here.

For example, Doppler demultiplexer 211b performs Doppler demultiplexing processing to separate, from outputs of ntmth Doppler analyzers 209, Doppler multiplexed signals from the PLₙₜₘ polarized transmission antenna. Here, based on the information input from CFAR section 210b, Doppler demultiplexer 211b, for example, associates Doppler shift amounts DOP₁, DOP₂, . . . , DOP_{Nt} of the Nt transmitted Doppler-multiplexed signals with the Doppler frequency indices, based on the relationship between the δ Doppler frequency indices for lower reception levels and the top N_{DM} Doppler frequency indices for higher reception power among Doppler frequency indices (f_{sddm_cfar,ntm}+(ndm−1)×N_{Δfd}), and outputs this as Doppler-multiplexed-signal separation index information DDM_RXindexₙₜₘ(f_{b_cfar,ntm})=(f_{demul_Tx #ntm}, . . . , f_{demul_Tx #{(NDM-1)NTM+ntm}}) along with distance index f_{b_cfar,ntm} to direction estimator 212b.

Here, f_{demul_Tx #n} indicates the Doppler frequency index of the reflected wave signal from the radar transmission signal transmitted by the nth transmission antenna (Tx #n). Here, ndm is an integer from 1 to N_{DM}+δ, and ntm is an integer from 1 to N_{TM}.

Further, Doppler demultiplexer 211b may output the outputs of Doppler analyzers 209 corresponding to these distances and Doppler separation indices to direction estimator 212b.

It should be noted that the Doppler shift amounts applied to transmission antennas of transmission antenna section 105 are known in Doppler shifters 104 of radar transmitter 100b. Therefore, the difference between the Doppler frequency indicated by Doppler-multiplexed-signal separation index information DDM_RXindexₙₜₘ(f_{b_cfar}) and the Doppler shift amounts applied to transmission antennas in radar transmitter 100b becomes the Doppler frequency of the target object. Therefore, Doppler demultiplexer 211b may output to direction estimator 212b the Doppler frequency of the target object estimated within the range of −1/(2N_{TM}Tr)≤fd<1/(2N_{TM}Tr) instead of separation index information DDM_RXindexₙₜₘ(f_{b_cfar}). In this case, direction estimator 212b can perform a similar operation by generating Doppler-multiplexed-signal separation index information DDM_RXindex(f_{b_cfar}) based on the Doppler frequency of the target object input from Doppler demultiplexer 211b and the Doppler shift amounts applied to transmission antennas in Doppler shifters 104 of radar transmitter 100b.

Thus, Doppler demultiplexer 211b can separate the Doppler multiplexed signals.

The exemplary operation of the Doppler demultiplexer 211b has been described above.

In FIG. 22, direction estimator 212b, for example, performs the target-object direction estimation processing based on the information input from Doppler demultiplexer 211b (for example, distance index f_{b_cfar,ntm} and the separation index information DDM_RXindexₙₜₘ(f_{b_cfar,ntm}) of the Doppler multiplexed signal), and the outputs of Doppler analyzers 209 corresponding to these distances and Doppler separation indices.

For example, direction estimator 212b extracts the output corresponding to distance index f_{b_cfar,ntm}, and separation index information DDM_RXindexₙₜₘ(f_{b_cfar,ntm}) from the outputs of nth Doppler analyzers 209, generates virtual reception array correlation vector h_{PLntm}(f_{b_cfar,ntm}, DDM_Rxindex(f_{b_cfar,ntm})) by the PLₙₜₘ polarized transmission antenna, and performs the direction estimation processing.

Here, h_{PLntm}(f_{b_cfar,ntm}, DDM_Rxindex(f_{b_cfar,ntm})) is a column vector having N_{PLntm}×Na elements.

For example, direction estimator 212b may extract the output corresponding to distance index f_{b_cfar, 1}, and separation index information DDM_RXindex₁(f_{b_cfar,1}) from the outputs of first Doppler analyzers 209, and generate virtual reception array correlation vector h_{PL1}(f_{b_cfar,1}, DDM_Rxindex(f_{b_cfar,1})) by the PL1-polarized transmission antenna. For example, direction estimator 212b may extract outputs corresponding to distance index f_{b_cfar,2}, and separation index information DDM_RXindex₂(f_{b_cfar,2}) from the outputs of second Doppler analyzers 209, and generate virtual reception array correlation vector h_{PL2}(f_{b_cfar,2}, DDM_Rxindex(f_{b_cfar,2})) by the PL2-polarized transmission antenna.

For example, by using virtual reception array correlation vectors h_{PL1}(f_{b_cfar,1}, DDM_Rxindex(f_{b_cfar,1})) and h_{PL2}(f_{b_cfar,2}, DDM_Rxindex(f_{b_cfar,2})) by the PL1- and PL2-polarized transmission antennas, respectively, direction estimator 212b may calculate the spatial profile for each transmission polarization while varying azimuth direction θᵤ within a predetermined angular range in direction estimation evaluation function P_{H-PLq}(θᵤ, f_{b_cfar}, DDM_Rxindex(f_{b_cfar})). Here, q=1 and 2.

Direction estimator 212b may extract a predetermined number of local maximum peaks of the calculated spatial profiles for each transmission polarization in descending order and output the azimuth direction of the local maximum peaks as the direction-of-arrival estimation value for each PLq-polarized transmission (e.g., positioning output). Here, q=1 and 2.

The operation of direction estimator 212b hereafter is similar to that of direction estimator 212 in Embodiment 1, and thus, the description of its exemplary operation is omitted.

As described above, in the present embodiment, by combining Doppler multiplexing with time-division multiplexing, it is possible to increase the number of signals transmitted simultaneously in a multiplexing manner and adapt the technique to a MIMO array configuration with an increased number of transmission antennas, in addition to achieving the same effects as in Embodiment 1. Further, the increase in N_{TM} makes the present embodiment also applicable to a MIMO array configuration, for example, even with two or more types of polarized transmission antennas.

For example, since the transmission period is divided for each polarized transmission antenna, radar apparatus 100c can separate Doppler multiplexed signals even when receiving reflected waves having a cross-polarization relation with respect to the polarization of the reception antenna. For example, the range of Doppler frequencies detectable by radar apparatus 100c is 1/N_{TM} of the range in Embodiment 1, but can be expanded beyond the Doppler detection range of even-interval DDM, −1/(2Nt×Tr)≤fd<1/(2Nt×Tr) (where Nt≥4 or more) in both of the cases.

The embodiments of the present disclosure have been described above.

### Other Embodiments

In the radar apparatuses according to one exemplary embodiment of the present disclosure, the radar transmitter and the radar receiver may be individually arranged in physically separate locations from each other. Also, In the radar receiver according to the exemplary embodiments of the present disclosure, the direction estimator and any other component may be individually arranged in physically separate locations from one another.

Further, the numerical values of parameters such as number Nt of transmission antennas, number Na of reception antennas, number N_{DM} of Doppler multiplexing, number N_{PLq} of PLq-polarized transmission antennas, the number of polarizations, the Doppler shift amount, and the Doppler shift interval used in the exemplary embodiments of the present disclosure are examples and are not limited to these values.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

When future integrated circuit technology replaces LSIs as a result of the advancement of semiconductor technology or other derivative technology, the functional blocks could be integrated using the future integrated circuit technology. Biotechnology can also be applied.

### Summary of Present Disclosure

A radar apparatus according to one exemplary embodiment of the present disclosure includes: a plurality of transmission antennas including a first transmission antenna that radiates a first polarized wave and a second transmission antenna that radiates a second polarized wave different from the first polarized wave; and transmission circuitry, which, in operation, performs multiplexing transmission of a transmission signal to which a phase rotation corresponding to a Doppler shift amount assigned to each of the plurality of transmission antennas is applied, from the plurality of transmission antennas, in which a Doppler multiplexing interval by the plurality of transmission antennas is an uneven interval on a Doppler frequency axis, and a first pattern of the Doppler shift amount assigned to the first transmission antenna and a second pattern of the Doppler shift amount assigned to the second transmission antenna are different from each other.

In one exemplary embodiment of the present disclosure, the first pattern and the second pattern relate to the Doppler multiplexing interval, and at least one of a plurality of the Doppler multiplexing intervals by the first transmission antenna is different from the Doppler multiplexing interval by the second transmission antenna.

In one exemplary embodiment of the present disclosure, the first pattern and the second pattern relate to a number of transmission antennas, and a number of the first transmission antennas and a number of the second transmission antennas are different from each other.

In one exemplary embodiment of the present disclosure, the first pattern and the second pattern relate to a number of Doppler multiplexing, and the number of Doppler multiplexing using the first polarized wave and the number of Doppler multiplexing using the second polarized wave are different from each other.

In one exemplary embodiment of the present disclosure, the first pattern and the second pattern relate to an order of an interval of the Doppler shift amounts, a plurality of first Doppler multiplexing intervals by the first transmission antenna and a plurality of Doppler multiplexing intervals by the second transmission antenna are the same, and an order of the plurality of Doppler multiplexing intervals by the first transmission antenna on the Doppler frequency axis is different from an order of the plurality of Doppler multiplexing intervals by the second transmission antenna on the Doppler frequency axis.

In one exemplary embodiment of the present disclosure, the Doppler multiplexing interval by the first transmission antenna is an uneven interval on the Doppler frequency axis.

In one exemplary embodiment of the present disclosure, the Doppler multiplexing interval by the second transmission antenna is an uneven interval on the Doppler frequency axis.

In one exemplary embodiment of the present disclosure, a reception antenna that receives a reflected wave signal using one of the first polarized wave and the second polarized wave, the reflected wave signal being the transmission signal reflected by a target object, and direction estimation circuitry, which, in operation, performs direction estimation based on the reflected wave signal are further included.

In one exemplary embodiment of the present disclosure, a plurality of reception antennas including a first reception antenna which uses the first polarized wave and a second reception antenna which uses the second polarized wave, the plurality of reception antennas receiving a reflected wave signal being the transmission signal reflected by a target object, and direction estimation circuitry, which, in operation, performs direction estimation individually for the reflected wave signal received by each of the first reception antenna and the second reception antenna are further included.

A radar apparatus according to one exemplary embodiment of the present disclosure includes: a plurality of transmission antennas including a first transmission antenna that radiates a first polarized wave and a second transmission antenna that radiates a second polarized wave different from the first polarized wave; and transmission circuitry, which, in operation, performs multiplexing transmission of a transmission signal to which a phase rotation corresponding to a Doppler shift amount assigned to each of the plurality of transmission antennas is applied, from the plurality of transmission antennas, in which a timing of transmitting the transmission signal from the first transmission antenna and a timing of transmitting the transmission signal from the second transmission antenna are different from each other.

In one exemplary embodiment of the present disclosure, the Doppler multiplexing interval by the first transmission antenna is an uneven interval on the Doppler frequency axis, and the Doppler multiplexing interval by the second transmission antenna is an uneven interval on the Doppler frequency axis.

In one exemplary embodiment of the present disclosure, the Doppler shift amount assigned to the first transmission antenna includes a same Doppler shift amount as the Doppler shift amount assigned to the second transmission antenna.

In one exemplary embodiment of the present disclosure, a third pattern of the Doppler shift amount assigned to the first transmission antenna is different from a fourth pattern of the Doppler shift amount assigned to the second transmission antenna.

A radar apparatus according to one exemplary embodiment of the present disclosure includes: a plurality of transmission antennas including a first transmission antenna that radiates a first polarized wave, a second transmission antenna that radiates a second polarized wave different from the first polarized wave, and a third transmission antenna of a polarization different from polarizations of the first and the second transmission antennas; and transmission circuitry, which, in operation, performs multiplexing transmission of a transmission signal to which a phase rotation corresponding to a Doppler shift amount assigned to each of the plurality of transmission antennas is applied, from the plurality of transmission antennas, in which a Doppler multiplexing interval by the plurality of transmission antennas is an uneven interval on a Doppler frequency axis, a fifth pattern related to the Doppler shift amount assigned to the first transmission antenna and the third transmission antenna differs from a sixth pattern related to the Doppler shift amount assigned to the second transmission antenna and the third transmission antenna on the Doppler frequency axis.

In one exemplary embodiment of the present disclosure, the fifth pattern and the sixth pattern relate to the Doppler multiplexing interval, and at least one of a plurality of the Doppler multiplexing intervals by the second transmission antenna and the third transmission antenna is different from the Doppler multiplexing interval by the first transmission antenna and the third transmission antenna.

In one exemplary embodiment of the present disclosure, the fifth pattern and the sixth pattern relate to an order of an interval of the Doppler shift amounts, a plurality of Doppler multiplexing intervals by the second transmission antenna and the third transmission antenna are the same as a plurality of Doppler multiplexing intervals by the first transmission antenna and the third transmission antenna, and an order of the plurality of Doppler multiplexing intervals by the second transmission antenna and the third transmission antenna on the Doppler frequency axis differs from an order of the plurality of Doppler multiplexing intervals by the first transmission antenna and the third transmission antenna on the Doppler frequency axis.

In one embodiment of the present disclosure, the Doppler multiplexing interval by the second transmission antenna and the third transmission antenna is an uneven interval on the Doppler frequency axis.

In one embodiment of the present disclosure, the Doppler multiplexing interval by the first transmission antenna and the third transmission antenna is an uneven interval on the Doppler frequency axis.

The disclosure of Japanese Patent Application No. 2022-105855, filed on Jun. 30, 2022, including the specification, drawings and abstract, is incorporated herein by reference in its entirety.

### INDUSTRIAL APPLICABILITY

The present disclosure is suitable as a radar apparatus for wide-angle range sensing.

### REFERENCE SIGNS LIST

10, 10b Radar apparatus
100, 100b Radar transmitter
101 Radar transmission signal generator
102 Modulation signal generator
103 VCO
104 Doppler shifter
105 Transmission antenna section
200, 200a Radar receiver
201 Antenna system processor
202 Reception antenna section
203 Reception radio
204 Mixer
205 LPF
206, 206b Signal processor
207 AD converter
208 Beat frequency analyzer
209 Doppler analyzer
210, 210a, 210b CFAR section
211, 211a, 211b Doppler demultiplexer
212, 212a, 212b Direction estimator

1. A radar apparatus, comprising:
a plurality of transmission antennas including a first transmission antenna that radiates a first polarized wave and a second transmission antenna that radiates a second polarized wave different from the first polarized wave; and
transmission circuitry, which, in operation, performs multiplexing transmission of a transmission signal to which a phase rotation corresponding to a Doppler shift amount assigned to each of the plurality of transmission antennas is applied, from the plurality of transmission antennas, wherein
a Doppler multiplexing interval by the plurality of transmission antennas is an uneven interval on a Doppler frequency axis, and
a first pattern of the Doppler shift amount assigned to the first transmission antenna and a second pattern of the Doppler shift amount assigned to the second transmission antenna are different from each other.

2. The radar apparatus according to claim 1, wherein:
the first pattern and the second pattern relate to the Doppler multiplexing interval, and
at least one of a plurality of the Doppler multiplexing intervals by the first transmission antenna is different from the Doppler multiplexing interval by the second transmission antenna.

3. The radar apparatus according to claim 1, wherein:
the first pattern and the second pattern relate to a number of transmission antennas, and
a number of the first transmission antennas and a number of the second transmission antennas are different from each other.

4. The radar apparatus according to claim 1, wherein:
the first pattern and the second pattern relate to a number of Doppler multiplexing, and
the number of Doppler multiplexing using the first polarized wave and the number of Doppler multiplexing using the second polarized wave are different from each other.

5. The radar apparatus according to claim 1, wherein:
the first pattern and the second pattern relate to an order of an interval of the Doppler shift amounts,
a plurality of first Doppler multiplexing intervals by the first transmission antenna and a plurality of Doppler multiplexing intervals by the second transmission antenna are the same, and
an order of the plurality of Doppler multiplexing intervals by the first transmission antenna on the Doppler frequency axis is different from an order of the plurality of Doppler multiplexing intervals by the second transmission antenna on the Doppler frequency axis.

6. The radar apparatus according to claim 1, wherein
at least either the Doppler multiplexing interval by the first transmission antenna or the Doppler multiplexing interval by the second transmission antenna is an uneven interval on the Doppler frequency axis.

7. The radar apparatus according to claim 1, further comprising:
a reception antenna that receives a reflected wave signal using one of the first polarized wave and the second polarized wave, the reflected wave signal being the transmission signal reflected by a target object, and
direction estimation circuitry, which, in operation, performs direction estimation based on the reflected wave signal.

8. The radar apparatus according to claim 1, further comprising:
a plurality of reception antennas including a first reception antenna which uses the first polarized wave and a second reception antenna which uses the second polarized wave, the plurality of reception antennas receiving a reflected wave signal being the transmission signal reflected by a target object, and
direction estimation circuitry, which, in operation, performs direction estimation individually for the reflected wave signal received by each of the first reception antenna and the second reception antenna.

9. The radar apparatus according to claim 1, wherein
a timing of transmitting the transmission signal from the first transmission antenna and a timing of transmitting the transmission signal from the second transmission antenna are different from each other.

10. The radar apparatus according to claim 1, wherein
the Doppler shift amount assigned to the first transmission antenna includes a same Doppler shift amount as the Doppler shift amount assigned to the second transmission antenna.

11. The radar apparatus according to claim 1, wherein:
the plurality of transmission antennas further include a third transmission antenna of a polarization different from polarizations of the first and the second transmission antennas, and
a third pattern related to the Doppler shift amount assigned to the first transmission antenna and the third transmission antenna differs from a fourth pattern related to the Doppler shift amount assigned to the second transmission antenna and the third transmission antenna on the Doppler frequency axis.

12. The radar apparatus according to claim 11, wherein:
the third pattern and the fourth pattern relate to the Doppler multiplexing interval, and
at least one of a plurality of the Doppler multiplexing intervals by the second transmission antenna and the third transmission antenna is different from the Doppler multiplexing interval by the first transmission antenna and the third transmission antenna.

13. The radar apparatus according to claim 11, wherein:
the third pattern and the fourth pattern relate to an order of an interval of the Doppler shift amounts,
a plurality of Doppler multiplexing intervals by the second transmission antenna and the third transmission antenna are the same as a plurality of Doppler multiplexing intervals by the first transmission antenna and the third transmission antenna, and
an order of the plurality of Doppler multiplexing intervals by the second transmission antenna and the third transmission antenna on the Doppler frequency axis differs from an order of the plurality of Doppler multiplexing intervals by the first transmission antenna and the third transmission antenna on the Doppler frequency axis.

14. The radar apparatus according to claim 11, wherein
the Doppler multiplexing interval by the third transmission antenna and either the first transmission antenna or the second transmission antenna is an uneven interval on the Doppler frequency axis.

15. A radar signal generating apparatus, comprising:
signal generation circuitry, which, in operation, generates a transmission signal; and
Doppler shift circuitry, which, in operation, performs multiplexing transmission of the transmission signal to which a phase rotation corresponding to a Doppler shift amount assigned to each of a plurality of transmission antennas, from the plurality of transmission antennas, wherein
the plurality of transmission antennas include a first transmission antenna that radiates a first polarized wave and a second transmission antenna that radiates a second polarized wave different from the first polarized wave,
a Doppler multiplexing interval by the plurality of transmission antennas is an uneven interval on a Doppler frequency axis, and
a first pattern of the Doppler shift amount assigned to the first transmission antenna and a second pattern of the Doppler shift amount assigned to the second transmission antenna are different from each other.

16. The radar signal generating apparatus according to claim 15, wherein:
the first pattern and the second pattern relate to the Doppler multiplexing interval,
at least one of a plurality of the Doppler multiplexing intervals by the first transmission antenna is different from the Doppler multiplexing interval by the second transmission antenna.

17. The radar signal generating apparatus according to claim 15, wherein:
the first pattern and the second pattern relate to a number of transmission antennas, and
a number of the first transmission antennas and a number of the second transmission antennas are different from each other.

18. A radar signal generating method, comprising:
generating a transmission signal; and
performing multiplexing transmission of the transmission signal to which a phase rotation corresponding to a Doppler shift amount assigned to each of a plurality of transmission antennas is applied, from the plurality of transmission antennas, wherein
the plurality of transmission antennas include a first transmission antenna that radiates a first polarized wave and a second transmission antenna that radiates a second polarized wave different from the first polarized wave,
a Doppler multiplexing interval by the plurality of transmission antennas is an uneven interval on the Doppler frequency axis, and
a first pattern of the Doppler shift amount assigned to the first transmission antenna and a second pattern of the Doppler shift amount assigned to the second transmission antenna are different from each other.

19. The radar signal generating method according to claim 18, wherein:
the first pattern and the second pattern relate to the Doppler multiplexing interval,
at least one of a plurality of the Doppler multiplexing intervals by the first transmission antenna is different from the Doppler multiplexing interval by the second transmission antenna.

20. The radar signal generating method according to claim 18, wherein:
the first pattern and the second pattern relate to a number of transmission antennas, and
a number of the first transmission antennas and a number of the second transmission antennas are different from each other.
